(19) United States
(12) Patent Application Publication
(10) Pub. No.: US 2025/0294167 A1
(43) Pub. Date: Sep. 18, 2025

(54) ENCODING METHOD, DECODING METHOD, AND DECODER

(71) Applicant: GUANGDONG OPPO MOBILE TELECOMMUNICATIONS CORP., LTD., Dongguan (CN)

(72) Inventors: Junyan HUO, Dongguan (CN); Yanzhuo MA, Dongguan (CN); Fuzheng YANG, Dongguan (CN); Xue HAO, Dongguan (CN); Ming LI, Dongguan (CN)

(73) Assignee: GUANGDONG OPPO MOBILE TELECOMMUNICATIONS CORP., LTD., Dongguan (CN)

(21) Appl. No.: 19/227,116

(22) Filed: Jun. 3, 2025

Related U.S. Application Data
(63) Continuation of application No. PCT/CN2022/138222, filed on Dec. 9, 2022.

(51) Int. Cl. H04N 19/159; H04N 19/132; H04N 19/176; H04N 19/196

(52) U.S. Cl. CPC H04N 19/159; H04N 19/132; H04N 19/176; H04N 19/196

(57) ABSTRACT

A decoding method includes: at least one first colour component block of a current block is determined; in response to the at least one first colour component block being intra predicted based on a block vector, at least one second block vector parameter of a second colour component block of the current block is determined based on at least one first block vector parameter of the at least one first colour component block; a prediction value of a second colour component is determined based on the at least one second block vector parameter.

### CROSS REFERENCE TO RELATED APPLICATION

This is a continuation of International Application No. PCT/CN2022/138222 filed on Dec. 9, 2022, the disclosure of which is hereby incorporated by reference in its entirety.

### TECHNICAL FIELD

Embodiments of the disclosure relate to the technical field of video encoding and decoding, and in particular to an encoding method, a decoding method, and a decoder.

### BACKGROUND

With the improvement of video display quality requirements, new forms of video applications such as high definition (HD) and ultra-high definition (UHD) videos, or the like have emerged accordingly. Joint Video Exploration Team (JVET) of the International Organization for Standardization (ISO)/International Electrotechnical Commission (IEC) and International Telecommunication Union Telecommunication Standardization Sector (ITU-T) has developed a video coding standard H.266/Versatile Video Coding (VVC). Intra Block Copy (IBC) is a block-level coding mode provided by VVC for screen content-type video sequences.

In the related art, for a Direct Mode (DM), if the IBC mode is used for a luma block, then the chroma prediction mode setting at this stage is unreasonable, resulting in inaccurate chroma prediction for a current block and a loss of coding efficiency.

### BRIEF DESCRIPTION OF THE DRAWINGS

FIG. 1 is a schematic flowchart of obtaining reconstructed samples based on an IBC mode.

FIG. 2 is a schematic diagram of a positional distribution of neighbouring blocks according to an embodiment of the disclosure.

FIG. 3 is a first schematic diagram of a positional relationship between a luma CU and a chroma CU according to an embodiment of the disclosure.

FIG. 4A is a schematic block diagram of composition of an encoder according to an embodiment of the disclosure.

FIG. 4B is a schematic block diagram of composition of a decoder according to an embodiment of the disclosure.

FIG. 5 is a schematic diagram of a network architecture of an encoding and decoding system according to an embodiment of the disclosure.

FIG. 6 is a schematic diagram of a decoding method.

FIG. 7 is a second schematic diagram of a positional relationship between a luma CU and a chroma CU according to an embodiment of the disclosure.

FIG. 8 is a third schematic diagram of a positional relationship between a luma CU and a chroma CU according to an embodiment of the disclosure.

FIG. 9 is a fourth schematic diagram of a positional relationship between a luma CU and a chroma CU according to an embodiment of the disclosure.

FIG. 10 is a fifth schematic diagram of a positional relationship between a luma CU and a chroma CU according to an embodiment of the disclosure.

FIG. 11 is a schematic structural diagram of whether an offset position does not overlap a current block according to an embodiment of the disclosure.

FIG. 12 is a schematic structural diagram of whether an offset position exceeds a preset available region according to an embodiment of the disclosure.

FIG. 13 is a schematic structural diagram of determining an optimal chroma BV parameter according to an embodiment of the disclosure.

FIG. 14 is a schematic diagram of coordinates and block sizes of a current chroma block and a collocated luma region.

FIG. 15 is a schematic diagram of searching a collocated luma region according to an embodiment of the disclosure.

FIG. 16 is a schematic diagram of template types according to an embodiment of the disclosure.

FIG. 17 is a schematic diagram of motion compensation of a template according to an embodiment of the disclosure.

FIG. 18 is a schematic structural diagram of block copying based on an IBC extension mode according to an embodiment of the disclosure.

FIG. 19 is a schematic diagram of an encoding method.

FIG. 20 is a detailed schematic flowchart of an encoding method according to an embodiment of the disclosure.

FIG. 21 is a detailed schematic flowchart of another encoding method according to an embodiment of the disclosure.

FIG. 22 is a schematic diagram of a composition structure of an encoder according to an embodiment of the disclosure.

FIG. 23 is a schematic diagram of a specific hardware structure of an encoder according to an embodiment of the disclosure.

FIG. 24 is a schematic diagram of a composition structure of a decoder according to an embodiment of the disclosure.

FIG. 25 is a schematic diagram of a specific hardware structure of a decoder according to an embodiment of the disclosure.

FIG. 26 is a schematic diagram of a composition structure of an encoding and decoding system according to an embodiment of the disclosure.

### DETAILED DESCRIPTION

In order to provide a more detailed understanding of the features and technical contents of the embodiments of the present disclosure, the implementation of the embodiments of the present disclosure will be described in detail below with reference to the drawings, which are for reference and illustration only, and are not intended to limit the embodiments of the present disclosure.

Unless otherwise defined, all technical and scientific terms used herein have the same meaning as commonly understood by those skilled in the art belonging to the present disclosure. The terminology used herein is for the purpose of describing embodiments of the present disclosure only and is not intended to limit the present disclosure.

In the following description, reference is made to “some embodiments”, which describes a subset of all possible embodiments, but it may be understood that “some embodiments” may be the same subset or different subsets of all possible embodiments, and may be combined with each other without conflict. It should also be pointed out that the terms “first\ second\third” referred to in the embodiments of the present disclosure are only used to distinguish similar objects, and do not represent a specific ordering for the objects. It may be understood that “first\second\third” may be interchanged with a specific order or a priority order where allowed, so that the embodiments of the present disclosure described herein may be implemented in an order other than that illustrated or described herein.

Before further describing the embodiments of the present disclosure in detail, the terms and phrases related to the embodiments of the present disclosure will be described firstly, and the terms and phrases related to the embodiments of the present disclosure are applicable to the following explanations.
Coding Block (CB);
Intra block copy (IBC);
Screen Content Coding (SCC);
Block Matching (BM);
Coding Unit (CU);
Block Vector (BV);
Motion Vector (MV);
Direct Block Vector (DBV);
Advanced Motion Vector Prediction (AMVP);
Cross-Component Linear Model prediction (CCLM);
MERGE Mode;
PLANAR Mode;
H.266/Versatile Video Coding (VVC); and
VVC Test Model (VTM).

It may be understood that in a video picture, a first colour component, a second colour component, and a third colour component are generally used to represent a coding block. Herein the three colour components are a luma component, a blue chroma component, and a red chroma component respectively. Specifically, the luma component is generally denoted by a symbol Y, the blue chroma component is generally denoted by a symbol Cb or U, and the red chroma component is generally denoted by a symbol Cr or V. In this way, the video picture may be represented in an YCbCr format or YUV format.

It may be further understood that IBC is an extension tool in VVC for coding screen content-type video sequences, which significantly improves the coding efficiency for screen content sequences. Specifically, IBC is a block-level coding mode similar to inter techniques, where a coding end performs motion search, specifically by block matching to find the optimal block vector (also referred to as a motion vector) for each CU. Herein the block vector is a vector pointing from a current block to a reference block. The difference between IBC and the inter techniques lies in that the optimal block vector of IBC is obtained by searching in a reconstructed region of a frame where the current block is located (i.e., a current coding frame), while a inter motion vector is obtained by searching in temporally neighbouring reference frames relative to the current coding frame.

In H.266/VVC, a specific process for obtaining reconstructed pixels of a current block in the IBC mode may include: deriving a block vector, deriving prediction samples using the block vector, deriving residual samples, and deriving reconstructed samples using the prediction samples and the residual samples.

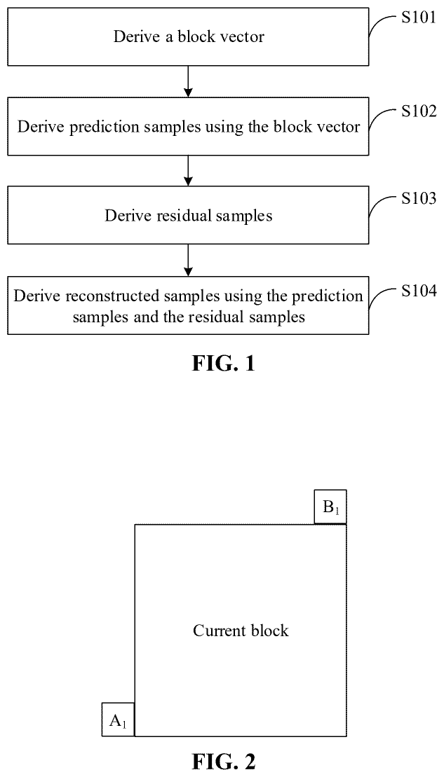

In a specific implementation, a process of obtaining reconstructed samples in the IBC mode, as shown in FIG. 1, may include the following operations S101 to S104.

At S101, a block vector is derived.

For a luma component, inputs include: a luma position (xCb, yCb), specifying a top-left sample of a current block relative to a top-left luma sample of a current picture; a variable cbWidth, specifying a width of the current block in luma samples; and a variable cbHeight, specifying a height of the current block in the luma samples. An output includes: a Block Vector Luma (bvL). It should be noted that the current block including the luma samples may also be referred to as “luma block”.

Here, the IBC mode is divided into an IBC MERGE mode and an IBC AMVP mode. When deriving the bvL, both modes need to establish an IBC block vector candidate list bvCandList. A process for establishing an IBC MERGE list is introduced in detail below. Herein a process for establishing an IBC AMVP list is consistent with that for the IBC MERGE list, but a maximum number of candidates for the two lists is inconsistent.

At operation 1, when IsGt4by4 is TRUE (the variable IsGt4by4 is TRUE when a product of the width and the height of the luma block is greater than 16), a derivation process for spatial block vector candidates from neighbouring coding units, as specified in the decoding specification, is invoked as an input using the luma block position (xCb, yCb), the width cbWidth of the luma block, and the height cbHeight of the luma block. Outputs are available flags availableFlagA₁ and availableFlagB₁, and block vectors bvA₁ and bvB₁. The relative positions of the neighbouring blocks where A₁ and B₁ are located with respect to the current block are shown in FIG. 2.

At operation 2, when IsGt4by4 is TRUE, the construction of the block vector candidate list bvCandList is as follows in pseudocode.
i=0
if (availableFlagA₁)
   bvCandList[i++]=bvA₁
if (availableFlagB₁)
   bvCandList[i++]=bvB₁

At operation 3, a derivation process for a variable numCurrCand (a current number of obtained candidates) is as follows.

If IsGt4by4 is TRUE, numCurrCand is set to be equal to a number of candidates in bvCandList. Otherwise, numCurrCand is set to 0.

At operation 4, when numCurrCand is less than MaxNumIbcMergeCand (a maximum number of candidates in the MERGE mode) and NumHmvpIbcCand (a maximum number of candidates for historical optimal block vectors Hmvp in the IBC mode) is greater than 0, bvCandList and numCurrCand are taken as inputs, the modified bvCandList and numCurrCand are taken as outputs, and a derivation process for history-based IBC block vector candidates as specified in the decoding specification is invoked.

At operation 5, when numCurrCand is less than MaxNumIbcMergeCand, the following operations are repeated until numCurrCand equals MaxNumIbcMergeCand.
bvCandList[numCurrCand][0] (a horizontal component of the BV) is set to 0;
bvCandList[numCurrCand][1] (a vertical component of the BV) is set to 0; and
numCurrCand is incremented by 1.

In this way, the block vector candidate list bvCandList is established. An index bvIdx of a candidate is derived as follows, herein general_merge_flag indicates whether the mode is the IBC MERGE mode.
bvIdx=general_merge_flag[xCb][yCb]?merge_idx[xCb][yCb]:mvp_l0_flag[xCb] [yCb]

In this way, the specific bvL may be obtained as follows based on the index bvIdx and the block vector candidate list bvCandList.
bvL[0]=bvCandList[bvIdx][0];
bvL[1]=bvCandList[bvIdx][1].

For the IBC AMVP mode, the specific bvL may be obtained as the prediction bvL by using the index bvIdx and the block vector candidate list bvCandList, while the actual bvL needs to be further adjusted by adding the block vector difference (BVD). The specific process is as follows.

At operation 1, the horizontal and vertical components of the BVD are obtained. Herein MvdL0 is a forward motion vector difference. The horizontal component of the BVD is denoted by bvd[0], and the vertical component of the BVD is denoted by bvd[1]. The specific details are as follows.
bvd[0]=MvdL0[xCb][yCb][0];
bvd[1]=MvdL0[xCb][yCb][1].

At operation 2, a rounding operation is performed on the obtained prediction bvL. Herein a right shifting based on parameter AmvrShift is used for rounding, and a left shifting based on parameter AmvrShift is used for improving the resolution. The specific details are as follows.

$$Offset = ( AmvrShift == 0 ) ? 0 : ( ( 1 ≪ ( AmvrShift - 1 ) ) - 1 ) ;$$

$$bvL [ 0 ] = Sign ( bvL [ 0 ] ) * ( ( ( Abs ( bvL [ 0 ] ) + offset ) ≫ AmvrShift ) ≪ AmvrShift ) ;$$

$$bvL [ 1 ] = Sign ( bvL [ 1 ] ) * ( ( ( Abs ( bvL [ 1 ] ) + offset ) ≫ AmvrShift ) ≪ AmvrShift ) .$$

At operation 3, a range of the actual bvL needs to be controlled between −2¹⁷ and 2¹⁷−1. The detailed derivation process is as follows.

$$u [ 0 ] = ( bvL [ 0 ] + bvd [ 0 ] + {2}^{18} ) \% {2}^{18} ;$$

$$bvL [ 0 ] = ( u [ 0 ] >= {2}^{17} ) ? ( u [ 0 ] - {2}^{18} ) : u [ 0 ] ;$$

$$u [ 1 ] = ( bvL [ 1 ] + bvd [ 1 ] + {2}^{18} ) \% {2}^{18} ;$$

$$bvL [ 1 ] = ( u [ 1 ] >= {2}^{17} ) ? ( u [ 1 ] - {2}^{18} ) : u [ 1 ] .$$

For a chroma component, if it is dual-tree partitioning, the IBC mode is not applied on the chroma component; if it is single-tree partitioning, the BV for the chroma component needs to be derived.

Herein the input includes: a luma bvL (with 1/16-pixel precision). The output includes: a Block Vector Chroma (bvC) (with 1/32-pixel precision). The specific derivation process is as follows.

$$bvC [ 0 ] = ( ( bvL [ 0 ] ≫ ( 3 + SubWidthC ) ) * 32 ) ;$$

$$bvC [ 1 ] = ( ( bvL [ 1 ] ≫ ( 3 + SubHeightC ) ) * 32 ) .$$

At S102, prediction samples are derived using the block vector.

Here, inputs include: the luma position (xCb, yCb), specifying the top-left sample of the current block relative to the top-left luma sample of the current picture; the variable cbWidth, specifying the width of the current block in the luma samples; the variable cbHeight, specifying the height of the current block in the luma samples; the block vector BV; a variable cIdx, specifying a colour component index of the current block. An output includes: an array of prediction samples predSamples.

For the prediction samples, the specific derivation process is as follows.

When cIdx equals to 0 (i.e., for the luma component), for x=xCb . . . xCb+cbWidth−1 and y=yCb . . . yCb+cbHeight−1:

$$xVb = ( x + ( b v [ 0 ] ≫ 4 ) ) \& ( IbcBufWidthY - 1 ) ;$$

$$yVb = ( y + ( b v [ 1 ] ≫ 4 ) ) \& ( CtbSizeY - 1 ) ;$$

$$predSamples [ x ] [ y ] = ibcVirBuf [ 0 ] [ xVb ] [ yVb ] .$$

Herein IbcBufWidthY is a width of luma pixels in the IBC-stored reconstructed buffer unit (Buffer), CtbSizeY is a size of the Coding Tree Unit (CTU), and ibcVirBuf is IBC-stored reconstructed pixels.

When cIdx is not equal to 0 (i.e., for the chroma component), for x=xCb/Sub WidthC . . . xCb/SubWidthC+cbWidth/SubWidthC−1 and y=yCb/SubHeightC . . . yCb/SubHeightC+cbHeight/SubHeightC−1:

$$xVb = ( x + ( b v [ 0 ] ≫ 5 ) ) \& ( IbcBufWidthC - 1 ) ;$$

$$yVb = ( y + ( b v [ 1 ] ≫ 5 ) ) \& ( ( CtbSizeY / subHeightC ) - 1 ) ;$$

$$predSamples [ x ] [ y ] = ibcVirBuf [ cIdx ] [ xVb ] [ yVb ] .$$

Herein the variables SubWidthC and SubHeightC depend on a chroma sampling format specified by sps_chroma_format_idc, and a specific correspondence is shown in Table 1.

TABLE 1

| sps_chroma_{—} | Colour sampling | | |
|---|---|---|---|
| format_idc | format | SubWidthC | SubHeightC |
| 0 | monochroma | 1 | 1 |
| 1 | 4:2:0 | 2 | 2 |
| 2 | 4:2:2 | 2 | 1 |
| 3 | 4:4:4 | 1 | 1 |

At S103, residual samples are derived.

For the residual samples, a residual decoding process as specified in the decoding specification may be invoked.

At S104, reconstructed samples are derived using the prediction samples and the residual samples.

For the reconstructed samples (i.e., reconstructed pixel values), a picture reconstruction process for a specified colour component as specified in the decoding specification may be invoked.

In another specific implementation, for the derivation process for the chroma prediction mode in H.266/VVC, inputs include: a luma position (xCb, yCb), specifying a top-left sample of the current block relative to a top-left luma sample of the current picture; a variable cbWidth, specifying a width of the current block in luma samples; a variable cbHeight, specifying a height of the current block in the luma samples; a variable treeType, specifying whether single-tree partitioning or dual-tree partitioning is used. Outputs include: a chroma intra prediction mode IntraPredModeC[xCb][yCb] and an MIP chroma direct mode flag MipChromaDirectFlag[xCb][yCb].

If treeType is equal to SINGLE_TREE, that is, in the case of single-tree partitioning, sps_chroma_format_idc is equal to 3, that is, 4:4:4 format, intra_chroma_pred_mode is equal to 4, and IntraMipFlag[xCb][yCb] is equal to 1, that is, a prediction mode for the corresponding collocated luma center block is the MIP mode, then:

\textcircled{1} The MIP chroma direct mode flag MipChromaDirectFlag[xCb][yCb] is set to be equal to 1, that is, the chroma uses the MIP mode of the luma.

\textcircled{2} The chroma intra prediction mode IntraPredModeC[xCb][yCb] is set to be equal to IntraPredModeY[xCb][yCb].

Otherwise:

\textcircled{1} The MIP chroma direct mode flag MipChromaDirectFlag[xCb][yCb] is set to be equal to 0.

\textcircled{2} A corresponding luma intra prediction mode lumaIntraPredMode is derived as follows.

If IntraMipFlag[xCb+cbWidth/2][yCb+cbHeight/2] is equal to 1, lumaIntraPredMode is set to be equal to INTRA_PLANAR.

Otherwise, if CuPredMode[0][xCb+cbWidth/2][yCb+cbHeight/2] is equal to MODE_IBC or MODE_PLT, lumaIntraPredMode is set to be equal to INTRA_DC.

In ECM, the IntraTmp mode is newly introduced. If CuPredMode[0][xCb+cbWidth/2][yCb+cbHeight/2] is equal to MODE_INTRA and it is the IntraTmp mode, lumaIntraPredMode is set to be equal to NTRA_PLANAR.

Otherwise, lumaIntraPredMode is set to be equal to IntraPredModeY[xCb+cbWidth/2][yCb+cbHeight/2].

\textcircled{3} The chroma intra prediction mode IntraPredModeC[xCb][yCb] is derived as follows.

If cu_act_enabled_flag[xCb][yCb] is equal to 1, the chroma intra prediction mode IntraPredModeC[xCb][yCb] is set to be equal to lumaIntraPredMode.

Otherwise:

If BdpcmFlag[xCb][yCb][1] is equal to 1, IntraPredModeC[xCb][yCb] is set to be equal to BdpcmDir[xCb][yCb][1]? INTRA_ANGULAR50:INTRA_ANGULAR18.

Otherwise, if cu_act_enabled_flag[xCb][yCb] is equal to 0 and BdpcmFlag[xCb][yCb][1] is equal to 0, the chroma intra prediction mode IntraPredModeC[xCb][yCb] uses cclm_mode_flag, cclm_mode_idx, and intra_chroma_pred_mode and lumaIntraPredMode specified in Table 2.

TABLE 2

| | | | lumaIntraPredMode | | | | |
|---|---|---|---|---|---|---|---|
| cclm_mode_{—} | cclm_mode_{—} | intra_chroma_{—} | | | | | X |
| flag | idx | pred_mode | 0 | 50 | 18 | 1 | (0 <= X <= 66) |
| 0 | — | 0 | 66 | 0 | 0 | 0 | 0 |
| 0 | — | 1 | 50 | 66 | 50 | 50 | 50 |
| 0 | — | 2 | 18 | 18 | 66 | 18 | 18 |
| 0 | — | 3 | 1 | 1 | 1 | 66 | 1 |
| 0 | — | 4 | 0 | 50 | 18 | 1 | X |
| 1 | 0 | — | 81 | 81 | 81 | 81 | 81 |
| 1 | 1 | — | 82 | 82 | 82 | 82 | 82 |
| 1 | 2 | — | 83 | 83 | 83 | 83 | 83 |

When sps_chroma_format_idc is equal to 2, the chroma intra prediction mode Y may be derived from the chroma intra prediction mode X in Table 2. Please refer to the mapping process specification from mode X to mode Y as shown in Table 3 for details. Then, the chroma intra prediction mode X is set to be equal to the chroma intra prediction mode Y.

TABLE 3

| mode X | 0 | 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|---|---|
| mode Y | 0 | 1 | 61 | 62 | 63 | 64 | 65 | 66 | 2 | 3 | 5 | 6 | 8 | 10 | 12 | 13 | 14 |
| mode X | 18 | 19 | 20 | 21 | 22 | 23 | 24 | 25 | 26 | 27 | 28 | 29 | 30 | 31 | 32 | 33 | 34 |
| mode Y | 18 | 20 | 22 | 23 | 24 | 26 | 28 | 30 | 31 | 33 | 34 | 35 | 36 | 37 | 38 | 39 | 40 |
| mode X | 36 | 37 | 38 | 39 | 40 | 41 | 42 | 43 | 44 | 45 | 46 | 47 | 48 | 49 | 50 | 51 | 52 |
| mode Y | 41 | 42 | 43 | 43 | 44 | 44 | 45 | 45 | 46 | 47 | 48 | 48 | 49 | 49 | 50 | 51 | 51 |

| mode X | 54 | 55 | 56 | 57 | 58 | 59 | 60 | 61 | 62 | 63 | 64 | 65 | 66 |
|---|---|---|---|---|---|---|---|---|---|---|---|---|---|
| mode Y | 52 | 53 | 54 | 55 | 55 | 56 | 56 | 57 | 57 | 58 | 59 | 59 | 60 |

In yet another specific implementation, for the DM mode, the DM mode refers to directly using the luma prediction mode information at the corresponding position:

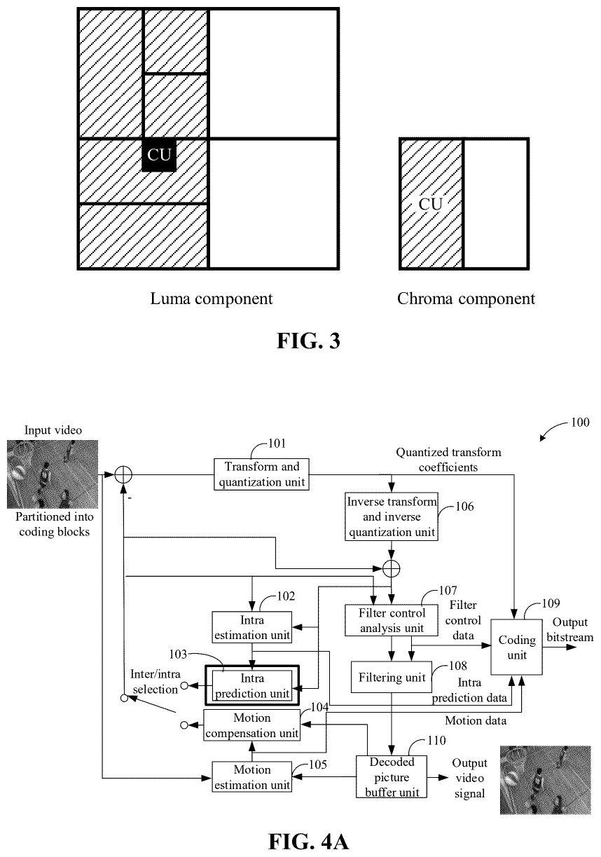

When an I-frame uses dual-tree partitioning, the luma component and the chroma component are allowed to use independent block partitioning structures. In this case, the luma component at the corresponding position of the chroma CU may include multiple luma CUs, as shown in FIG. 3. In H.266/VVC, the chroma CU inherits the intra prediction mode of a CU at the center position of the corresponding luma block, that is, intra_chroma_pred_mode is equal to 4.

The specific description of the CU position taken by the DM mode is as follows.

A luma position (xCb, yCb), specifying a position of a top-left luma sample of the luma region corresponding to the current block relative to a top-left luma sample of the current picture; a variable cbWidth, specifying a width of the current block in the luma samples; and a variable cbHeight, specifying a height of the current block in the luma samples.

A positional relationship between a current chroma CU and a corresponding luma region is shown in FIG. 3. A center luma pixel position of the luma region corresponding to the current chroma CU is described as follows, herein xCenter represents a horizontal coordinate position, yCenter represents a vertical coordinate position, and a CU including this pixel position is the CU at the center position of the luma block corresponding to the chroma CU:

$$xCenter = xCb + cbWidth ≫ 1 ;$$

$$yCenter = yCb + cbHeight ≫ 1.$$

In yet another specific implementation, for the decoding process of chroma prediction in H.266/VVC, the decoding flow is shown in Table 4. Furthermore, for a value of the syntax element intra_chroma_pred_mode, a corresponding binarization mapping table is shown in Table 5. For different syntax elements (e.g., cclm_mode_flag, cclm_mode_idx, and intra_chroma_pred_mode, etc.), the coding scheme adopted for each coding bit is shown in Table 6.

TABLE 4

| | |
|---|---|
| if( !cu_act_enabled_flag ) { | |
| if( cbWidth / SubWidthC <= MaxTsSize && | |
| cbHeight / SubHeightC <= MaxTsSize && sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| else | |
| intra_chroma_pred_mode | ae(v) |
| } | |
| } | |

TABLE 5

| Value of intra_chroma_pred_mode | Bin string |
|---|---|
| 0 | 100 |
| 1 | 101 |
| 2 | 110 |
| 3 | 111 |
| 4 | 0 |

TABLE 6

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| intra_chroma_pred_mode | 0 | bypass | bypass | na | na | na |

Herein binIdx represents a bit position. If binIdx=0, it indicates a 0th bit. If binIdx=1, it indicates a 1st bit. Furthermore, bypass indicates a bypass mode, and na indicates no processing.

In the related art, under the dual-tree partitioning: for the DM mode, if the corresponding luma block is in the IBC mode, the obtained chroma prediction mode is the DC mode, which results in a loss of coding efficiency. This is because, for chroma prediction, using a fixed DC mode for prediction leads to prediction pixels having the same value, which fails to represent the chroma texture feature content of the current block; and in chroma prediction, information from the collocated luma block in the IBC mode is not utilized, nor is there a prediction algorithm similar to block copy such as IBC, thus failing to effectively compress video sequences similar to screen content. In short, the current chroma prediction mode is relatively singular, resulting in inaccurate chroma prediction for the current block, and thus reducing the coding efficiency.

In order to solve the above problems, the embodiments of the disclosure provide an encoding method, a decoding method, an encoder, a decoder, and a storage medium. The encoder and the decoder determine at least one first colour component block of a current block; in response to the at least one first colour component block being intra predicted based on a block vector, determine at least one second block vector parameter of a second colour component block based on at least one first block vector parameter of the at least one first colour component block; and determine a prediction value of a second colour component based on the at least one second block vector parameter. Therefore, in the embodiments of the disclosure, if luma block(s) corresponding to the current block is/are intra predicted based on the block vector, the at least one second block vector parameter of a chroma component may be determined based on the block vector parameter(s) of the luma block(s), and the at least one second block vector parameter is used to predict the chroma component. That is to say, the encoding method and decoding method proposed in the embodiments of the disclosure address the problem of monotonicity in chroma prediction, make full use of related information of the collocated luma block. This improves the accuracy of chroma prediction, reduces the bitrate, improves the encoding and decoding efficiency, and thereby enhances the encoding and decoding performance.

The various embodiments of the disclosure are descripted below in detail in combination with the drawings.

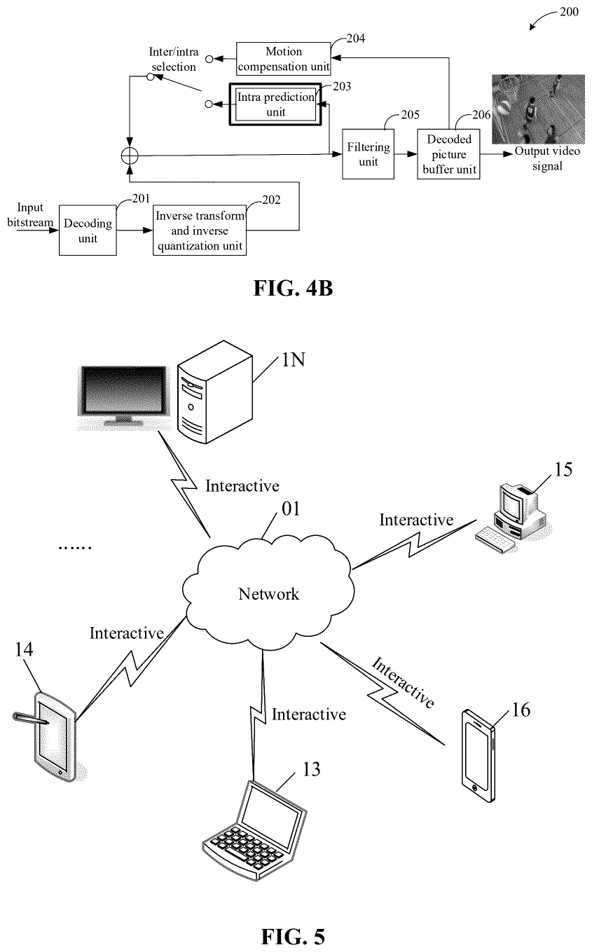

Referring to FIG. 4A, FIG. 4A illustrates a schematic block diagram of composition of an encoder according to an embodiment of the disclosure. As shown in FIG. 4A, an encoder (specifically, “a video encoder”) 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, a coding unit 109, a decoded picture buffer unit 110 and the like. Here, the filtering unit 108 may implement de-blocking filtering and sample adaptive offset (SAO) filtering. The coding unit 109 may implement header information coding and context-based adaptive binary arithmetic coding (CABAC). For an original video signal that is input, a video coding block may be obtained by applying partitioning to a coding tree unit (CTU). Then, the video coding block may be transformed by passing residual pixel information obtained by the intra prediction or inter prediction through the transform and quantization unit 101, which includes transforming the residual information from a pixel domain to a transform domain and quantizing a resulted transform coefficient to further reduce the bitrate. The intra estimation unit 102 and the intra prediction unit 103 are used for performing the intra prediction on the video coding block. Explicitly, the intra estimation unit 102 and the intra prediction unit 103 are used for determining the intra prediction mode for coding the video coding block. The motion compensation unit 104 and the motion estimation unit 105 are used for performing the inter prediction coding of a received video coding block relative to one or more blocks of one or more reference pictures, to provide temporal prediction information. The motion estimation performed by the motion estimation unit 105 is a process for generating motion vectors that may estimate the motion of the video coding block. Then, the motion compensation is performed by the motion compensation unit 104 based on the motion vectors determined by the motion estimation unit 105. After determining the intra prediction mode, the intra prediction unit 103 is further used for providing selected intra prediction data to the coding unit 109, and the motion estimation unit 105 transmits the motion vector data that is determined through calculation to the coding unit 109 too. In addition, the inverse transform and inverse quantization unit 106 is used for the reconstruction of the video coding block. A residual block is reconstructed in the pixel domain, a blocking effect artifact of the reconstructed residual block is removed by the filter control analysis unit 107 and the filtering unit 108; and then, the reconstructed residual block is added into a prediction block in a picture in the decoded picture buffer unit 110, to generate a reconstructed video coding block. The coding unit 109 is used for coding various coding parameters and quantized transform coefficients. In a CABAC-based coding algorithm, a context content may be based on neighbouring coding blocks, and may be used for coding the information that indicates the determined intra prediction mode, to output a bitstream of the video signal. The decoded picture buffer unit 110 is used for storing the reconstructed video coding block for prediction reference. As the progress of the video picture coding, new reconstructed video coding blocks are continuously generated, and all of the reconstructed video coding blocks are stored in the decoded picture buffer unit 110.

Referring to FIG. 4B, FIG. 4B illustrates a schematic block diagram of composition of a decoder according to an embodiment of the disclosure. As shown in FIG. 4B, a decoder (specifically, “a video decoder”) 200 includes a decoding unit 201, an inverse transform and inverse quantization unit 202, an intra prediction unit 203, a motion compensation unit 204, a filtering unit 205, a decoded picture buffer unit 206, and the like. Here, the decoding unit 201 may implement header information decoding and CABAC decoding. The filtering unit 205 may implement a de-blocking filtering and an SAO filtering. After the input video signal is coded by the coding process as shown in FIG. 4A, the bitstream of the video signal is output. The bitstream is input into the decoder 200, and the bitstream firstly passes through the decoding unit 201 to obtain a decoded transform coefficient. The decoded transform coefficient is processed by the inverse transform and inverse quantization unit 202, to generate a residual block in the pixel domain. The intra prediction unit 203 may be used for generating prediction data for a current video decoding block, based on the determined intra prediction mode and data from previously decoded blocks of the current frame or picture. The motion compensation unit 204 is used for determining prediction information for the video decoding block by parsing the motion vectors and other associated syntax elements, and using the prediction information to generate a prediction block of the video decoding block that is being decoded. The decoded video block is formed by summing the residual block from the inverse transform and inverse quantization unit 202 and the corresponding prediction block generated by the intra prediction unit 203 or the motion compensation unit 204. The decoded video signal passes through the filtering unit 205, to remove the blocking effect artifact, which may improve the video quality. Then, the decoded video block is stored in the decoded picture buffer unit 206. The decoded picture buffer unit 206 stores reference pictures for subsequent intra prediction or motion compensation, and is also used for outputting the video signal, that is, the restored original video signal is obtained.

Furthermore, the embodiments of the disclosure further provide a network architecture of an encoding and decoding system including an encoder and a decoder. FIG. 5 illustrates a schematic diagram of a network architecture of an encoding and decoding system according to an embodiment of the disclosure. As shown in FIG. 5, the network architecture includes one or more electronic devices 13 to IN, and a communication network 01. Here, the electronic devices 13 to IN may perform video interactions via the communication network 01. During the implementation process, the electronic devices may be various types of devices with video encoding and decoding capabilities. For example, the electronic devices may include smartphones, tablet computers, personal computers, personal digital assistants, navigators, digital telephones, video telephones, televisions, sensing devices, servers, etc., which are not specifically limited in the embodiments of the disclosure. Here, the decoder or encoder described in the embodiments of the disclosure may be the above electronic devices.

It should be noted that methods in the embodiments of the disclosure are mainly applied to the intra prediction unit 103 shown in FIG. 4A and the intra prediction unit 203 shown in FIG. 4B. That is to say, the embodiments of the disclosure may be applied to the encoder, the decoder, or even both the encoder and the decoder. However, no specific limits are made thereto in the embodiments of the disclosure.

It should be further noted that, when applied to the intra prediction unit 103, the “current block” specifically refers to a current coding block to be intra-predicted; and when applied to the intra prediction unit 203, the “current block” specifically refers to a current decoding block to be intra-predicted.

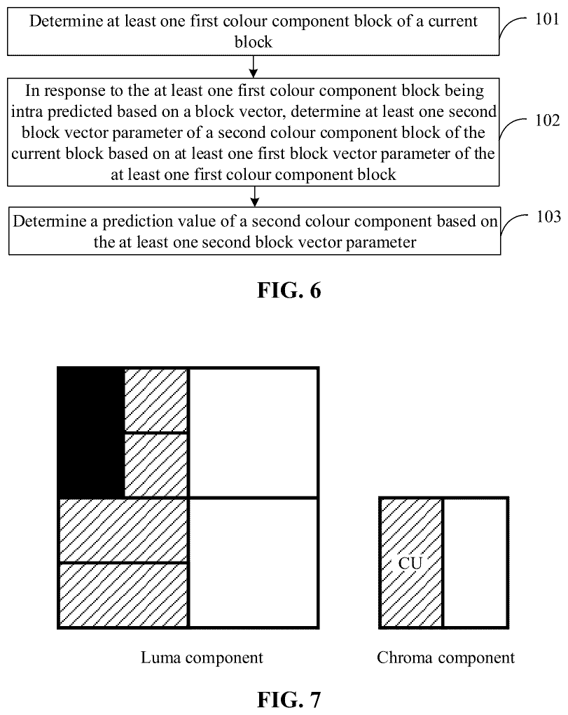

An embodiment of the disclosure provides a decoding method, which is applied to a decoder. FIG. 6 is a schematic diagram of a decoding method. As shown in FIG. 6, the method for performing decoding processing by the decoder may include the following operations 101 to 103.

At operation 101, at least one first colour component block of a current block is determined.

It should be noted that the method in the embodiment of the disclosure may be applied to an encoder or a decoder. Moreover, a prediction mode herein may specifically refer to an intra prediction mode. Here, assuming that the first colour component(s) is/are luma component(s) and a second colour component is a chroma component, then more specifically, this is a method for determining a chroma intra prediction mode.

It should be further noted that in an embodiment of the disclosure, the current block at least includes a first colour component and a second colour component. For the first colour component of the current block, this block may be simply referred to as a first colour component block. When the first colour component is a luma component, the first colour component block may also be referred to as a luma block. Similarly, for the second colour component of the current block, this block may be simply referred to as a second colour component block. When the second colour component is a chroma component, the second colour component block may also be referred to as a chroma block.

It should be further noted that under the dual-tree partitioning, for the DM mode, when a prediction mode of a collocated luma block is an IBC mode, the embodiments of the disclosure may determine BV information corresponding to the chroma of the current block based on BV information of the collocated luma block, and then use the BV information of the chroma block for intra prediction processing, which can address the problem of monotonicity in chroma prediction and thereby improve the coding efficiency.

In some embodiments, the operation that the at least one first colour component block of the current block is determined may include that: a collocated first colour component region of the current block is determined; and the at least one first colour component block of the current block is determined from multiple blocks partitioned from the first colour component region.

It should be noted that in an embodiment of the disclosure, for the current block, block partitioning may be performed on the collocated first colour component region, for example, using a binary tree structure, a ternary tree structure, a quadtree structure, etc., to obtain multiple blocks, each of which may be regarded as a CU. Then, first colour component block(s) of the current block is/are determined from the multiple CUs.

Exemplarily, taking FIG. 3 as an example, a diagonally hatched region represents the collocated luma region of the chroma CU. This collocated luma region may be partitioned into multiple blocks. A block at a center position may be selected from these blocks as a corresponding luma block of the current block, for example, a block filled with black in FIG. 3 is the corresponding luma block of the current block.

Further, in some embodiments, the operation that the at least one first colour component block of the current block is determined from the multiple blocks partitioned from the first colour component region may include that: a target block is selected from the multiple blocks partitioned from the first colour component region, and the target block is taken as the at least one first colour component block of the current block.

Here, the target block may be a block at any position. In a specific embodiment, a block at a center position in the first colour component region is selected as the target block; or a block at a top-left position in the first colour component region is selected as the target block; or a block at a bottom-right position in the first colour component region is selected as the target block.

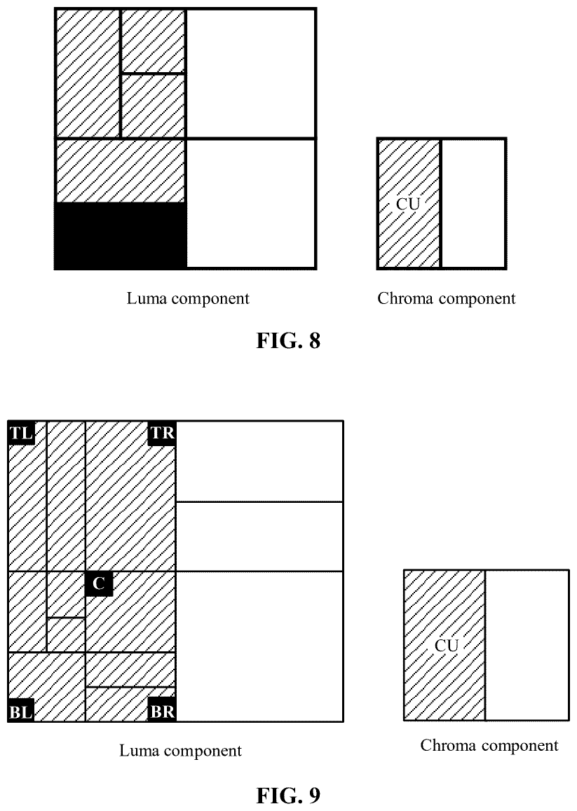

It should be understood that in an embodiment of the disclosure, the target block as the first colour component block may be a block at any position among the multiple blocks shown in FIG. 3. For example, the target block may be a block (filled with black) at the center position in the collocated luma region as shown in FIG. 3, a block (filled with black) at the top-left position in the collocated luma region as shown in FIG. 7, a block (filled with black) at the bottom-right position in the collocated luma region as shown in FIG. 8, or even a block at the top-right position or a block at the bottom-left position in the collocated luma region, or more even a block at the center position of the top-left region, etc., which is not specifically limited herein.

Further, in an embodiment of the disclosure, when selecting the target block from the multiple blocks partitioned from the first colour component region, position information of the current block may be determined first. Then, the position information of the current block is scaled according to a preset sampling format (a colour sampling format), to obtain position information of the collocated region corresponding to the current block. Further, target position information may be determined based on the position information of the collocated region, and a block including the target position information may be taken as the target block.

It may be understood that in some embodiments, a mapping relationship between position information (x, y) of the chroma block and scaled position information (xCb, yCb) of the luma block is shown in Table 7.

TABLE 7

| | colour sampling | | |
|---|---|---|---|
| sps_chroma_format_idc | format | xCb | yCb |
| 0 | monochroma | — | — |
| 1 | 4:2:0 | x <<1 | y <<1 |
| 2 | 4:2:2 | x <<1 | y |
| 3 | 4:4:4 | x | y |

Exemplarily, in an embodiment of the disclosure, when selecting the block at the center position in the first colour component region as the target block, a position of the current chroma block is obtained, that is, the position chromaPos=(x, y) of the top-left chroma sample of the current chroma block relative to the top-left chroma sample of the current picture. chromaPos is scaled according to the chroma sampling format, to obtain the position lumaPos=(xCb, yCb) of the collocated luma region corresponding to the current chroma block. Then, it is assumed that a position of the collocated luma pixel corresponding to the top-left corner of the current chroma coding block relative to the top-left luma pixel of the picture is (xCb, yCb), and a width and a height of the collocated luma region corresponding to the current chroma coding block are chWidth and cbHeight, respectively. The block at the center position of the luma region is a luma block (the block filled with black in FIG. 3) including the position coordinate (xCb+cbWidth>>1, yCb+cbHeight>>1).

Exemplarily, in an embodiment of the disclosure, when selecting the block at the top-left position in the first colour component region as the target block, the position of the current chroma block is obtained, that is, the position chromaPos=(x, y) of the top-left chroma sample of the current chroma block relative to the top-left chroma sample of the current picture. chromaPos is scaled according to the chroma sampling format, to obtain the position lumaPos=(xCb, yCb) of the collocated luma region corresponding to the current chroma block. Then, it is assumed that a position of the collocated luma pixel corresponding to the top-left corner of the current chroma coding block relative to the top-left luma pixel of the picture is (xCb, yCb), and a width and a height of the collocated luma region corresponding to the current chroma coding block are chWidth and cbHeight, respectively. The block at the top-left position of the luma region is a luma block (the block filled with black in FIG. 7) including the position coordinate (xCb, yCb).

Exemplarily, in an embodiment of the disclosure, when selecting the block at the bottom-right position in the first colour component region as the target block, the position of the current chroma block is obtained, that is, the position chromaPos=(x, y) of the top-left chroma sample of the current chroma block relative to the top-left chroma sample of the current picture. chromaPos is scaled according to the chroma sampling format, to obtain the position lumaPos=(xCb, yCb) of the collocated luma region corresponding to the current chroma block. Then, it is assumed that a position of the collocated luma pixel corresponding to the top-left corner of the current chroma coding block relative to the top-left luma pixel of the picture is (xCb, yCb), and a width and a height of the collocated luma region corresponding to the current chroma coding block are cbWidth and cbHeight, respectively. The block at the bottom-right position of the luma region is a luma block (the block filled with black in FIG. 8) including the position coordinate (xCb+cbWidth−1, yCb+cbHeight−1).

Further, in some embodiments, the operation that the at least one first colour component block of the current block is determined from the multiple blocks partitioned from the first colour component region may include that: at least one candidate block at a preset position is determined from the multiple blocks partitioned from the first colour component region; and the at least one candidate block is traversed according to a preset order, and a first candidate block among the at least one candidate block that is intra predicted based on the block vector is determined as the at least one first colour component block of the current block.

It should be understood that in an embodiment of the disclosure, the first colour component block may be further determined by determining whether the at least one candidate block at the preset position is intra predicted based on the block vector. For example, as shown in FIG. 9, it includes CUs at five luma pixel positions, specifically: C, TL, TR, BL, and BR. However, the embodiment of the disclosure is not limited to five positions, and may be multiple different positions. Moreover, it is not limited to the five positions shown in FIG. 9, and no specific limits are made thereto.

It should be further understood that in an embodiment of the disclosure, the five positions shown in FIG. 9 may be obtained in the preset order successively until a determined candidate block is intra predicted based on the block vector (that is, encoded and decoded in a mode with BV information). That is, a first CU at a luma pixel position that is intra predicted based on the block vector is found, and the first CU at the luma pixel position is taken as the corresponding luma block of the current block, i.e., the first colour component block.

That is to say, in the embodiment of the disclosure, when determining the first colour component block, the at least one candidate block at the preset position is determined, such as the blocks including five luma pixel positions shown in FIG. 9. These blocks are successively obtained until a block is determined to be coded in the mode with BV information (intra predicted based on the block vector), that is, the first block at the luma pixel position that is coded in the mode with BV information is found.

Moreover, in an embodiment of the disclosure, the preset order may include, but is not limited to, the following order: C->TL->TR->BL->BR. For a detailed derivation process of positions of C, TL, TR, BL, and BR, position information of the current block may be determined first. Then, the position information of the current block is scaled according to the preset sampling format (colour sampling format), to obtain position information of the collocated region corresponding to the current block. Subsequently, target position information may be determined based on the position information of the collocated region, and at least one block including the target position information is taken as the at least one candidate block at the preset position, such as C, TL, TR, BL, and BR.

Exemplarily, in an embodiment of the disclosure, when selecting the block at the bottom-right position in the first colour component region as the target block, the position of the current chroma block is obtained, that is, the position chromaPos=(x, y) of the top-left chroma sample of the current chroma block relative to the top-left chroma sample of the current picture. chromaPos is scaled according to the chroma sampling format (referring to Table 7), to obtain the position lumaPos=(xCb, yCb) of the collocated luma region corresponding to the current chroma block. Then, it is assumed that a position (i.e., the position of the luma pixel TL) of the collocated luma pixel corresponding to the top-left position of the current block relative to the top-left luma pixel of the picture is (xCb, yCb), and a width and a height of the collocated luma region (i.e., the entire diagonally hatched region of the luma component in FIG. 9) corresponding to the current block are cbWidth and cbHeight, respectively.

The coordinate information of the position of the luma pixel Cis (xCb+cbWidth/2, yCb+cbHeight/2).

The coordinate information of the position of the luma pixel TL is (xCb, yCb).

The coordinate information of the position of the luma pixel TR is (xCb+cbWidth−1, yCb).

The coordinate information of the position of the luma pixel BL is (xCb, yCb+cbHeight−1).

The coordinate information of the position of the luma pixel BR is (xCb+cbWidth−1, yCb+cbHeight−1).

In this way, for the current block, the corresponding first colour component block needs to be determined first. When the first colour component is the luma component, the luma block (i.e., the luma CU) at the corresponding position needs to be determined.

Further, in some embodiments, the operation that the at least one first colour component block of the current block is determined from the multiple blocks partitioned from the first colour component region may include that: at least one candidate block at a preset position is determined from the multiple blocks partitioned from the first colour component region; and the at least one candidate block is directly determined as the at least one first colour component block(s) of the current block.

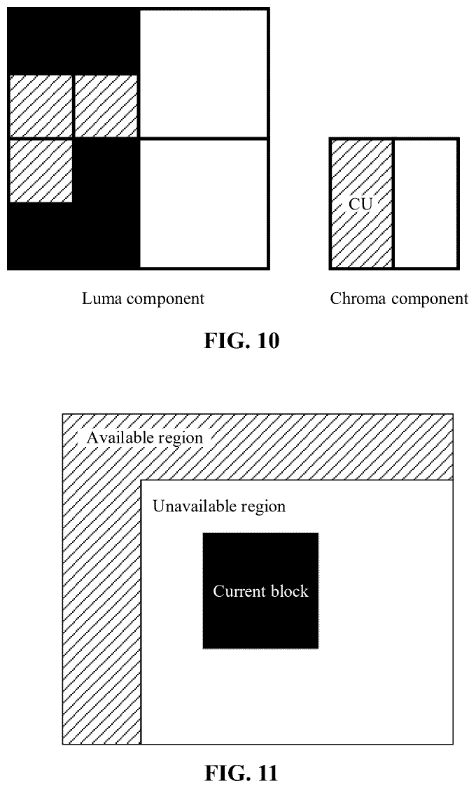

It should be understood that, in an embodiment of the disclosure, the first colour component block(s) may be further determined based on the at least one candidate block at the preset position. For example, as shown in FIG. 10, it also includes CUs at five luma pixel positions. However, the embodiment of the disclosure is not limited to five positions, and may be multiple different positions. Moreover, it is not limited to the five positions shown in FIG. 10, and no specific limits are made thereto.

It should be further understood that, in an embodiment of the disclosure, for the five positions shown in FIG. 10, CUs at multiple luma pixel positions are taken as the corresponding luma blocks of the current block, i.e., multiple first colour component blocks.

That is to say, when determining the first colour component block(s), multiple blocks in the collocated luma region may be obtained. The positions of the multiple blocks include, but are not limited to, the multiple positions shown in FIG. 10.

Further, when determining the first colour component block(s), at least one candidate block at a preset position may be determined from the multiple blocks partitioned from the first colour component region. Then, the at least one candidate block is traversed according to a preset order, and a first candidate block among the at least one candidate block that meets a preset condition is determined as the first colour component block of the current block. In response to a candidate block being intra predicted based on the block vector and a block vector parameter of the second colour component block determined based on the candidate block meeting a first availability condition, the candidate block may be determined to meet the preset condition.

It should be understood that in an embodiment of the disclosure, the first colour component block may be further determined by determining whether the at least one candidate block at the preset position meets the preset condition. For example, as shown in FIG. 9, there are CUs at five luma pixel positions, specifically: C, TL, TR, BL, and BR. However, the embodiment of the disclosure is not limited to the five positions, and may be multiple different positions. Moreover, it is not limited to the five positions shown in FIG. 9, and no specific limits are made thereto.

Furthermore, in an embodiment of the disclosure, the preset order may include, but is not limited to, the following order: C->TL->TR->BL->BR. When sequentially determining whether the at least one candidate block at the preset position meets the preset condition, whether obtained luma blocks at the five positions are coded in the mode with BV information are determined first, that is, whether the obtained luma blocks at the five positions are intra predicted based on the block vector is determined. If no obtained luma blocks at the five positions are coded in the mode with BV information, the luma blocks are not obtained, and parsing of prediction mode identification information for the second colour component may not be performed. If one or more of the luma blocks at the five positions are coded in the mode with BV information, the five positions will be re-obtained in sequence until a first luma block that meets the following conditions is found: whether the luma block is coded in the mode with BV information, and after adjusting the luma BV to obtain a chroma BV, whether the chroma BV is available. If the chroma BV is available, this luma block is selected as the final luma block from which the BV is obtained, i.e., the first colour component block.

Correspondingly, if the chroma BV is unavailable, this luma block is not obtained. Instead, the prediction is performed using modes including, but not limited to, PLANAR mode, CCLM-like modes, or other angular prediction modes. Alternatively, the first luma block that is coded in the mode with BV information is found, the BV of the first luma block is adjusted to be available, and this luma block is selected as the final luma block from which the BV is obtained, i.e., the first colour component block.

The detailed derivation process of the positions of C, TL, TR, BL, and BR includes that: it is assumed that the position (i.e., the position of the luma pixel TL) of the collocated luma pixel corresponding to the top-left corner of the current chroma coding block relative to the top-left luma pixel of the picture is (xCb, yCb), and the width and the height of the collocated luma region (i.e., the entire gray region in the left drawing of the following drawing) corresponding to the current chroma coding block is cbWidth and cbHeight, respectively.

The coordinate of the position of the luma pixel C is (xCb+cbWidth/2, yCb+cbHeight/2).

The coordinate of the position of the luma pixel TL is (xCb, yCb).

The coordinate of the position of the luma pixel TR is (xCb+cbWidth−1, yCb).

The coordinate of the position of the luma pixel BL is (xCb, yCb+cbHeight−1).

The coordinate of the position of the luma pixel BR is (xCb+cbWidth−1, yCb+cbHeight−1).

At operation 102, in response to the at least one first colour component block being intra predicted based on a block vector, at least one second block vector parameter of a second colour component block of the current block is determined based on at least one first block vector parameter of the at least one first colour component block.

It should be noted that, in the embodiment of the disclosure, after determining the first colour component block(s), whether the first colour component block(s) is/are intra predicted based on the block vector needs to be determined. In response to the first colour component block(s) being intra predicted based on the block vector, that is, it is determined that the first colour component block(s) is/are processed in the mode with BV information, the first block vector parameter(s) (e.g., BV(s) of the luma block(s)) of the first colour component block(s) may be further determined, and the second block vector parameter(s) (e.g., BV(s) of the chroma block) of the second colour component block may be determined based on the first block vector parameter(s) of the first colour component block(s).

It should be understood that, in an embodiment of the disclosure, the condition for determining whether to perform intra prediction based on the block vector may be: the prediction mode of the first colour component block(s) is the mode using BV information, herein the mode using BV information includes, but is not limited to, the IBC mode or the IntraTMP mode.

It should be noted that, in an embodiment of the disclosure, a first block vector parameter indicates a vector pointing to a reference block from the current block, and the reference block is obtained by searching in a reconstructed region of the frame (i.e., the current picture) where the current block is located.

It should be further understood that, in an embodiment of the disclosure, the first colour component block may be any number of blocks, that is, for the first colour component block of the current block, it is not limited to one block, but may also be composed of multiple blocks. Correspondingly, whether to perform intra prediction based on the block vector needs to be determined for each first colour component block. Only the first colour component that meets intra prediction based on the block vector may be used for the subsequent determination of the second block vector parameter(s) of the second colour component.

It may be understood that, in an embodiment of the disclosure, after determining the first colour component block(s), whether the first colour component block(s) is/are intra predicted based on the block vector needs to be determined, that is, whether the first colour component block(s) is/are processed in the mode with BV information is determined. In response to the first colour component block(s) being intra predicted based on the block vector, the first block vector parameter(s) of the first colour component block(s) may be determined, and the second block vector parameter(s) of the second colour component block may be determined based on the first block vector parameter(s).

Further, in an embodiment of the disclosure, in response to the first colour component block(s) being not intra predicted based on the block vector, that is, the first colour component block(s) is/are not processed in the mode with BV information, parsing of the prediction mode identification information for the second colour component may not be performed.

It should be noted that, in an embodiment of the disclosure, when determining the second block vector parameter(s) of the second colour component block based on the first block vector parameter(s) of the first colour component block(s), the first block vector parameter(s) of the first colour component block(s) may be directly determined as the second block vector parameter(s) of the second colour component block.

It should be noted that, in an embodiment of the disclosure, when determining the second block vector parameter(s) of the second colour component block based on the first block vector parameter(s) of the first colour component block(s), it is also possible to select to determine a block vector parameter candidate list of the second colour component block of the current block based on the first block vector parameter(s) of the first colour component block(s). Then, the second block vector parameter(s) of the second colour component block is/are determined based on the block vector parameter candidate list.

That is to say, in the embodiments of the disclosure, the first block vector parameter(s) of the first colour component block(s) may be directly taken as the second block vector parameter(s) of the second colour component block. Alternatively, the block vector parameter candidate list of the second colour component block may be constructed first using the first block vector parameter(s), and then the second block vector parameter(s) of the second colour component block is/are determined based on the block vector parameter candidate list.

In some embodiments, the operation that the second block vector parameter(s) of the second colour component block is/are determined based on the first block vector parameter(s) of the first colour component block(s) may include that: the first block vector parameter(s) of the first colour component block(s) is/are directly taken as the second block vector parameter(s) of the second colour component block; or the first block vector parameter(s) of the first colour component block(s) is/are adjusted to determine the second block vector parameter(s) of the second colour component block; or the block vector parameter candidate list of the second colour component block is constructed based on the first block vector parameter(s), and then the second block vector parameter(s) of the second colour component block is/are determined based on the block vector parameter candidate list.

Assuming that the first colour component block(s) is/are luma block(s), the first block vector parameter(s) may be BV(s) of the luma block(s), i.e., BVL(s). Assuming that the second colour component block is a chroma block, the second block vector parameter(s) may be BV(s) of the chroma block, i.e., BVC(s).

It may be understood that in an embodiment of the disclosure, assuming that the first block vector parameter is the luma BV=(BVLhor, BVLver) and the second block vector parameter is the chroma BV=(BVChor, BVCver), the chroma BVC candidate list including one or more candidate block vector parameters may be constructed by adjusting the BVL (luma BV) or the BVC (chroma BV).

Further, in an embodiment of the disclosure, when determining the block vector parameter candidate list of the second colour component block of the current block based on the first block vector parameter(s) of the first colour component block(s), the first block vector parameter(s) may be adjusted first to determine candidate block vector parameter(s) of the second colour component block; and then the block vector parameter candidate list may be determined based on the candidate block vector parameter(s).

It may be understood that in an embodiment of the disclosure, the adjustment processing may include scaling processing according to the chroma sampling format, herein the mapping relationship between the luma BV parameter and the scaled chroma BV parameter is shown in Table 8.

TABLE 8

| sps_chroma_{—} | Colour sampling | | |
|---|---|---|---|
| format_idc | format | BVCₕₒᵣ | BVCᵥₑᵣ |
| 0 | monochroma | — | — |
| 1 | 4:2:0 | BVLₕₒᵣ>>1 | BVLᵥₑᵣ>>1 |
| 2 | 4:2:2 | BVLₕₒᵣ>>1 | BVLᵥₑᵣ |
| 3 | 4:4:4 | BVLₕₒᵣ | BVLᵥₑᵣ |

Here, the syntax element sps_chroma_format_idc indicates the type of the colour sampling format. Here, the colour sampling format specifically refers to the chroma sampling format. Different types of chroma sampling formats corresponding to different scaling operations.

Exemplarily, if the value of sps_chroma_format_idc is 0, it is determined that the chroma sampling format is monochrome, that is, there are no chroma BV parameter (BVChor, BVCver). If the value of sps_chroma_format_idc is 1, it is determined that the chroma sampling format is 4:2:0, and the mapping relationship between the luma BV parameter and the chroma BV parameter is: BVChor=BVLhor>>1, BVCver=BVLver>>1. If the value of sps_chroma_format_idc is 2, it is determined that the chroma sampling format is 4:2:2, and the mapping relationship between the luma BV parameter and the chroma BV parameter is: BVChor=BVLhor>>1, BVCver=BVLver. If the value of sps_chroma_format_idc is 3, it is indicated that the chroma sampling format is 4:4:4, and the mapping relationship between the luma BV parameter and the chroma BV parameter is: BVChor=BVLhor, BVCver=BVLver.

Further, in an embodiment of the disclosure, when adjusting the first block vector parameter(s) to determine the candidate block vector parameter(s) of the second colour component block, the colour sampling format of the current block may be determined first; and then the first block vector parameter(s) may be scaled according to the colour sampling format to determine the candidate block vector parameter(s).

That is to say, in the embodiment of the disclosure, based on Table 8, the scaling may be performed according to the chroma sampling format, and the scaled BVC(s) as the candidate block vector parameter(s) may be added to the chroma BVC candidate list (the block vector parameter candidate list).

Further, in an embodiment of the disclosure, when adjusting the first block vector parameter(s) to determine the candidate block vector parameter(s) of the second colour component block, the colour sampling format of the current block may be determined first; then, the first block vector parameter(s) may be scaled according to the colour sampling format to determine a first initial block vector parameter; and finally, the candidate block vector parameter(s) may be determined based on the first initial block vector parameter and one or more values.

Further, in an embodiment of the disclosure, when adjusting the first block vector parameter(s) to determine the candidate block vector parameter(s) of the second colour component block, one or more second initial block vector parameters may be determined based on the first block vector parameter(s) and one or more values; and then, the colour sampling format of the current block may be determined, and the one or more second initial block vector parameters may be scaled according to the colour sampling format to determine the candidate block vector parameter(s).

It should be noted that the above one or more values may be any number of any values.

That is to say, in the embodiment of the disclosure, after obtaining the corresponding BV(s) of the luma block(s), it may be denoted by BVL(s), the chroma BV(s) obtained through the BVL(s) may be denoted by BVC(s), and a chroma BVC candidate list including one or more candidates may be constructed by adjusting the BVL(s) or the BVC(s). That is, based on Table 8, the scaling may be performed according to the chroma sampling format, and the scaled BVL(s) or BVC(s) as the candidate block vector parameter(s) may be added to the chroma BVC candidate list.

Exemplarily, in an embodiment of the disclosure, a BVL may be adjusted to form four scenarios, which in turn allows for the adjustment of the BVC. Specifically, when the BVL is odd, the four scenarios include BVL=(BVLhor, BVLver), BVL=(BVLhor+1, BVLver), BVL=(BVLhor, BVLver+1), and BVL=(BVLhor+1, BVLver+1). When the BVL is even, BVL=(BVLhor, BVLver). Then, using Table 8, the BVL(s) may be scaled according to the chroma sampling format to obtain BVC(s). In this way, when the BVL is odd, four BVC candidate block vector parameters are formed, and these candidate block vector parameters are added to the chroma BVC candidate list.

Exemplarily, in an embodiment of the disclosure, a BVL may be adjusted to form four scenarios, which in turn allows for the adjustment of the BVC. Specifically, when the BVL is odd, the four scenarios include BVL=(BVLhor, BVLver), BVL=(BVLhor+1, BVLver), BVL=(BVLhor, BVLver+1), and BVL=(BVLhor+1, BVLver+1). When the BVL is even, the four scenarios include BVL=(BVLhor, BVLver), BVL=(BVLhor−1, BVLver), BVL=(BVLhor, BVLver−1), and BVL=(BVLhor−1, BVLver−1). Then, using Table 8, the BVLs may be scaled according to the chroma sampling format to obtain BVCs. In this way, when the BVL is odd or even, four BVC candidates are formed, and these candidates are added to the chroma BVC candidate list.

Exemplarily, in an embodiment of the disclosure, the operations for both odd and even cases may be unified through the following calculations: BVL=(BVLhor−1, BVLver-1), BVL=(BVLhor+1, BVLver−1), BVL=(BVLhor−1, BVLver+1), and BVL=(BVLhor+1, BVLver+1) are directly taken for the four scenarios.

Exemplarily, in an embodiment of the disclosure, a BVL may be adjusted to form multiple scenarios, which in turn allows for the adjustment of the BVC. Specifically, when the BVL is odd, the multiple scenarios include BVL=(BVLhor, BVLver), BVL=(BVLhor+1, BVLver), BVL=(BVLhor, BVLver+1), BVL=(BVLhor+1, BVLver+1), BVL=(BVLhor+3, BVLver), BVL=(BVLhor, BVLver+3), BVL=(BVLhor+3, BVLver+3), BVL=(BVLhor−2, BVLver), BVL=(BVLhor, BVLver−2), and etc., and these candidates may be sequentially constructed into the list. When the BVL is even, the multiple scenarios include BVL=(BVLhor, BVLver), BVL=(BVLhor−1, BVLver), BVL=(BVLhor, BVLver−1), BVL=(BVLhor−1, BVLver−1), BVL=(BVLhor−3, BVLver), BVL=(BVLhor, BVLver−3), BVL=(BVLhor−3, BVLver−3), BVL=(BVLhor+2, BVLver), BVL=(BVLhor, BVLver+2), and etc. Then, using Table 8, the BVLs may be scaled according to the chroma sampling format to obtain BVCs. In this way, when the BVL is odd or even, multiple BVC candidates are formed, and these candidates are added to the chroma BVC candidate list.

Exemplarily, in an embodiment of the disclosure, the operations for both odd and even cases may be unified through the following calculations: BVL=(BVLhor−1, BVLver−1), BVL=(BVLhor+1, BVLver−1), BVL=(BVLhor−1, BVLver+1), BVL=(BVLhor+1, BVLver+1), BVL=(BVLhor+3, BVLver−1), BVL=(BVLhor−1, BVLver+3), BVL=(BVLhor+3, BVLver+3), BVL=(BVLhor−3, BVLver−1), BVL=(BVLhor−1, BVLver−3), and etc. are directly taken.

Exemplarily, in an embodiment of the disclosure, a obtained BVC may be adjusted to obtain nine candidates: BVC=(BVChor, BVCver), BVC=(BVChor−1, BVCver), BVC=(BVChor, BVCver−1), BVC=(BVChor−1, BVCver−1), BVC=(BVChor+1, BVCver), BVC=(BVChor, BVCver+1), BVC=(BVChor+1, BVCver+1), BVC=(BVChor−1, BVCver+1), and BVC=(BVChor+1, BVCver−1) are set. In this way, nine BVC candidates are formed, and these candidates are added to the chroma BVC candidate list.

Exemplarily, in an embodiment of the disclosure, a obtained BVC may be adjusted to obtain multiple candidates: BVC=(BVChor, BVCver), BVC=(BVChor−1, BVCver), BVC=(BVChor, BVCver−1), BVC=(BVChor−1, BVCver−1), BVC=(BVChor+1, BVCver), BVC=(BVChor, BVCver+1), BVC=(BVChor+1, BVCver+1), BVC=(BVChor−1, BVCver+1), BVC=(BVChor+1, BVCver−1), BVC=(BVChor−2, BVCver), BVC=(BVChor, BVCver−2), BVC=(BVChor−2, BVCver−2), BVC=(BVChor+2, BVCver), BVC=(BVChor, BVCver+2), BVC=(BVChor+2, BVCver+2), BVC=(BVChor−2, BVCver+2), BVC=(BVChor+2, BVCver−2), and etc. are set. In this way, multiple BVC candidates are formed, and these candidates are added to the chroma BVC candidate list.

Further, in an embodiment of the disclosure, when determining the block vector parameter candidate list of the second colour component block of the current block based on the first block vector parameter(s) of the first colour component block(s), an optimal block vector parameter may be determined first based on the first block vector parameter(s); then the colour sampling format of the current block is determined, and the optimal block vector parameter is scaled according to the colour sampling format to determine candidate block vector parameters of the second colour component block; and further, the block vector parameter candidate list may be determined based on the candidate block vector parameters.

Exemplarily, in an embodiment of the disclosure, in the inter prediction of the single-tree and the IBC mode under single-tree partitioning, the optimal BVL (optimal block vector parameter) is determined through RDO from luma BVs (denoted by BVLs), and then the chroma BV (denoted by BVC) is obtained by scaling the optimal block vector parameter according to the chroma sampling format. Here, scaling processing may be performed on the optimal block vector parameter using the above Table 8, or any one of the above adjustment or scaling schemes may be applied to adjust the optimal block vector parameter, to obtain the corresponding candidate block vector parameters, thereby completing the construction of the block vector parameter candidate list.

Further, in an embodiment of the disclosure, when determining the block vector parameter candidate list of the second colour component block of the current block based on the first block vector parameter(s) of the first colour component block(s), an optimal block vector parameter corresponding to the first colour component block(s) may be determined first; and then the block vector parameter candidate list of the second colour component block of the current block may be determined based on the optimal block vector parameter.

Exemplarily, in an embodiment of the disclosure, for the IntraTmp mode, the optimal mode (optimal block vector parameter, and denoted by BVL) of the luma block may be determined through fine template searching. When the IntraTmp is applied to the chroma, the block vector parameter candidate list may be constructed based on the optimal block vector parameter using any one of the above construction schemes of the list.

It should be noted that in an embodiment of the disclosure, the embodiment of the disclosure may introduce a new prediction mode, which may be denoted by INTRA_DBV. In this prediction mode, the second colour component of the current block may be predicted based on the determined second block vector parameter(s), thereby determining the prediction value of the second colour component.

It should be further noted that, in an embodiment of the disclosure, when determining the second block vector parameter(s) of the second colour component block based on the block vector parameter candidate list, whether the candidate block vector parameter(s) is/are available needs to be further determined, that is, one or more available candidate block vector parameters need to be selected from the block vector parameter candidate list.

In some embodiments, when determining the second block vector parameter(s) of the second colour component block based on the block vector parameter candidate list, it may be determined first whether one or more candidate block vector parameters meeting a first availability condition exist in the block vector parameter candidate list. In response to the one or more candidate block vector parameters meeting the first availability condition existing, the second block vector parameter(s) is/are determined based on the one or more candidate block vector parameters.

Specifically, in the embodiment of the disclosure, only when a candidate block vector parameter meets the first availability condition, the candidate block vector parameter may be determined as the second block vector parameter.

Further, in some embodiments, the operation of the one or more candidate block vector parameters meeting the first availability condition at least includes: whether an offset position indicated by the one or more candidate block vector parameters does not exceed picture boundaries; whether the offset position indicated by the one or more candidate block vector parameters does not overlap the current block; whether the offset position indicated by the one or more candidate block vector parameters does not exceed a preset available region; and whether the offset position indicated by the one or more candidate block vector parameters has been reconstructed.

It should be understood that in the embodiments of the disclosure, only when all the above conditions are met, the candidate block vector parameter(s) may be determined to meet the first availability condition, that is, the candidate block vector parameter(s) is/are available. In a specific embodiment, the operation of the candidate block vector parameter(s) meeting the first availability condition at least includes: the offset position indicated by the candidate block vector parameter(s) not exceeding picture boundaries; and the offset position indicated by the candidate block vector parameter(s) not overlapping the current block; and the offset position indicated by the candidate block vector parameter(s) not exceeding the preset available region; and the offset position indicated by the candidate block vector parameter(s) having been reconstructed.

Exemplarily, FIG. 11 shows a schematic structural diagram of whether an offset position does not overlap a current block according to an embodiment of the disclosure. As shown in FIG. 11, the block filled with black represents the current block, the diagonally hatched region represents an available region, and the unfilled region represents an unavailable region. For the current block, if the offset position indicated by the candidate block vector parameter(s) is in the unavailable region, a situation of the offset position overlapping the current block will occur.

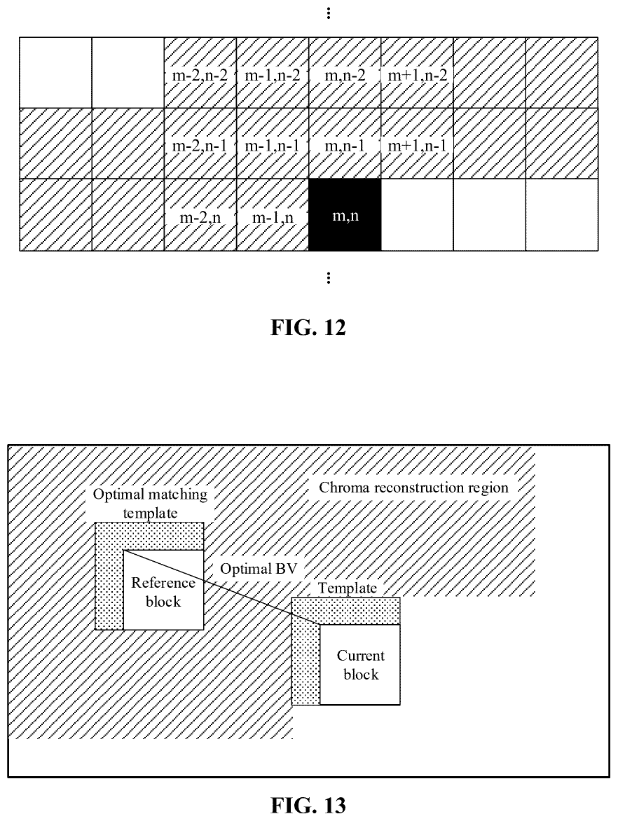

Exemplarily, FIG. 12 shows a schematic structural diagram of whether an offset position exceeds a preset available region according to an embodiment of the disclosure. As shown in FIG. 12, the block filled with black represents the current block, the diagonally hatched region represents an available region, and reference blocks within the available region have been already reconstructed. In an embodiment of the disclosure, considering the storage capacity of the Buffer, neighbouring reference blocks of the current block (m, n) may be generally taken as the preset available region, there reference blocks specifically are a reference block (m−2, n−2), a reference block (m−1, n−2), a reference block (m, n−2), a reference block (m+1, n−2), a reference block (m−2, n−1), a reference block (m−1, n−1), a reference block (m, n−1), a reference block (m+1, n−1), a reference block (m−2, n), and a reference block (m−1, n), etc.

Further, in an embodiment of the disclosure, when constructing the block vector parameter candidate list, the candidate block vector parameter(s) of the second colour component block may be determined first based on the first block vector parameter(s). In response to the candidate block vector parameter(s) meeting the first availability condition, correction processing may be performed on the candidate block vector parameter(s), and the block vector parameter candidate list may be determined based on the corrected candidate block vector parameter(s).

Correspondingly, in response to the candidate block vector parameter(s) not meeting the first availability condition, adjustment processing is performed on the candidate block vector parameter(s) until the adjusted candidate block vector parameter(s) meets/meet the first availability condition.

It should be noted that in an embodiment of the disclosure, when performing correction processing on the candidate block vector parameter(s), an offset position of the second colour component block may be determined based on the candidate block vector parameter(s) and position information of the second colour component block; and then, search processing may be performed based on the offset position of the second colour component block, and the corrected candidate block vector parameter(s) is/are determined.

It should be further understood that in an embodiment of the disclosure, after scaling the first block vector parameter(s) of the first colour component block(s) according to the colour sampling format, further correction processing needs to be performed on the obtained candidate block vector parameter(s). Before performing the correction processing, whether the candidate block vector parameter(s) meets/meet the first availability condition needs to be determined. In response to the candidate block vector parameter(s) meeting the first availability condition, correction processing is performed on the candidate block vector parameter(s) of the current block, and corrected parameter(s) is/are determined as the second block vector parameter(s); or, in response to the candidate block vector parameter(s) not meeting the first availability condition, adjustment processing is performed on the candidate block vector parameter(s) until the adjusted block vector parameter(s) meets/meet the first availability condition, correction processing is performed on the adjusted block vector parameter(s), and the corrected parameter(s) is/are determined as the second block vector parameter(s).

That is to say, in the embodiment of the disclosure, the chroma BV(s) may be corrected, and then the corrected BVC(s) may be added to the chroma BVC candidate list. At this case, there is only the corrected BVC(s) in the BVC candidate list.

Exemplarily, after obtaining the scaled chroma BV(s) according to the chroma sampling format, further correction is performed on the scaled chroma BV(s). Before performing the correction, whether the BV(s) is/are available is determined first. In response to the BV(s) being available, the correction is performed. In response to the BV(s) being unavailable, the BV(s) is/are adjusted to be available, then the correction is performed, and the corrected BVC(s) is/are added to the chroma BVC candidate list.

When determining whether a BV is available, the position (xCb, yCb) of the current chroma block may be obtained, and the chroma BVC=(BVChor, BVCver) may be obtained, the corresponding offset position (xCb+BVChor, yCb+BVCver) may be found, and in response to all of the following conditions (i.e., the first availability condition) being met, the chroma BV is available: whether the obtained offset position does not exceed the picture boundaries; whether the obtained offset position does not overlap the current block, as shown in FIG. 10; whether the obtained offset position does not exceed the preset available region, as shown in FIG. 11; and whether the obtained offset position has been reconstructed.

Exemplarily, in an embodiment of the disclosure, for the correction manner, template search may be used for correction, that is, after obtaining the corrected chroma BV parameter(s), the offset position may be found by using the position of the current block and the corrected chroma BV parameter(s), and then a fine search may be performed in the vicinity of the offset position using template matching to obtain the optimal chroma BV parameter. The reference block at the optimal offset position obtained after the fine search is copied to obtain the chroma prediction block of the current block. As shown in FIG. 13, the diagonally hatched region represents the chroma reconstruction region. For the current block, the optimal matching template and the corresponding optimal BV may be found using the template matching. The reference block of the current block may be determined based on the optimal BV (i.e., IntraTMP BV), and then the chroma prediction value of the current block may be determined.

Since whether the BV(s) is/are available is determined before performing correction, subsequent operations may bypass the determination of whether the BV(s) is/are available (whether the BV(s) meets/meet the first availability condition), and directly proceed to determinate the second block vector parameter(s).

Further, in an embodiment of the disclosure, when constructing the block vector parameter candidate list, in response to the first block vector parameter(s) meeting the second availability condition, correction processing is performed on the first block vector parameter(s), and the block vector parameter candidate list is determined based on the corrected first block vector parameter(s).

That is to say, before constructing the block vector parameter candidate list, the correction processing may be further performed on the first block vector parameter(s). For example, the luma BVL(s) is/are corrected, and then any of the above list construction schemes is used to construct the BVC candidate list.

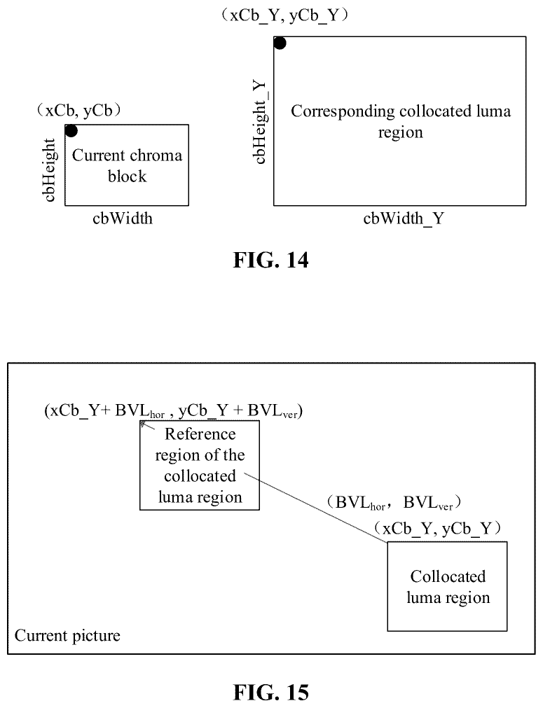

Exemplarily, in an embodiment of the disclosure, the collocated luma region corresponding to the current chroma block may be obtained first. As shown in FIG. 14, which shows a schematic diagram of coordinates and block sizes of a current chroma block and a collocated luma region, the position chromaPos=(xCb, yCb) of the current chroma block is obtained. Based on the above Table 7, chromaPos is scaled according to the chroma sampling format, to obtain the position lumaPos=(xCb_Y, yCb_Y) of the collocated luma region corresponding to the current chroma block. The size chromaSize=(cbWidth, cbHeight) of the current chroma block is obtained. Based on the mapping relationship in Table 9, chromaSize is scaled according to the chroma sampling format, to obtain the size lumaSize=(cbWidth_Y, cbHeight_Y) of the collocated luma region corresponding to the current chroma block.

TABLE 9

| sps_chroma_{—} | Colour sampling | | |
|---|---|---|---|
| format_idc | format | cbWidth_Y | cbHeight_Y |
| 0 | monochroma | — | — |
| 1 | 4:2:0 | cbWidth <<1 | cbHeight <<1 |
| 2 | 4:2:2 | cbWidth <<1 | cbHeight |
| 3 | 4:4:4 | cbWidth | cbHeight |

Exemplarily, further correction may be performed on the luma BVL(s). Before performing the correction, whether the BVL(s) is/are available (whether the BVL(s) meets/meet the second availability condition) needs to be determined first. In response to the BVL(s) being available, the correction is performed. In response to the BVL(s) being unavailable, the BVL(s) is/are adjusted to be available, and then the correction is performed.

In some embodiments, when determining whether a BVL is available, the position (xCb_Y, yCb_Y) of the collocated luma region is obtained, the luma BVL=(BVLhor, BVLver) is obtained, and the corresponding offset position (xCb_Y+BVLhor, yCb_Y+BVLver) is found. In response to the following conditions being met, the luma BVL (a first block vector parameter) is available, that is, the first block vector parameter meets the second availability condition. The conditions may at least include: an offset position indicated by the first block vector parameter not exceeding picture boundaries; the offset position indicated by the first block vector parameter not exceeding a preset available region, as shown in FIG. 12; and the offset position indicated by the first block vector parameter having been reconstructed.

Here, compared with the first availability condition, the second availability condition does not need to determine whether the offset position overlaps the collocated luma region corresponding to the current block.

Further, in an embodiment of the disclosure, when performing the correction processing, an offset position of the at least one first colour component block is determined based on the at least one first block vector parameter and position information of the at least one first colour component block; and search processing is performed based on the offset position of the at least one first colour component block to determine the at least one corrected first block vector parameter.

Exemplarily, the correction processing includes, but is not limited to, the following manner: the correction is performed using a search of the collocated luma region corresponding to the current chroma block. That is, after obtaining a luma BVL, the offset position is found using the position of the collocated luma region and the obtained luma BVL, and a fine search is performed in the vicinity of the offset position using the collocated luma region, and the range of the fine search needs to meet the limited available region, as shown in FIG. 12. Finally, the optimal luma BVL is obtained, as shown in FIG. 15 by the search in the collocated luma region.

It may be understood that in an embodiment of the disclosure, the construction manner of the block vector parameter candidate list includes but is not limited to the various situations as described above, and different manners may all be used for constructing a candidate list.

Further, in an embodiment of the disclosure, in response to one or more candidate block vector parameters meeting the first availability condition existing, then when determining a second block vector parameter based on the one or more candidate block vector parameters, a candidate block vector parameter meeting the first availability condition may be directly determined as the second block vector parameter.

That is to say, if the constructed available BVC candidate list only has one BVC candidate meeting the first availability condition, a final selected BV (a second block vector parameter) is this BVC.

Further, in an embodiment of the disclosure, in response to one or more candidate block vector parameters meeting the first availability condition existing, then when determining the second block vector parameter(s) based on the one or more candidate block vector parameters, for the multiple candidate block vector parameters meeting the first availability condition, a first matching template is determined based on the multiple candidate block vector parameters; a matching error between a first template of the current block and the first matching template is calculated according to a preset error criterion, to determine a first cost value corresponding to the multiple candidate block vector parameters; and finally, one or more second block vector parameters are determined from the multiple candidate block vector parameters based on the first cost value.

That is to say, in the embodiment of the disclosure, if there are multiple available BVC candidates in the constructed available BVC candidate list, the decision needs to be performed on these available BVCs to obtain final BV(s). The decision manner includes, but is not limited to, the decision manner using the template.

It may be understood that in an embodiment of the disclosure, the preset error criterion includes any one of sum of absolute differences (SAD), sum of absolute transformed differences (SATD), sum of squared errors (SSE), mean absolute difference (MAD), mean absolute error (MAE), and mean squared error (MSE).

Exemplarily, in the embodiment of the disclosure, when calculating the costs, that is, determining the first cost value, there are multiple choices for a cost function for calculating the costs of the template regions, that is, the preset error criterion may have multiple choices. For example, an evaluation criterion such as the sum of absolute differences (SAD), the sum of absolute transformed differences (SATD), the sum of squared errors (SSE), the mean absolute difference (MAD), the mean absolute error (MAE), and the mean squared error (MSE), etc. may be selected. The certain evaluation criterion mentioned in the following content may be one selected from the above criteria. Taking the SAD as an example of the evaluation criterion, a calculation formula is as follows:

$$S A D = {\sum }_{i = 0}^{predTempSizeW - 1} {\sum }_{j = 0}^{predTempSizeH - 1} \vert predTemp [ i ] [ j ] - recTempC [ i ] [ j ] \vert \qquad ( 1 )$$

Here, predTempSizeW is a width of the template, predTempSizeH is a height of the template, predTemp[i][j] is a pixel point of the template at BV, and recTempC[i][j] is a pixel point of the current block template.

It should be noted that, in an embodiment of the disclosure, the first template includes one or more sample values in a neighbouring decoded region of the current block.

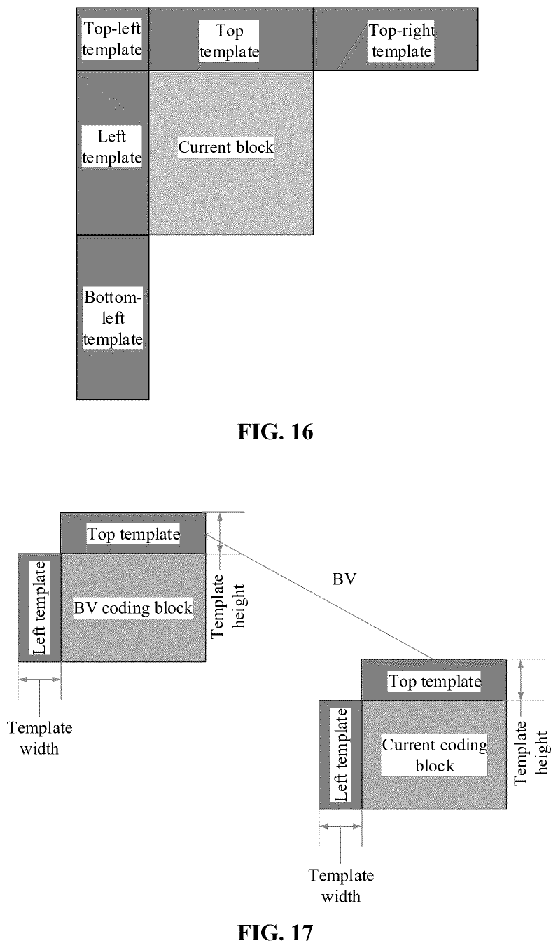

Exemplarily, in an embodiment of the disclosure, when selecting a template (the first template of the current block), whether pixels at the template position are available, including reconstructed luma information, may be determined based on the pixel availability of the neighboring regions of the current block. FIG. 16 is a schematic diagram of template types. As shown in FIG. 16, according to the relative positional relationship between the templates and the current block, the templates may be classified into types such as top template, left template, top-right template, bottom-left template, top-left template, etc. Sizes of different types of templates for different coding blocks may be fixed to be the same or different.

For example, the same template size is selected for any current coding block (the current block). The following formulas illustrate setting conditions of the template sizes, where nTbW and nTbH are the width and the height of the current luma coding block (the current block), respectively, and iTempW and iTempH are the width and the height of the adopted template, respectively:

$$top template : \{ \begin{matrix}iTempW = nTbW \\ iTempH = 1\end{matrix} \qquad ( 2 )$$

$$left template : \{ \begin{matrix}iTempW = 1 \\ iTempH = nTbH\end{matrix} \qquad ( 3 )$$

For example, different template sizes may be selected according to different sizes of the current coding block. The following formulas illustrate setting conditions of the template sizes, where nTbW and nTbH are the width and the height of the current luma coding block, respectively, and iTempW and iTempH are the width and the height of the adopted template, respectively:

$$top template : \{ \begin{matrix}\{ \begin{matrix}iTempW = nTbW \\ iTempH = 2\end{matrix} , min ( nTbW , nTbH ) \leq 4 \\ \{ \begin{matrix}iTempW = nTbW \\ iTempH = 4\end{matrix} , min ( nTbW , nTbH ) > 4\end{matrix} \qquad ( 4 )$$

$$left template : \{ \begin{matrix}\{ \begin{matrix}iTempW = 2 \\ iTempH = nTbH\end{matrix} , min ( nTbW , nTbH ) \leq 4 \\ \{ \begin{matrix}iTempW = 4 \\ iTempH = nTbH\end{matrix} , min ( nTbW , nTbH ) > 4\end{matrix} \qquad ( 5 )$$

$$Min ( x , y ) = \{ \begin{matrix}x , & x \leq y \\ y , & x > y\end{matrix}$$

For example, different template sizes may also be selected based on a number of pixels within the current luma coding block. The following formulas illustrate setting conditions of the template sizes, where nTbW and nTbH are the width and the height of the current luma coding block, respectively, nTbW×nTbH is the number of pixels within the current luma coding block, and iTempW and iTempH are the width and the height of the adopted template, respectively:

$$top template : \{ \begin{matrix}\{ \begin{matrix}iTempW = nTbW \\ iTempH = 2\end{matrix} , nTbW \times nTbH \leq 16 \\ \{ \begin{matrix}iTempW = nTbW \\ iTempH = 4\end{matrix} , nTbW \times nTbH > 16\end{matrix} \qquad ( 6 )$$

$$left template : \{ \begin{matrix}\{ \begin{matrix}iTempW = 2 \\ iTempH = nTbH\end{matrix} , nTbW \times nTbH \leq 16 \\ \{ \begin{matrix}iTempW = 4 \\ iTempH = nTbH\end{matrix} , nTbW \times nTbH > 16\end{matrix} \qquad ( 7 )$$

In some embodiments, when determining the first matching template based on the multiple candidate block vector parameters, with a position of a current point as a starting point, a region indicated by the multiple candidate block vector parameters that has a same shape and includes a same number of sample values as the first template may be determined as the first matching template.

Exemplarily, in an embodiment of the disclosure, when determining the first matching template, motion compensation is performed on the obtained multiple BVC candidates (i.e., the candidate block vector parameters that meet the first availability condition) using the first template of the current block, and templates (the first matching template) at the corresponding BVs are obtained. FIG. 17 is a schematic diagram of motion compensation of a template. As shown in FIG. 17, in response to a BV (a BVC candidate) being available, the motion compensation is performed using the first template and the new BV, and a template (i.e., a first matching template) at the corresponding BV is obtained.

There are following several scenarios for the usage of templates when calculating the costs.

For a first scenario, both a top template and a left template of the current block exist, and a top template and a left template at a corresponding BV also exist. In this case, the top templates and the left templates are available.

For a second scenario, both a top template and a left template of the current block exist, and only a top template at a corresponding BV exists. In this case, there are two schemes. For a first scheme, a left template at the corresponding BV does not exist and is simply not used, that is, only the top templates are used for calculation. For a second scheme, the left template at the corresponding BV does not exist, and a leftmost template width column inside the reference block is used to replace the left template, that is, the top templates and the left templates are used for calculation.

For a third scenario, both a top template and a left template of the current block exist, and only a left template at a corresponding BV exists. In this case, there are two schemes. For a first scheme, a top template at the corresponding BV does not exist and is simply not used, that is, only the left templates are used for calculation. For a second scheme, the top template at the corresponding BV does not exist, and a topmost template height row inside the reference block is used to replace the top template, that is, the top templates and the left templates are used for calculation.

For a fourth scenario, for the current block, only a top template exists. In this case, there are three schemes. For a first scheme, if a top template at a corresponding BV does not exist, it is simply not used, and a final selected BV is a first BVC or a certain BVC at a specified position in the BVC candidate list. For a second scheme, if the top template at the corresponding BV does not exist, a topmost template height row inside the reference block is used to replace the top template. For a third scheme, if the top template at the corresponding BV exists, it is directly used.

For a fifth scenario, for the current block, only a left template exists. In this case, there are three schemes. For a first scheme, if a left template at a corresponding BV does not exist, it is simply not used, and a final selected BV is a first BVC or a certain BVC at a specified position in the BVC candidate list. For a second scheme, if the left template at the corresponding BV does not exist, a leftmost template width column inside the reference block is used to replace the left template. For a third scheme, if the left template at the corresponding BV exists, it is directly used.

For a sixth scenario, both a top template and a left template of the current block do not exist. In this case, a final selected BV is a first BVC or a certain BVC at a specified position in the BVC candidate list.

Exemplarily, in an embodiment of the disclosure, when determining the one or more second block vector parameters based on the first cost value, except for the cases where the costs cannot be calculated, a cost is calculated for each candidate in the BVC candidate list, and then the candidates are sorted. The sorting scheme includes, but is not limited to, bubble sort, selection sort, insertion sort, Shell sort, merge sort, quick sort, radix sort, heap sort, counting sort, bucket sort, etc. BVC(s) with the smallest costs are selected in any number as final BV(s) (the second block vector parameter(s)) for chroma prediction based on the BV.

Further, in an embodiment of the disclosure, in response to all of the candidate block vector parameter(s) in the block vector parameter candidate list not meeting the first availability condition, the prediction value of the second colour component is determined according to a first preset mode.

In some embodiments, the first preset mode at least includes one of a PLANAR mode, a DM mode, a DC mode, a CCLM mode and a skip mode, but is not limited to these.

Exemplarily, when the prediction mode of the first colour component block(s) is/are not the IBC mode, the first preset mode may include, but is not limited to, the PLANAR mode, the cross component prediction mode (e.g., the CCLM mode), or other angular prediction modes, etc. Then, the reference pixel and related parameters are obtained for prediction processing. Moreover, the first preset mode may also be the skip mode, that is, the current block may skip the prediction processing of this mode.

Further, in an embodiment of the disclosure, in response to all of the candidate block vector parameter(s) in the block vector parameter candidate list not meeting the first availability condition, adjustment processing is performed on the candidate block vector parameter(s) in the block vector parameter candidate list until one or more candidate block vector parameters meeting the first availability condition exist in the block vector parameter candidate list.

That is to say, in the embodiment of the disclosure, in response to all of the candidate block vector parameter(s) in the block vector parameter candidate list being unavailable, that is, all of the candidate block vector parameter(s) in the block vector parameter candidate list do not meet the first availability condition, it may be either selected that one or more of the BVC candidates (candidate block vector parameter(s)) in the block vector parameter candidate list may be adjusted until they are available. The adjustment schemes include, but are not limited to, clipping, scaling, and etc. Alternatively, the prediction mode using BV information, e.g., the DBV mode, may be replaced by prediction mode that includes but is not limited to the PLANAR mode or the CCLM-like mode or other angular prediction modes, that is, it is selected that the prediction value of the second colour component is determined based on the first preset mode.

Exemplarily, in an embodiment of the disclosure, if the PLANAR mode or the CCLM-like mode or other angular mode is used, the reference pixels and the mode parameters may be obtained for chroma mode prediction.

At operation 103, a prediction value of a second colour component is determined based on the at least one second block vector parameter.

When determining the prediction value of the second colour component based on the second block vector parameter(s), an offset position of the current block is determined based on the second block vector parameter(s) and position information of the current block; block copy processing is performed based on the offset position of the current block, to obtain a first prediction block; and the prediction value of the second colour component is determined based on the first prediction block.

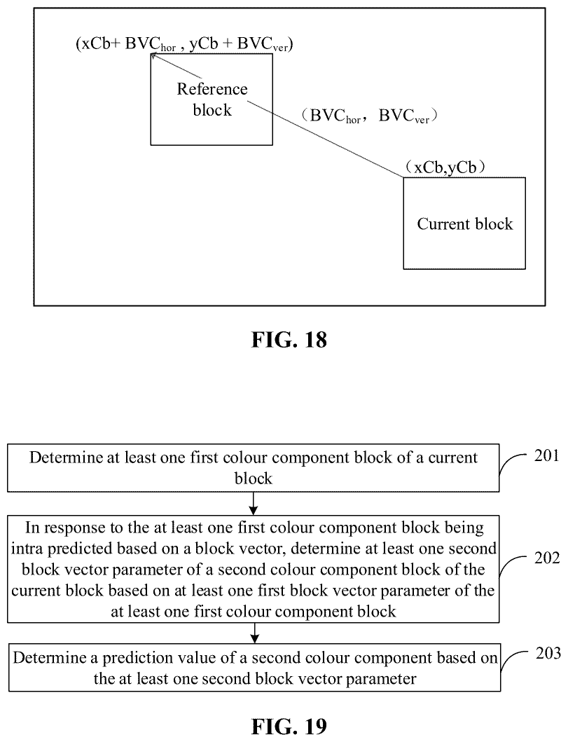

In some embodiments, in the embodiments of the disclosure, if the second colour component of the current block is predicted using the second block vector parameter(s), the position information (xCb, yCb) of the current block and the chroma BV=(BVChor, BVCver) may be obtained. Therefore, the offset position (xCb+BVChor, yCb+BVCver) can be found for block copy, as shown in FIG. 18.

Exemplarily, cbWidth represents the width of the current block in the chroma samples, cbHeight represents the height of the current block in the chroma samples, predSamples [x][y] represents the chroma prediction value of the current block, and cIdx specifies the colour component index of the current block. The specific process is as follows.

$$For x = xCb ... xCb + cbWidth - 1 , and y = yCb ... yCb + cbHeight - 1 :$$

$$xVb = ( xCb + BVChor ) \& ( IbcBufWidthC - 1 ) ;$$

$$yVb = ( yCb + BVCver ) \& ( CtbSizeC - 1 ) ;$$

$$predSamples [ x ] [ y ] = ibcVirChromaBuf [ xVb ] [ yVb ] .$$

Here, BufWidthC represents a width of chroma pixels in a stored reconstructed buffer, CtbSizeC represents a size of chroma pixels in the CTU, VirChromaBuf represents stored reconstructed chroma pixels, and function ( ) is a processing function for pixel values, which may be a direct copy, or a shift operation for ensuring calculation accuracy, or a filtering operation, etc.

Further, when determining the prediction value of the second colour component based on the second block vector parameter(s), multiple offset positions of the current block are determined based on multiple second block vector parameters and position information of the current block; block copy processing is performed based on the multiple offset positions of the current block, to obtain multiple second prediction blocks; weighted processing is performed on the multiple second prediction blocks, to determine a first prediction block; and the prediction value of the second colour component is determined based on the first prediction block.

That is to say, in an embodiment of the disclosure, if multiple BVs are determined, that is, if multiple second block vector parameters are determined based on the block vector parameter candidate list, the multiple second prediction values are obtained through the prediction based on the multiple BVs, and then these multiple second prediction values are weighted, to obtain a weighted first prediction value.

Further, in an embodiment of the disclosure, when determining the prediction value of the second colour component based on the first prediction block, it may be selected that the first prediction block is directly determined as the prediction value of the second colour component.

Further, in an embodiment of the disclosure, when determining the prediction value of the second colour component based on the first prediction block, it may also be selected that correction processing is performed on the first prediction block to determine the prediction value of the second colour component.

Here, after obtaining the first prediction value, the first prediction value may be further corrected. The correction scheme includes, but is not limited to, weighting with the CCLM-like mode or other mode.

Exemplarily, in an embodiment of the disclosure, the position (xCb, yCb) of the current chroma block may be obtained, the chroma BV=(BVChor, BVCver) may be obtained, the corresponding offset position (xCb+BVChor, yCb+BVCver) may be found, the block copy processing may be performed, and the copied value may be corrected to obtain the final prediction value. The correction scheme includes, but is not limited to, weighting with the CCLM-like mode or other mode.

Exemplarily, in a specific embodiment, the operation that the prediction value of the second colour component is determined based on the first prediction block may include that: intra prediction processing is performed on the second colour component of the current block according to a second preset mode, to obtain a second prediction block; weighted fusion processing is performed on the first prediction block and the second prediction block, to determine the prediction value of the second colour component. The second preset mode at least includes one of the following: the PLANAR mode, the DM mode, the DC mode, and the CCLM mode.

It should be understood that in an embodiment of the disclosure, for the prediction value of the second colour component, if it is obtained by block copying based on the second block vector parameter(s), the prediction value may be corrected by using a scheme including but not limited to weighting with a conventional prediction mode.

Further, in an embodiment of the disclosure, prediction mode identification information is determined. In response to the prediction mode identification information indicating that the second colour component of the current block uses a DBV mode, the second block vector parameter(s) of the second colour component block is/are determined. The prediction value of the second colour component is determined based on the second block vector parameter(s).

In an embodiment of the disclosure, whether the second colour component of the current block is allowed to use the DBV mode (the prediction is performed based on the BV information) is determined according to the prediction mode identification information. Here, the value of the prediction mode identification information may be decoded and determined, to determine whether the prediction mode identification information indicates that the second colour component of the current block uses the DBV mode.

Exemplarily, in an embodiment of the disclosure, in response to the value of the prediction mode identification information being a first value, it is determined that the prediction mode identification information indicates that the second colour component of the current block uses the BV information for prediction. In response to the value of the prediction mode identification information being a second value, it is determined that the prediction mode identification information indicates that the second colour component of the current block does not use the BV information for prediction.

In an embodiment of the disclosure, the prediction mode identification information may be denoted by intra_dbv_flag or intra_chroma_ibc_flag, used for indicating whether the second colour component of the current block uses the BV information for prediction.

In an embodiment of the disclosure, the first value and the second value are different, and the first value and the second value may be in the form of parameters or numerical values. Specifically, the prediction mode identification information may be a parameter written in the profile, or may be a value of a flag, which is not specifically limited herein.

Exemplarily, taking the first value set as 1 and the second value set as 0 as an example, the value of the prediction mode identification information is decoded and determined. In response to the value of the prediction mode identification information being 1, it may be determined that the second colour component of the current block uses the BV information for prediction. Then, the second block vector parameter(s) of the second colour component block may be determined based on the above operations, and the prediction value of the second colour component may be determined based on the second block vector parameter(s).

It may be further understood that the decoding method according to the embodiments of the disclosure may also be a modification of the DM mode in the related art, to enable the modified DM mode capable of accommodating the INTRA_DBV mode.

In an embodiment of the disclosure, under the dual-tree partitioning and the DM mode, if the corresponding luma region has BV information, the current chroma block uses the DBV mode for prediction, that is, the current chroma block may be predicted based on the BV information.

For example, if CuPredMode[0][xCb+cbWidth/2][yCb+cbHeight/2] is equal to MODE_IBC, intra_dbv_flag is set to be equal to 1, and then the chroma intra prediction mode IntraPredModeC[xCb][yCb] uses DBV.

For example, if CuPredMode[0][xCb+cbWidth/2][yCb+cbHeight/2] is equal to MODE_INTRA, and if IntraTmpFlag[xCb+cbWidth/2][yCb+cbHeight/2] is equal to 1, intra_dbv_flag is set to be equal to 1, and then the chroma intra prediction mode IntraPredModeC[xCb][yCb] uses DBV.

Here, the derivation of the chroma prediction mode is as follows.

The chroma intra prediction mode IntraPredModeC[xCb][yCb] uses cclm_mode_flag, cclm_mode_idx, and intra_chroma_pred_mode, lumaIntraPredMode, and lumaTempPredMode specified in Table 10. Herein 0 represents the Planar mode, 1 represents the DC, 18 represents the horizontal prediction mode, 50 represents the vertical prediction mode, and 81 to 83 represent CCLM prediction modes. It should be noted that these fill-in items other than the DBV mode are given as examples with corresponding values, and are not required to be filled in with these values.

TABLE 10

| | | | lumaIntraPredMode | | | | | |
|---|---|---|---|---|---|---|---|---|
| cclm_mode_{—} | cclm_mode_{—} | intra_chroma_{—} | | | | | X | intra_dbv_{—} |
| flag | idx | pred_mode | 0 | 50 | 18 | 1 | (0 <= X <= 66) | flag == 1 |
| 0 | — | 0 | 66 | 0 | 0 | 0 | 0 | 0 |
| 0 | — | 1 | 50 | 66 | 50 | 50 | 50 | 50 |
| 0 | — | 2 | 18 | 18 | 66 | 18 | 18 | 18 |
| 0 | — | 3 | 1 | 1 | 1 | 66 | 1 | 1 |
| 0 | — | 4 | 0 | 50 | 18 | 1 | X | DBV |
| 1 | 0 | — | 81 | 81 | 81 | 81 | 81 | 81 |
| 1 | 1 | — | 82 | 82 | 82 | 82 | 82 | 82 |
| 1 | 2 | | 83 | 83 | 83 | 83 | 83 | 83 |

In some embodiments, in the DM mode, if intra_dbv_flag==1, that is, the information obtained from the center position block of the collocated luma region includes BV, then the chroma intra prediction mode IntraPredModeC[xCb][yCb] uses DBV. Then, based on the decoding method including the operations 101 to 103 above, the second colour component may be predicted. Here, if the first colour component block is the center block of the collocated luma region, the BV of the corresponding luma block may be directly obtained as the first block vector parameter. Further, if the candidate block vector parameter(s) (candidate chroma BV(s)) determined based on the first block vector parameter is/are unavailable, the corresponding luma prediction mode may be obtained for the prediction of the second colour component.

That is to say, when using the INTRA_DBV mode for prediction, for the CU at the center position of the collocated luma region that is obtained, if the obtained CU at the center position of the collocated luma region is unavailable, the corresponding luma prediction mode may be obtained for chroma prediction.

Further, in an embodiment of the disclosure, in response to any block in the first colour component region being intra predicted based on the block vector, it is determined that the second colour component of the current block uses the DBV mode; the second block vector parameter(s) of the second colour component block is/are determined; and the prediction value of the second colour component is determined based on the second block vector parameter(s). That is, if it is determined that the second colour component of the current block uses the DBV mode, the second block vector parameter(s) of the second colour component block may be determined based on the above method, and the prediction value of the second colour component may be determined based on the second block vector parameter(s).

That is to say, the judgment condition for the DM mode may be that there is BV information at any position within the entire corresponding luma region. In some embodiments, in the DM mode, if the prediction information of the corresponding luma region includes BV information, the current chroma block is coded using the DBV mode. For example: if for x=xCb . . . xCb+cbWidth−1, and y=yCb . . . yCb+cbHeight−1, there is any pair (x, y) where CuPredMode[0][x][y] equals MODE_IBC, then Intra_DBV_flag is set to be 1, in which case the chroma intra prediction mode IntraPredModeC[xCb][yCb] uses DBV. If for x=xCb . . . xCb+cbWidth−1, y=yCb . . . yCb+cbHeight−1, there is any pair (x, y) where CuPredMode[0][x][y] equals MODE_INTRA and IntraTmpFlag[x][y] equals 1, then Intra_DBV_flag is set to be 1, in which case the chroma intra prediction mode IntraPredModeC[xCb][yCb] uses DBV. Herein IntraTmpFlag indicates whether to use the IntraTmp mode.

Further, in an embodiment of the disclosure, when performing transform and inverse transform on the corresponding residual of the chroma block predicted in the DBV mode, the following schemes may be included but are not limited to: a single transform may be performed (for example, only a discrete cosine transform (DCT) is performed without a low-frequency non-separable transform (LFNST)), or two transforms may be performed (a primary transform and a secondary transform, for example, the coding end first performs the DCT transform and then performs the LFNST transform). The forward transforms implemented at the decoding end are in reverse order to those at the coding end.

It should be noted that the encoding method and decoding method according to the embodiments of the disclosure, on the one hand, address the problem of monotonicity in chroma prediction, make full use of the information of the collocated luma region, and effectively enhance the accuracy of chroma prediction. On the other hand, the precision of the chroma BV is adjusted, the candidate list is constructed, and multiple possibilities may be adaptively provided according to different contents and sampling formats, making DBV prediction more effective and thereby further improving the coding efficiency.

The encoding method and decoding method proposed in the embodiments of the disclosure have been tested, and test data is shown in the following table.

TABLE 11

All Intra Main 10

| | | | | |
|---|---|---|---|---|
| Y | U | V | EncT | DecT |

| | | | |
|---|---|---|---|
| Class F | −0.38% | −0.36% | −0.36% |
| Class TGM | −1.88% | −1.99% | −2.64% |

From the test data, it may be seen that the encoding method and decoding method proposed in the embodiments of the disclosure improve the coding performance.

In view of the above, the encoding method and decoding method proposed in the embodiments of the disclosure take full account of available information such as reconstructed luma and BV, and predict the chroma based on this information, which may address the problem of monotonicity in chroma prediction; and after obtaining the luma BV(s), the luma BV(s) or the chroma BV(s) is/are adjusted to construct multiple chroma BV candidates, which may adaptively provide multiple choices according to different contents and sampling formats, making DBV prediction more effective, thereby further improving the coding efficiency.

That is to say, in the embodiments of the disclosure, the BV parameter(s) of the corresponding luma block(s) may be obtained, and the BV parameter(s) may be adjusted and applied to chroma. This addresses the problem of monotonicity in chroma prediction, makes full use of information of the collocated luma region, thereby improving the accuracy of chroma prediction and effectively improving the encoding and decoding efficiency.

The embodiments of the disclosure provide an encoding method and a decoding method. The encoder and the decoder determine at least one first colour component block of a current block; in response to the at least one first colour component block being intra predicted based on a block vector, determine at least one second block vector parameter of a second colour component block based on at least one first block vector parameter of the at least one first colour component block; and determine a prediction value of a second colour component based on the at least one second block vector parameter. Therefore, in the embodiments of the disclosure, if luma block(s) corresponding to the current block is/are intra predicted based on the block vector, the at least one second block vector parameter of a chroma component may be determined based on the block vector parameter(s) of the luma block(s), and the at least one second block vector parameter is used to predict the chroma component. That is to say, the encoding method and decoding method proposed in the embodiments of the disclosure address the problem of monotonicity in chroma prediction, make full use of related information of the collocated luma block. This improves the accuracy of chroma prediction, reduces the bitrate, improves the encoding and decoding efficiency, and thereby enhances the encoding and decoding performance.

An embodiment of the disclosure provides an encoding method, which is applied to an encoder. FIG. 19 is a schematic diagram of an encoding method. As shown in FIG. 19, the method for performing encoding processing by the encoder may include the following operations 201 to 203.

At operation 201, at least one first colour component block of a current block is determined.

It should be noted that the method in the embodiment of the disclosure may be applied to an encoder or a decoder. Moreover, a prediction mode herein may specifically refer to an intra prediction mode. Here, assuming that the first colour component(s) is/are luma component(s) and a second colour component is a chroma component, then more specifically, this is a method for determining a chroma intra prediction mode.

It should be further noted that in an embodiment of the disclosure, the current block at least includes a first colour component and a second colour component. For the first colour component of the current block, this block may be simply referred to as a first colour component block. When the first colour component is a luma component, the first colour component block may also be referred to as a luma block. Similarly, for the second colour component of the current block, this block may be simply referred to as a second colour component block. When the second colour component is a chroma component, the second colour component block may also be referred to as a chroma block.

It should be further noted that under the dual-tree partitioning, for the DM mode, when a prediction mode of a collocated luma block is an IBC mode, the embodiments of the disclosure may determine BV information corresponding to the chroma of the current block based on BV information of the collocated luma block, and then use the BV information of the chroma block for intra prediction processing, which can address the problem of monotonicity in chroma prediction and thereby improve the coding efficiency.

In some embodiments, the operation that the at least one first colour component block of the current block is determined may include that: a collocated first colour component region of the current block is determined; and the at least one first colour component block of the current block is determined from multiple blocks partitioned from the first colour component region.

It should be noted that in an embodiment of the disclosure, for the current block, block partitioning may be performed on the collocated first colour component region, for example, using a binary tree structure, a ternary tree structure, a quadtree structure, etc., to obtain multiple blocks, each of which may be regarded as a CU. Then, first colour component block(s) of the current block is/are determined from the multiple CUs.

Exemplarily, taking FIG. 3 as an example, a diagonally hatched region represents the collocated luma region of the chroma CU. This collocated luma region may be partitioned into multiple blocks. A block at a center position may be selected from these blocks as a corresponding luma block of the current block, for example, a block filled with black in FIG. 3 is the corresponding luma block of the current block.

Further, in some embodiments, the operation that the at least one first colour component block of the current block is determined from the multiple blocks partitioned from the first colour component region may include that: a target block is selected from the multiple blocks partitioned from the first colour component region, and the target block is taken as the at least one first colour component block of the current block.

Here, the target block may be a block at any position. In a specific embodiment, a block at a center position in the first colour component region is selected as the target block; or a block at a top-left position in the first colour component region is selected as the target block; or a block at a bottom-right position in the first colour component region is selected as the target block.

It should be understood that in an embodiment of the disclosure, the target block as the first colour component block may be a block at any position among the multiple blocks shown in FIG. 3. For example, the target block may be a block (filled with black) at the center position in the collocated luma region as shown in FIG. 3, a block (filled with black) at the top-left position in the collocated luma region as shown in FIG. 7, a block (filled with black) at the bottom-right position in the collocated luma region as shown in FIG. 8, or even a block at the top-right position or a block at the bottom-left position in the collocated luma region, or more even a block at the center position of the top-left region, etc., which is not specifically limited herein.

Further, in an embodiment of the disclosure, when selecting the target block from the multiple blocks partitioned from the first colour component region, position information of the current block may be determined first. Then, the position information of the current block is scaled according to a preset sampling format (a colour sampling format), to obtain position information of the collocated region corresponding to the current block. Further, target position information may be determined based on the position information of the collocated region, and a block including the target position information may be taken as the target block.

It may be understood that in some embodiments, a mapping relationship between position information (x, y) of the chroma block and scaled position information (xCb, yCb) of the luma block is shown in Table 7.

Exemplarily, in an embodiment of the disclosure, when selecting the block at the center position in the first colour component region as the target block, a position of the current chroma block is obtained, that is, the position chromaPos=(x, y) of the top-left chroma sample of the current chroma block relative to the top-left chroma sample of the current picture. chromaPos is scaled according to the chroma sampling format, to obtain the position lumaPos=(xCb, yCb) of the collocated luma region corresponding to the current chroma block. Then, it is assumed that a position of the collocated luma pixel corresponding to the top-left corner of the current chroma coding block relative to the top-left luma pixel of the picture is (xCb, yCb), and a width and a height of the collocated luma region corresponding to the current chroma coding block are chWidth and cbHeight, respectively. The block at the center position of the luma region is a luma block (the block filled with black in FIG. 3) including the position coordinate (xCb+cbWidth>>1, yCb+cbHeight>>1).

Exemplarily, in an embodiment of the disclosure, when selecting the block at the top-left position in the first colour component region as the target block, the position of the current chroma block is obtained, that is, the position chromaPos=(x, y) of the top-left chroma sample of the current chroma block relative to the top-left chroma sample of the current picture. chromaPos is scaled according to the chroma sampling format, to obtain the position lumaPos=(xCb, yCb) of the collocated luma region corresponding to the current chroma block. Then, it is assumed that a position of the collocated luma pixel corresponding to the top-left corner of the current chroma coding block relative to the top-left luma pixel of the picture is (xCb, yCb), and a width and a height of the collocated luma region corresponding to the current chroma coding block are cbWidth and cbHeight, respectively. The block at the top-left position of the luma region is a luma block (the block filled with black in FIG. 7) including the position coordinate (xCb, yCb).

Exemplarily, in an embodiment of the disclosure, when selecting the block at the bottom-right position in the first colour component region as the target block, the position of the current chroma block is obtained, that is, the position chromaPos=(x, y) of the top-left chroma sample of the current chroma block relative to the top-left chroma sample of the current picture. chromaPos is scaled according to the chroma sampling format, to obtain the position lumaPos=(xCb, yCb) of the collocated luma region corresponding to the current chroma block. Then, it is assumed that a position of the collocated luma pixel corresponding to the top-left corner of the current chroma coding block relative to the top-left luma pixel of the picture is (xCb, yCb), and a width and a height of the collocated luma region corresponding to the current chroma coding block are cbWidth and cbHeight, respectively. The block at the bottom-right position of the luma region is a luma block (the block filled with black in FIG. 8) including the position coordinate (xCb+cbWidth−1, yCb+cbHeight−1).

Further, in some embodiments, the operation that the at least one first colour component block of the current block is determined from the multiple blocks partitioned from the first colour component region may include that: at least one candidate block at a preset position is determined from the multiple blocks partitioned from the first colour component region; and the at least one candidate block is traversed according to a preset order, and a first candidate block among the at least one candidate block that is intra predicted based on the block vector is determined as the at least one first colour component block of the current block.

It should be understood that in an embodiment of the disclosure, the first colour component block may be further determined by determining whether the at least one candidate block at the preset position is intra predicted based on the block vector. For example, as shown in FIG. 9, it includes CUs at five luma pixel positions, specifically: C, TL, TR, BL, and BR. However, the embodiment of the disclosure is not limited to five positions, and may be multiple different positions. Moreover, it is not limited to the five positions shown in FIG. 9, and no specific limits are made thereto.

It should be further understood that in an embodiment of the disclosure, the five positions shown in FIG. 9 may be obtained in the preset order successively until a determined candidate block is intra predicted based on the block vector (that is, encoded and decoded in a mode with BV information). That is, a first CU at a luma pixel position that is intra predicted based on the block vector is found, and the first CU at the luma pixel position is taken as the corresponding luma block of the current block, i.e., the first colour component block.

That is to say, in the embodiment of the disclosure, when determining the first colour component block, the at least one candidate block at the preset position is determined, such as the blocks including five luma pixel positions shown in FIG. 9. These blocks are successively obtained until a block is determined to be coded in the mode with BV information (intra predicted based on the block vector), that is, the first block at the luma pixel position that is coded in the mode with BV information is found.

Moreover, in an embodiment of the disclosure, the preset order may include, but is not limited to, the following order: C->TL->TR->BL->BR. For a detailed derivation process of positions of C, TL, TR, BL, and BR, position information of the current block may be determined first. Then, the position information of the current block is scaled according to the preset sampling format (colour sampling format), to obtain position information of the collocated region corresponding to the current block. Subsequently, target position information may be determined based on the position information of the collocated region, and at least one block including the target position information is taken as the at least one candidate block at the preset position, such as C, TL, TR, BL, and BR.

Exemplarily, in an embodiment of the disclosure, when selecting the block at the bottom-right position in the first colour component region as the target block, the position of the current chroma block is obtained, that is, the position chromaPos=(x, y) of the top-left chroma sample of the current chroma block relative to the top-left chroma sample of the current picture. chromaPos is scaled according to the chroma sampling format (referring to Table 7), to obtain the position lumaPos=(xCb, yCb) of the collocated luma region corresponding to the current chroma block. Then, it is assumed that a position (i.e., the position of the luma pixel TL) of the collocated luma pixel corresponding to the top-left position of the current block relative to the top-left luma pixel of the picture is (xCb, yCb), and a width and a height of the collocated luma region (i.e., the entire diagonally hatched region of the luma component in FIG. 9) corresponding to the current block are cbWidth and cbHeight, respectively.

The coordinate information of the position of the luma pixel C is (xCb+cbWidth/2, yCb+cbHeight/2).

The coordinate information of the position of the luma pixel TL is (xCb, yCb).

The coordinate information of the position of the luma pixel TR is (xCb+cbWidth−1, yCb).

The coordinate information of the position of the luma pixel BL is (xCb, yCb+cbHeight−1).

The coordinate information of the position of the luma pixel BR is (xCb+cbWidth−1, yCb+cbHeight−1).

In this way, for the current block, the corresponding first colour component block needs to be determined first. When the first colour component is the luma component, the luma block (i.e., the luma CU) at the corresponding position needs to be determined.

Further, in some embodiments, the operation that the the at least one first colour component block of the current block is determined from the multiple blocks partitioned from the first colour component region may include that: at least one candidate block at a preset position is determined from the multiple blocks partitioned from the first colour component region; and the at least one candidate block is directly determined as the first colour component block(s) of the current block.

It should be understood that, in an embodiment of the disclosure, the first colour component block(s) may be further determined based on the at least one candidate block at the preset position. For example, as shown in FIG. 10, it also includes CUs at five luma pixel positions. However, the embodiment of the disclosure is not limited to five positions, and may be multiple different positions. Moreover, it is not limited to the five positions shown in FIG. 10, and no specific limits are made thereto.

It should be further understood that, in an embodiment of the disclosure, for the five positions shown in FIG. 10, CUs at multiple luma pixel positions are taken as the corresponding luma blocks of the current block, i.e., multiple first colour component blocks.

That is to say, when determining the first colour component block(s), multiple blocks in the collocated luma region may be obtained. The positions of the multiple blocks include, but are not limited to, the multiple positions shown in FIG. 10.

Further, when determining the first colour component block(s), at least one candidate block at a preset position may be determined from the multiple blocks partitioned from the first colour component region. Then, the at least one candidate block is traversed according to a preset order, and a first candidate block among the at least one candidate block that meets a preset condition is determined as the first colour component block of the current block. In response to a candidate block being intra predicted based on the block vector and a block vector parameter of the second colour component block determined based on the candidate block meeting a first availability condition, the candidate block may be determined to meet the preset condition.

It should be understood that in an embodiment of the disclosure, the first colour component block may be further determined by determining whether the at least one candidate block at the preset position meets the preset condition. For example, as shown in FIG. 9, there are CUs at five luma pixel positions, specifically: C, TL, TR, BL, and BR. However, the embodiment of the disclosure is not limited to the five positions, and may be multiple different positions. Moreover, it is not limited to the five positions shown in FIG. 9, and no specific limits are made thereto.

Furthermore, in an embodiment of the disclosure, the preset order may include, but is not limited to, the following order: C->TL->TR->BL->BR. When sequentially determining whether the at least one candidate block at the preset position meets the preset condition, whether obtained luma blocks at the five positions are coded in the mode with BV information are determined first, that is, whether the obtained luma blocks at the five positions are intra predicted based on the block vector is determined. If no obtained luma blocks at the five positions are coded in the mode with BV information, the luma blocks are not obtained, and an identifier of this mode is not transmitted in a bitstream. If one or more of the luma blocks at the five positions are coded in the mode with BV information, the five positions will be re-obtained in sequence until a first luma block that meets the following conditions is found: whether the luma block is coded in the mode with BV information, and after adjusting the luma BV to obtain a chroma BV, whether the chroma BV is available. If the chroma BV is available, this luma block is selected as the final luma block from which the BV is obtained, i.e., the first colour component block.

Correspondingly, if the chroma BV is unavailable, this luma block is not obtained. Instead, the prediction is performed using modes including, but not limited to, PLANAR mode, CCLM-like modes, or other angular prediction modes. Alternatively, the first luma block that is coded in the mode with BV information is found, the BV of the first luma block is adjusted to be available, and this luma block is selected as the final luma block from which the BV is obtained, i.e., the first colour component block.

The detailed derivation process of the positions of C, TL, TR, BL, and BR includes that: it is assumed that the position (i.e., the position of the luma pixel TL) of the collocated luma pixel corresponding to the top-left corner of the current chroma coding block relative to the top-left luma pixel of the picture is (xCb, yCb), and the width and the height of the collocated luma region (i.e., the entire gray region in the left drawing of the following drawing) corresponding to the current chroma coding block is cbWidth and cbHeight, respectively.

The coordinate of the position of the luma pixel C is (xCb+cbWidth/2, yCb+cbHeight/2).

The coordinate of the position of the luma pixel TL is (xCb, yCb).

The coordinate of the position of the luma pixel TR is (xCb+cbWidth−1, yCb).

The coordinate of the position of the luma pixel BL is (xCb, yCb+cbHeight−1).

The coordinate of the position of the luma pixel BR is (xCb+cbWidth−1, yCb+cbHeight−1).

At operation 202, in response to the at least one first colour component block being intra predicted based on a block vector, at least one second block vector parameter of a second colour component block of the current block is determined based on at least one first block vector parameter of the at least one first colour component block.

It should be noted that, in the embodiment of the disclosure, after determining the first colour component block(s), whether the first colour component block(s) is/are intra predicted based on the block vector needs to be determined. In response to the first colour component block(s) being intra predicted based on the block vector, that is, it is determined that the first colour component block(s) is/are processed in the mode with BV information, the first block vector parameter(s) (e.g., BV(s) of the luma block(s)) of the first colour component block(s) may be further determined, and the second block vector parameter(s) (e.g., BV(s) of the chroma block) of the second colour component block may be determined based on the first block vector parameter(s) of the first colour component block(s).

It should be understood that, in an embodiment of the disclosure, the condition for determining whether to perform intra prediction based on the block vector may be: the prediction mode of the first colour component block(s) is the mode using BV information, herein the mode using BV information includes, but is not limited to, the IBC mode or the IntraTMP mode.

It should be noted that, in an embodiment of the disclosure, a first block vector parameter indicates a vector pointing to a reference block from the current block, and the reference block is obtained by searching in a reconstructed region of the frame (i.e., the current picture) where the current block is located.

It should be further understood that, in an embodiment of the disclosure, the first colour component block may be any number of blocks, that is, for the first colour component block of the current block, it is not limited to one block, but may also be composed of multiple blocks. Correspondingly, whether to perform intra prediction based on the block vector needs to be determined for each first colour component block. Only the first colour component that meets intra prediction based on the block vector may be used for the subsequent determination of the second block vector parameter(s) of the second colour component.

It may be understood that, in an embodiment of the disclosure, after determining the first colour component block(s), whether the first colour component block(s) is/are intra predicted based on the block vector needs to be determined, that is, whether the first colour component block(s) is/are processed in the mode with BV information is determined. In response to the first colour component block(s) being intra predicted based on the block vector, the first block vector parameter(s) of the first colour component block(s) may be determined, and the second block vector parameter(s) of the second colour component block may be determined based on the first block vector parameter(s).

Further, in an embodiment of the disclosure, in response to the first colour component block(s) being not intra predicted based on the block vector, that is, the first colour component block(s) is/are not processed in the mode with BV information, an identifier of this mode may be not transmitted in a bitstream.

It should be noted that, in an embodiment of the disclosure, when determining the second block vector parameter(s) of the second colour component block based on the first block vector parameter(s) of the first colour component block(s), the first block vector parameter(s) of the first colour component block(s) may be directly determined as the second block vector parameter(s) of the second colour component block.

It should be noted that, in an embodiment of the disclosure, when determining the second block vector parameter(s) of the second colour component block based on the first block vector parameter(s) of the first colour component block(s), it is also possible to select to determine a block vector parameter candidate list of the second colour component block of the current block based on the first block vector parameter(s) of the first colour component block(s). Then, the second block vector parameter(s) of the second colour component block is/are determined based on the block vector parameter candidate list.

That is to say, in the embodiments of the disclosure, the first block vector parameter(s) of the first colour component block(s) may be directly taken as the second block vector parameter(s) of the second colour component block. Alternatively, the block vector parameter candidate list of the second colour component block may be constructed first using the first block vector parameter(s), and then the second block vector parameter(s) of the second colour component block is/are determined based on the block vector parameter candidate list.

In some embodiments, the operation that the second block vector parameter(s) of the second colour component block is/are determined based on the first block vector parameter(s) of the first colour component block(s) may include that: the first block vector parameter(s) of the first colour component block(s) is/are directly taken as the second block vector parameter(s) of the second colour component block; or the first block vector parameter(s) of the first colour component block(s) is/are adjusted to determine the second block vector parameter(s) of the second colour component block; or the block vector parameter candidate list of the second colour component block is constructed based on the first block vector parameter(s), and then the second block vector parameter(s) of the second colour component block is/are determined based on the block vector parameter candidate list.

Assuming that the first colour component block(s) is/are luma block(s), the first block vector parameter(s) may be BV(s) of the luma block(s), i.e., BVL(s). Assuming that the second colour component block is a chroma block, the second block vector parameter(s) may be BV(s) of the chroma block, i.e., BVC(s).

It may be understood that in an embodiment of the disclosure, assuming that the first block vector parameter is the luma BV=(BVLhor, BVLver) and the second block vector parameter is the chroma BV=(BVChor, BVCver), the chroma BVC candidate list including one or more candidate block vector parameters may be constructed by adjusting the BVL (luma BV) or the BVC (chroma BV).

Further, in an embodiment of the disclosure, when determining the block vector parameter candidate list of the second colour component block of the current block based on the first block vector parameter(s) of the first colour component block(s), the first block vector parameter(s) may be adjusted first to determine candidate block vector parameter(s) of the second colour component block; and then the block vector parameter candidate list may be determined based on the candidate block vector parameter(s).

It may be understood that in an embodiment of the disclosure, the adjustment processing may include scaling processing according to the chroma sampling format, herein the mapping relationship between the luma BV parameter and the scaled chroma BV parameter is shown in Table 8. Here, the syntax element sps_chroma_format_idc indicates the type of the colour sampling format. Here, the colour sampling format specifically refers to the chroma sampling format. Different types of chroma sampling formats corresponding to different scaling operations.

Exemplarily, if the value of sps_chroma_format_idc is 0, it is determined that the chroma sampling format is monochrome, that is, there are no chroma BV parameter (BVChor, BVCver). If the value of sps_chroma_format_idc is 1, it is determined that the chroma sampling format is 4:2:0, and the mapping relationship between the luma BV parameter and the chroma BV parameter is: BVChor=BVLhor>>1, BVCver=BVLver>>1. If the value of sps_chroma_format_idc is 2, it is determined that the chroma sampling format is 4:2:2, and the mapping relationship between the luma BV parameter and the chroma BV parameter is: BVChor=BVLhor>>1, BVCver=BVLver. If the value of sps_chroma_format_idc is 3, it is indicated that the chroma sampling format is 4:4:4, and the mapping relationship between the luma BV parameter and the chroma BV parameter is: BVChor=BVLhor, BVCver=BVLver.

Further, in an embodiment of the disclosure, when adjusting the first block vector parameter(s) to determine the candidate block vector parameter(s) of the second colour component block, the colour sampling format of the current block may be determined first; and then the first block vector parameter(s) may be scaled according to the colour sampling format to determine the candidate block vector parameter(s).

That is to say, in the embodiment of the disclosure, based on Table 8, the scaling may be performed according to the chroma sampling format, and the scaled BVC(s) as the candidate block vector parameter(s) may be added to the chroma BVC candidate list (the block vector parameter candidate list).

Further, in an embodiment of the disclosure, when adjusting the first block vector parameter(s) to determine the candidate block vector parameter(s) of the second colour component block, the colour sampling format of the current block may be determined first; then, the first block vector parameter(s) may be scaled according to the colour sampling format to determine a first initial block vector parameter; and finally, the candidate block vector parameter(s) may be determined based on the first initial block vector parameter and one or more values.

Further, in an embodiment of the disclosure, when adjusting the first block vector parameter(s) to determine the candidate block vector parameter(s) of the second colour component block, one or more second initial block vector parameters may be determined based on the first block vector parameter(s) and one or more values; and then, the colour sampling format of the current block may be determined, and the one or more second initial block vector parameters may be scaled according to the colour sampling format to determine the candidate block vector parameter(s).

It should be noted that the above one or more values may be any number of any values.

That is to say, in the embodiment of the disclosure, after obtaining the corresponding BV(s) of the luma block(s), it may be denoted by BVL(s), the chroma BV(s) obtained through the BVL(s) may be denoted by BVC(s), and a chroma BVC candidate list including one or more candidates may be constructed by adjusting the BVL(s) or the BVC(s). That is, based on Table 8, the scaling may be performed according to the chroma sampling format, and the scaled BVL(s) or BVC(s) as the candidate block vector parameter(s) may be added to the chroma BVC candidate list.

Exemplarily, in an embodiment of the disclosure, a BVL may be adjusted to form four scenarios, which in turn allows for the adjustment of the BVC. Specifically, when the BVL is odd, the four scenarios include BVL=(BVLhor, BVLver), BVL=(BVLhor+1, BVLver), BVL=(BVLhor, BVLver+1), and BVL=(BVLhor+1, BVLver+1). When the BVL is even, BVL=(BVLhor, BVLver). Then, using Table 8, the BVL(s) may be scaled according to the chroma sampling format to obtain BVC(s). In this way, when the BVL is odd, four BVC candidate block vector parameters are formed, and these candidate block vector parameters are added to the chroma BVC candidate list.

Exemplarily, in an embodiment of the disclosure, a BVL may be adjusted to form four scenarios, which in turn allows for the adjustment of the BVC. Specifically, when the BVL is odd, the four scenarios include BVL=(BVLhor, BVLver), BVL=(BVLhor+1, BVLver), BVL=(BVLhor, BVLver+1), and BVL=(BVLhor+1, BVLver+1). When the BVL is even, the four scenarios include BVL=(BVLhor, BVLver), BVL=(BVLhor−1, BVLver), BVL=(BVLhor, BVLver−1), and BVL=(BVLhor−1, BVLver−1). Then, using Table 8, the BVLs may be scaled according to the chroma sampling format to obtain BVCs. In this way, when the BVL is odd or even, four BVC candidates are formed, and these candidates are added to the chroma BVC candidate list.

Exemplarily, in an embodiment of the disclosure, the operations for both odd and even cases may be unified through the following calculations: BVL=(BVLhor−1, BVLver-1), BVL=(BVLhor+1, BVLver−1), BVL=(BVLhor−1, BVLver+1), and BVL=(BVLhor+1, BVLver+1) are directly taken for the four scenarios.

Exemplarily, in an embodiment of the disclosure, a BVL may be adjusted to form multiple scenarios, which in turn allows for the adjustment of the BVC. Specifically, when the BVL is odd, the multiple scenarios include BVL=(BVLhor, BVLver), BVL=(BVLhor+1, BVLver), BVL=(BVLhor, BVLver+1), BVL=(BVLhor+1, BVLver+1), BVL=(BVLhor+3, BVLver), BVL=(BVLhor, BVLver+3), BVL=(BVLhor+3, BVLver+3), BVL=(BVLhor−2, BVLver), BVL=(BVLhor, BVLver−2), and etc., and these candidates may be sequentially constructed into the list. When the BVL is even, the multiple scenarios include BVL=(BVLhor, BVLver), BVL=(BVLhor−1, BVLver), BVL=(BVLhor, BVLver−1), BVL=(BVLhor−1, BVLver−1), BVL=(BVLhor−3, BVLver), BVL=(BVLhor, BVLver−3), BVL=(BVLhor−3, BVLver−3), BVL=(BVLhor+2, BVLver), BVL=(BVLhor, BVLver+2), and etc. Then, using Table 8, the BVLs may be scaled according to the chroma sampling format to obtain BVCs. In this way, when the BVL is odd or even, multiple BVC candidates are formed, and these candidates are added to the chroma BVC candidate list.

Exemplarily, in an embodiment of the disclosure, the operations for both odd and even cases may be unified through the following calculations: BVL=(BVLhor−1, BVLver−1), BVL=(BVLhor+1, BVLver−1), BVL=(BVLhor−1, BVLver+1), BVL=(BVLhor+1, BVLver+1), BVL=(BVLhor+3, BVLver−1), BVL=(BVLhor−1, BVLver+3), BVL=(BVLhor+3, BVLver+3), BVL=(BVLhor−3, BVLver−1), BVL=(BVLhor−1, BVLver−3), and etc. are directly taken.

Exemplarily, in an embodiment of the disclosure, a obtained BVC may be adjusted to obtain nine candidates: BVC=(BVChor, BVCver), BVC=(BVChor−1, BVCver), BVC=(BVChor, BVCver−1), BVC=(BVChor−1, BVCver−1), BVC=(BVChor+1, BVCver), BVC=(BVChor, BVCver+1), BVC=(BVChor+1, BVCver+1), BVC=(BVChor−1, BVCver+1), and BVC=(BVChor+1, BVCver−1) are set. In this way, nine BVC candidates are formed, and these candidates are added to the chroma BVC candidate list.

Exemplarily, in an embodiment of the disclosure, a obtained BVC may be adjusted to obtain multiple candidates: BVC=(BVChor, BVCver), BVC=(BVChor−1, BVCver), BVC=(BVChor, BVCver−1), BVC=(BVChor−1, BVCver−1), BVC=(BVChor+1, BVCver), BVC=(BVChor, BVCver+1), BVC=(BVChor+1, BVCver+1), BVC=(BVChor−1, BVCver+1), BVC=(BVChor+1, BVCver−1), BVC=(BVChor−2, BVCver), BVC=(BVChor, BVCver−2), BVC=(BVChor−2, BVCver−2), BVC=(BVChor+2, BVCver), BVC=(BVChor, BVCver+2), BVC=(BVChor+2, BVCver+2), BVC=(BVChor−2, BVCver+2), BVC=(BVChor+2, BVCver−2), and etc. are set. In this way, multiple BVC candidates are formed, and these candidates are added to the chroma BVC candidate list.

Further, in an embodiment of the disclosure, when determining the block vector parameter candidate list of the second colour component block of the current block based on the first block vector parameter(s) of the first colour component block(s), an optimal block vector parameter may be determined first based on the first block vector parameter(s); then the colour sampling format of the current block is determined, and the optimal block vector parameter is scaled according to the colour sampling format to determine candidate block vector parameters of the second colour component block; and further, the block vector parameter candidate list may be determined based on the candidate block vector parameters.

Exemplarily, in an embodiment of the disclosure, in the inter prediction of the [00381] single-tree and the IBC mode under single-tree partitioning, the optimal BVL (optimal block vector parameter) is determined through RDO from luma BVs (denoted by BVLs), and then the chroma BV (denoted by BVC) is obtained by scaling the optimal block vector parameter according to the chroma sampling format. Here, scaling processing may be performed on the optimal block vector parameter using the above Table 8, or any one of the above adjustment or scaling schemes may be applied to adjust the optimal block vector parameter, to obtain the corresponding candidate block vector parameters, thereby completing the construction of the block vector parameter candidate list.

Further, in an embodiment of the disclosure, when determining the block vector parameter candidate list of the second colour component block of the current block based on the first block vector parameter(s) of the first colour component block(s), an optimal block vector parameter corresponding to the first colour component block(s) may be determined first; and then the block vector parameter candidate list of the second colour component block of the current block may be determined based on the optimal block vector parameter.

Exemplarily, in an embodiment of the disclosure, for the IntraTmp mode, the optimal mode (optimal block vector parameter, and denoted by BVL) of the luma block may be determined through fine template searching. When the IntraTmp is applied to the chroma, the block vector parameter candidate list may be constructed based on the optimal block vector parameter using any one of the above construction schemes of the list.

It should be noted that in an embodiment of the disclosure, the embodiment of the disclosure may introduce a new prediction mode, which may be denoted by INTRA_DBV. In this prediction mode, the second colour component of the current block may be predicted based on the determined second block vector parameter(s), thereby determining the prediction value of the second colour component.

It should be further noted that, in an embodiment of the disclosure, when determining the second block vector parameter(s) of the second colour component block based on the block vector parameter candidate list, whether the candidate block vector parameter(s) is/are available needs to be further determined, that is, one or more available candidate block vector parameters need to be selected from the block vector parameter candidate list.

In some embodiments, when determining the second block vector parameter(s) of the second colour component block based on the block vector parameter candidate list, it may be determined first whether one or more candidate block vector parameters meeting a first availability condition exist in the block vector parameter candidate list. In response to the one or more candidate block vector parameters meeting the first availability condition existing, the second block vector parameter(s) is/are determined based on the one or more candidate block vector parameters.

Specifically, in the embodiment of the disclosure, only when a candidate block vector parameter meets the first availability condition, the candidate block vector parameter may be determined as the second block vector parameter.

Further, in some embodiments, the operation of the one or more candidate block vector parameters meeting the first availability condition at least includes: whether an offset position indicated by the one or more candidate block vector parameters does not exceed picture boundaries; whether the offset position indicated by the one or more candidate block vector parameters does not overlap the current block; whether the offset position indicated by the one or more candidate block vector parameters does not exceed a preset available region; and whether the offset position indicated by the one or more candidate block vector parameters has been reconstructed.

It should be understood that in the embodiments of the disclosure, only when all the above conditions are met, the candidate block vector parameter(s) may be determined to meet the first availability condition, that is, the candidate block vector parameter(s) is/are available. In a specific embodiment, the operation of the candidate block vector parameter(s) meeting the first availability condition at least includes: the offset position indicated by the candidate block vector parameter(s) not exceeding picture boundaries; and the offset position indicated by the candidate block vector parameter(s) not overlapping the current block; and the offset position indicated by the candidate block vector parameter(s) not exceeding the preset available region; and the offset position indicated by the candidate block vector parameter(s) having been reconstructed.

Exemplarily, as shown in FIG. 11, the block filled with black represents the current block, the diagonally hatched region represents an available region, and the unfilled region represents an unavailable region. For the current block, if the offset position indicated by the candidate block vector parameter(s) is in the unavailable region, a situation of the offset position overlapping the current block will occur.

Exemplarily, as shown in FIG. 12, the block filled with black represents the current block, the diagonally hatched region represents an available region, and reference blocks within the available region have been already reconstructed. In an embodiment of the disclosure, considering the storage capacity of the Buffer, neighbouring reference blocks of the current block (m, n) may be generally taken as the preset available region, there reference blocks specifically are a reference block (m−2, n−2), a reference block (m−1, n−2), a reference block (m, n−2), a reference block (m+1, n−2), a reference block (m−2, n−1), a reference block (m−1, n−1), a reference block (m, n−1), a reference block (m+1, n−1), a reference block (m−2, n), and a reference block (m−1, n), etc.

Further, in an embodiment of the disclosure, when constructing the block vector parameter candidate list, the candidate block vector parameter(s) of the second colour component block may be determined first based on the first block vector parameter(s). In response to the candidate block vector parameter(s) meeting the first availability condition, correction processing may be performed on the candidate block vector parameter(s), and the block vector parameter candidate list may be determined based on the corrected candidate block vector parameter(s).

Correspondingly, in response to the candidate block vector parameter(s) not meeting the first availability condition, adjustment processing is performed on the candidate block vector parameter(s) until the adjusted candidate block vector parameter(s) meets/meet the first availability condition.

It should be noted that in an embodiment of the disclosure, when performing correction processing on the candidate block vector parameter(s), an offset position of the second colour component block may be determined based on the candidate block vector parameter(s) and position information of the second colour component block; and then, search processing may be performed based on the offset position of the second colour component block, and the corrected candidate block vector parameter(s) is/are determined.

It should be further understood that in an embodiment of the disclosure, after scaling the first block vector parameter(s) of the first colour component block(s) according to the colour sampling format, further correction processing needs to be performed on the obtained candidate block vector parameter(s). Before performing the correction processing, whether the candidate block vector parameter(s) meets/meet the first availability condition needs to be determined. In response to the candidate block vector parameter(s) meeting the first availability condition, correction processing is performed on the candidate block vector parameter(s) of the current block, and corrected parameter(s) is/are determined as the second block vector parameter(s); or, in response to the candidate block vector parameter(s) not meeting the first availability condition, adjustment processing is performed on the candidate block vector parameter(s) until the adjusted block vector parameter(s) meets/meet the first availability condition, correction processing is performed on the adjusted block vector parameter(s), and the corrected parameter(s) is/are determined as the second block vector parameter(s).

That is to say, in the embodiment of the disclosure, the chroma BV(s) may be corrected, and then the corrected BVC(s) may be added to the chroma BVC candidate list. At this case, there is only the corrected BVC(s) in the BVC candidate list.

Exemplarily, after obtaining the scaled chroma BV(s) according to the chroma sampling format, further correction is performed on the scaled chroma BV(s). Before performing the correction, whether the BV(s) is/are available is determined first. In response to the BV(s) being available, the correction is performed. In response to the BV(s) being unavailable, the BV(s) is/are adjusted to be available, then the correction is performed, and the corrected BVC(s) is/are added to the chroma BVC candidate list.

When determining whether a BV is available, the position (xCb, yCb) of the current chroma block may be obtained, and the chroma BVC=(BVChor, BVCver) may be obtained, the corresponding offset position (xCb+BVChor, yCb+BVCver) may be found, and in response to all of the following conditions (i.e., the first availability condition) being met, the chroma BV is available: whether the obtained offset position does not exceed the picture boundaries; whether the obtained offset position does not overlap the current block, as shown in FIG. 10; whether the obtained offset position does not exceed the preset available region, as shown in FIG. 11; and whether the obtained offset position has been reconstructed.

Exemplarily, in an embodiment of the disclosure, for the correction manner, template search may be used for correction, that is, after obtaining the corrected chroma BV parameter(s), the offset position may be found by using the position of the current block and the corrected chroma BV parameter(s), and then a fine search may be performed in the vicinity of the offset position using template matching to obtain the optimal chroma BV parameter. The reference block at the optimal offset position obtained after the fine search is copied to obtain the chroma prediction block of the current block. As shown in FIG. 13, the diagonally hatched region represents the chroma reconstruction region. For the current block, the optimal matching template and the corresponding optimal BV may be found using the template matching. The reference block of the current block may be determined based on the optimal BV (i.e., IntraTMP BV), and then the chroma prediction value of the current block may be determined.

Since whether the BV(s) is/are available is determined before performing correction, subsequent operations may bypass the determination of whether the BV(s) is/are available (whether the BV(s) meets/meet the first availability condition), and directly proceed to determinate the second block vector parameter(s).

Further, in an embodiment of the disclosure, when constructing the block vector parameter candidate list, in response to the first block vector parameter(s) meeting the second availability condition, correction processing is performed on the first block vector parameter(s), and the block vector parameter candidate list is determined based on the corrected first block vector parameter(s).

That is to say, before constructing the block vector parameter candidate list, the correction processing may be further performed on the first block vector parameter(s). For example, the luma BVL(s) is/are corrected, and then any of the above list construction schemes is used to construct the BVC candidate list.

Exemplarily, in an embodiment of the disclosure, the collocated luma region corresponding to the current chroma block may be obtained first. As shown in FIG. 14, which shows a schematic diagram of coordinates and block sizes of a current chroma block and a collocated luma region, the position chromaPos=(xCb, yCb) of the current chroma block is obtained. Based on the above Table 7, chromaPos is scaled according to the chroma sampling format, to obtain the position lumaPos=(xCb_Y, yCb_Y) of the collocated luma region corresponding to the current chroma block. The size chromaSize=(cbWidth, cbHeight) of the current chroma block is obtained. Based on the mapping relationship in Table 9, chromaSize is scaled according to the chroma sampling format, to obtain the size lumaSize=(cbWidth_Y, cbHeight_Y) of the collocated luma region corresponding to the current chroma block.

Exemplarily, further correction may be performed on the luma BVL(s). Before performing the correction, whether the BVL(s) is/are available (whether the BVL(s) meets/meet the second availability condition) needs to be determined first. In response to the BVL(s) being available, the correction is performed. In response to the BVL(s) being unavailable, the BVL(s) is/are adjusted to be available, and then the correction is performed.

In some embodiments, when determining whether a BVL is available, the position (xCb_Y, yCb_Y) of the collocated luma region is obtained, the luma BVL=(BVLhor, BVLver) is obtained, and the corresponding offset position (xCb_Y+BVLhor, yCb_Y+BVLver) is found. In response to the following conditions being met, the luma BVL (a first block vector parameter) is available, that is, the first block vector parameter meets the second availability condition. The conditions may at least include: an offset position indicated by the first block vector parameter not exceeding picture boundaries; the offset position indicated by the first block vector parameter not exceeding a preset available region, as shown in FIG. 12; and the offset position indicated by the first block vector parameter having been reconstructed.

Here, compared with the first availability condition, the second availability condition does not need to determine whether the offset position overlaps the collocated luma region corresponding to the current block.

Further, in an embodiment of the disclosure, when performing the correction processing, an offset position of the at least one first colour component block is determined based on the at least one first block vector parameter and position information of the at least one first colour component block; and search processing is performed based on the offset position of the at least one first colour component block to determine the at least one corrected first block vector parameter.

Exemplarily, the correction processing includes, but is not limited to, the following manner: the correction is performed using a search of the collocated luma region corresponding to the current chroma block. That is, after obtaining a luma BVL, the offset position is found using the position of the collocated luma region and the obtained luma BVL, and a fine search is performed in the vicinity of the offset position using the collocated luma region, and the range of the fine search needs to meet the limited available region, as shown in FIG. 12. Finally, the optimal luma BVL is obtained, as shown in FIG. 15 by the search in the collocated luma region.

It may be understood that in an embodiment of the disclosure, the construction manner of the block vector parameter candidate list includes but is not limited to the various situations as described above, and different manners may all be used for constructing a candidate list.

Further, in an embodiment of the disclosure, in response to one or more candidate block vector parameters meeting the first availability condition existing, then when determining a second block vector parameter based on the one or more candidate block vector parameters, a candidate block vector parameter meeting the first availability condition may be directly determined as the second block vector parameter.

That is to say, if the constructed available BVC candidate list only has one BVC candidate meeting the first availability condition, a final selected BV (a second block vector parameter) is this BVC.

Further, in an embodiment of the disclosure, in response to one or more candidate block vector parameters meeting the first availability condition existing, then when determining the second block vector parameter(s) based on the one or more candidate block vector parameters, for the multiple candidate block vector parameters meeting the first availability condition, a first matching template is determined based on the multiple candidate block vector parameters; a matching error between a first template of the current block and the first matching template is calculated according to a preset error criterion, to determine a first cost value corresponding to the multiple candidate block vector parameters; and finally, one or more second block vector parameters are determined from the multiple candidate block vector parameters based on the first cost value.

That is to say, in the embodiment of the disclosure, if there are multiple available BVC candidates in the constructed available BVC candidate list, the decision needs to be performed on these available BVCs to obtain final BV(s). The decision manner includes, but is not limited to, the decision manner using the template.

It may be understood that in an embodiment of the disclosure, the preset error criterion includes any one of sum of absolute differences (SAD), sum of absolute transformed differences (SATD), sum of squared errors (SSE), mean absolute difference (MAD), mean absolute error (MAE), and mean squared error (MSE).

Exemplarily, in the embodiment of the disclosure, when calculating the costs, that is, determining the first cost value, there are multiple choices for a cost function for calculating the costs of the template regions, that is, the preset error criterion may have multiple choices. For example, an evaluation criterion such as the sum of absolute differences (SAD), the sum of absolute transformed differences (SATD), the sum of squared errors (SSE), the mean absolute difference (MAD), the mean absolute error (MAE), and the mean squared error (MSE), etc. may be selected. The certain evaluation criterion mentioned in the following content may be one selected from the above criteria. Taking the SAD as an example of the evaluation criterion, a calculation formula is as the formula (1).

It should be noted that, in an embodiment of the disclosure, the first template includes one or more sample values in a neighbouring decoded region of the current block.

Exemplarily, in an embodiment of the disclosure, when selecting a template (the first template of the current block), whether pixels at the template position are available, including reconstructed luma information, may be determined based on the pixel availability of the neighboring regions of the current block. FIG. 16 is a schematic diagram of template types. As shown in FIG. 16, according to the relative positional relationship between the templates and the current block, the templates may be classified into types such as top template, left template, top-right template, bottom-left template, top-left template, etc. Sizes of different types of templates for different coding blocks may be fixed to be the same or different.

In some embodiments, when determining the first matching template based on the multiple candidate block vector parameters, with a position of a current point as a starting point, a region indicated by the multiple candidate block vector parameters that has a same shape and includes a same number of sample values as the first template may be determined as the first matching template.

Exemplarily, in an embodiment of the disclosure, when determining the first matching template, motion compensation is performed on the obtained multiple BVC candidates (i.e., the candidate block vector parameters that meet the first availability condition) using the first template of the current block, and templates (the first matching template) at the corresponding BVs are obtained. FIG. 17 is a schematic diagram of motion compensation of a template. As shown in FIG. 17, in response to a BV (a BVC candidate) being available, the motion compensation is performed using the first template and the new BV, and a template (i.e., a first matching template) at the corresponding BV is obtained.

There are following several scenarios for the usage of templates when calculating the costs.

For a first scenario, both a top template and a left template of the current block exist, and a top template and a left template at a corresponding BV also exist. In this case, the top templates and the left templates are available.

For a second scenario, both a top template and a left template of the current block exist, and only a top template at a corresponding BV exists. In this case, there are two schemes. For a first scheme, a left template at the corresponding BV does not exist and is simply not used, that is, only the top templates are used for calculation. For a second scheme, the left template at the corresponding BV does not exist, and a leftmost template width column inside the reference block is used to replace the left template, that is, the top templates and the left templates are used for calculation.

For a third scenario, both a top template and a left template of the current block exist, and only a left template at a corresponding BV exists. In this case, there are two schemes. For a first scheme, a top template at the corresponding BV does not exist and is simply not used, that is, only the left templates are used for calculation. For a second scheme, the top template at the corresponding BV does not exist, and a topmost template height row inside the reference block is used to replace the top template, that is, the top templates and the left templates are used for calculation.

For a fourth scenario, for the current block, only a top template exists. In this case, there are three schemes. For a first scheme, if a top template at a corresponding BV does not exist, it is simply not used, and a final selected BV is a first BVC or a certain BVC at a specified position in the BVC candidate list. For a second scheme, if the top template at the corresponding BV does not exist, a topmost template height row inside the reference block is used to replace the top template. For a third scheme, if the top template at the corresponding BV exists, it is directly used.

For a fifth scenario, for the current block, only a left template exists. In this case, there are three schemes. For a first scheme, if a left template at a corresponding BV does not exist, it is simply not used, and a final selected BV is a first BVC or a certain BVC at a specified position in the BVC candidate list. For a second scheme, if the left template at the corresponding BV does not exist, a leftmost template width column inside the reference block is used to replace the left template. For a third scheme, if the left template at the corresponding BV exists, it is directly used.

For a sixth scenario, both a top template and a left template of the current block do not exist. In this case, a final selected BV is a first BVC or a certain BVC at a specified position in the BVC candidate list.

Exemplarily, in an embodiment of the disclosure, when determining the one or more second block vector parameters based on the first cost value, except for the cases where the costs cannot be calculated, a cost is calculated for each candidate in the BVC candidate list, and then the candidates are sorted. The sorting scheme includes, but is not limited to, bubble sort, selection sort, insertion sort, Shell sort, merge sort, quick sort, radix sort, heap sort, counting sort, bucket sort, etc. BVC(s) with the smallest costs are selected in any number as final BV(s) (the second block vector parameter(s)) for chroma prediction based on the BV.

Further, in an embodiment of the disclosure, in response to all of the candidate block vector parameter(s) in the block vector parameter candidate list not meeting the first availability condition, the prediction value of the second colour component is determined according to a first preset mode.

In some embodiments, the first preset mode at least includes one of a PLANAR mode, a DM mode, a DC mode, a CCLM mode and a skip mode, but is not limited to these.

Exemplarily, when the prediction mode of the first colour component block(s) is/are not the IBC mode, the first preset mode may include, but is not limited to, the PLANAR mode, the cross component prediction mode (e.g., the CCLM mode), or other angular prediction modes, etc. Then, the reference pixel and related parameters are obtained for prediction processing. Moreover, the first preset mode may also be the skip mode, that is, the current block may skip the prediction processing of this mode.

Further, in an embodiment of the disclosure, in response to all of the candidate block vector parameter(s) in the block vector parameter candidate list not meeting the first availability condition, adjustment processing is performed on the candidate block vector parameter(s) in the block vector parameter candidate list until one or more candidate block vector parameters meeting the first availability condition exist in the block vector parameter candidate list.

That is to say, in the embodiment of the disclosure, in response to all of the candidate block vector parameter(s) in the block vector parameter candidate list being unavailable, that is, all of the candidate block vector parameter(s) in the block vector parameter candidate list do not meet the first availability condition, it may be either selected that one or more of the BVC candidates (candidate block vector parameter(s)) in the block vector parameter candidate list may be adjusted until they are available. The adjustment schemes include, but are not limited to, clipping, scaling, and etc. Alternatively, the prediction mode using BV information, e.g., the DBV mode, may be replaced by prediction mode that includes but is not limited to the PLANAR mode or the CCLM-like mode or other angular prediction modes, that is, it is selected that the prediction value of the second colour component is determined based on the first preset mode.

Exemplarily, in an embodiment of the disclosure, if the PLANAR mode or the CCLM-like mode or other angular mode is used, the reference pixels and the mode parameters may be obtained for chroma mode prediction.

At operation 203, a prediction value of a second colour component is determined based on the at least one second block vector parameter.

When determining the prediction value of the second colour component based on the second block vector parameter(s), an offset position of the current block is determined based on the second block vector parameter(s) and position information of the current block; block copy processing is performed based on the offset position of the current block, to obtain a first prediction block; and the prediction value of the second colour component is determined based on the first prediction block.

In some embodiments, in the embodiments of the disclosure, if the second colour component of the current block is predicted using the second block vector parameter(s), the position information (xCb, yCb) of the current block and the chroma BV=(BVChor, BVCver) may be obtained. Therefore, the offset position (xCb+BVChor, yCb+BVCver) can be found for block copy, as shown in FIG. 18.

Exemplarily, cbWidth represents the width of the current block in the chroma samples, cbHeight represents the height of the current block in the chroma samples, predSamples [x][y] represents the chroma prediction value of the current block, and cIdx specifies the colour component index of the current block. The specific process is as follows.

$$For x = xCb ... xCb + cbWidth - 1 , and y = yCb ... yCb + cbHeight - 1 :$$

$$xVb = ( xCb + BVChor ) \& ( IbcBufWidthC - 1 ) ;$$

$$yVb = ( yCb + BVCver ) \& ( CtbSizeC - 1 ) ;$$

$$predSamples [ x ] [ y ] = ibcVirChromaBuf [ xVb ] [ yVb ] .$$

Here, BufWidthC represents a width of chroma pixels in a stored reconstructed buffer, CtbSizeC represents a size of chroma pixels in the CTU, VirChromaBuf represents stored reconstructed chroma pixels, and function ( ) is a processing function for pixel values, which may be a direct copy, or a shift operation for ensuring calculation accuracy, or a filtering operation, etc.

Further, when determining the prediction value of the second colour component based on the second block vector parameter(s), multiple offset positions of the current block are determined based on multiple second block vector parameters and position information of the current block; block copy processing is performed based on the multiple offset positions of the current block, to obtain multiple second prediction blocks; weighted processing is performed on the multiple second prediction blocks, to determine a first prediction block; and the prediction value of the second colour component is determined based on the first prediction block.

That is to say, in an embodiment of the disclosure, if multiple BVs are determined, that is, if multiple second block vector parameters are determined based on the block vector parameter candidate list, the multiple second prediction values are obtained through the prediction based on the multiple BVs, and then these multiple second prediction values are weighted, to obtain a weighted first prediction value.

Further, in an embodiment of the disclosure, when determining the prediction value of the second colour component based on the first prediction block, it may be selected that the first prediction block is directly determined as the prediction value of the second colour component.

Further, in an embodiment of the disclosure, when determining the prediction value of the second colour component based on the first prediction block, it may also be selected that correction processing is performed on the first prediction block to determine the prediction value of the second colour component.

Here, after obtaining the first prediction value, the first prediction value may be further corrected. The correction scheme includes, but is not limited to, weighting with the CCLM-like mode or other mode.

Exemplarily, in an embodiment of the disclosure, the position (xCb, yCb) of the current chroma block may be obtained, the chroma BV=(BVChor, BVCver) may be obtained, the corresponding offset position (xCb+BVChor, yCb+BVCver) may be found, the block copy processing may be performed, and the copied value may be corrected to obtain the final prediction value. The correction scheme includes, but is not limited to, weighting with the CCLM-like mode or other mode.

Exemplarily, in a specific embodiment, the operation that the prediction value of the second colour component is determined based on the first prediction block may include that: intra prediction processing is performed on the second colour component of the current block according to a second preset mode, to obtain a second prediction block; weighted fusion processing is performed on the first prediction block and the second prediction block, to determine the prediction value of the second colour component. The second preset mode at least includes one of the following: the PLANAR mode, the DM mode, the DC mode, and the CCLM mode.

It should be understood that in an embodiment of the disclosure, for the prediction value of the second colour component, if it is obtained by block copying based on the second block vector parameter(s), the prediction value may be corrected by using a scheme including but not limited to weighting with a conventional prediction mode.

Further, in an embodiment of the disclosure, prediction mode identification information is determined. In response to the prediction mode identification information indicating that the second colour component of the current block uses a DBV mode, the second block vector parameter(s) of the second colour component block is/are determined. The prediction value of the second colour component is determined based on the second block vector parameter(s).

In an embodiment of the disclosure, whether the second colour component of the current block is allowed to use the DBV mode (the prediction is performed based on the BV information) is determined according to the prediction mode identification information. Here, the value of the prediction mode identification information may be decoded and determined, to determine whether the prediction mode identification information indicates that the second colour component of the current block uses the DBV mode.

Exemplarily, in an embodiment of the disclosure, in response to the value of the prediction mode identification information being a first value, it is determined that the prediction mode identification information indicates that the second colour component of the current block uses the BV information for prediction. In response to the value of the prediction mode identification information being a second value, it is determined that the prediction mode identification information indicates that the second colour component of the current block does not use the BV information for prediction.

In an embodiment of the disclosure, the prediction mode identification information may be denoted by intra_dbv_flag or intra_chroma_ibc_flag, used for indicating whether the second colour component of the current block uses the BV information for prediction.

In an embodiment of the disclosure, the first value and the second value are different, and the first value and the second value may be in the form of parameters or numerical values. Specifically, the prediction mode identification information may be a parameter written in the profile, or may be a value of a flag, which is not specifically limited herein.

Exemplarily, taking the first value set as 1 and the second value set as 0 as an example, the value of the prediction mode identification information is decoded and determined. In response to the value of the prediction mode identification information being 1, it may be determined that the second colour component of the current block uses the BV information for prediction. Then, the second block vector parameter(s) of the second colour component block may be determined based on the above operations, and the prediction value of the second colour component may be determined based on the second block vector parameter(s).

It may be further understood that the decoding method according to the embodiments of the disclosure may also be a modification of the DM mode in the related art, to enable the modified DM mode capable of accommodating the INTRA_DBV mode.

In an embodiment of the disclosure, under the dual-tree partitioning and the DM mode, if the corresponding luma region has BV information, the current chroma block uses the DBV mode for prediction, that is, the current chroma block may be predicted based on the BV information.

For example, if CuPredMode[0][xCb+cbWidth/2][yCb+cbHeight/2] is equal to MODE_IBC, intra_dbv_flag is set to be equal to 1, and then the chroma intra prediction mode IntraPredModeC[xCb][yCb] uses DBV.

For example, if CuPredMode[0][xCb+cbWidth/2][yCb+cbHeight/2] is equal to MODE_INTRA, and if IntraTmpFlag[xCb+cbWidth/2][yCb+cbHeight/2] is equal to 1, intra_dbv_flag is set to be equal to 1, and then the chroma intra prediction mode IntraPredModeC[xCb][yCb] uses DBV.

Here, the derivation of the chroma prediction mode is as follows.

The chroma intra prediction mode IntraPredModeC[xCb][yCb] uses cclm_mode_flag, cclm_mode_idx, and intra_chroma_pred_mode, lumaIntraPredMode, and lumaTempPredMode specified in Table 10. Herein 0 represents the Planar mode, 1 represents the DC, 18 represents the horizontal prediction mode, 50 represents the vertical prediction mode, and 81 to 83 represent CCLM prediction modes. It should be noted that these fill-in items other than the DBV mode are given as examples with corresponding values, and are not required to be filled in with these values.

In some embodiments, in the DM mode, if intra_dbv_flag==1, that is, the information obtained from the center position block of the collocated luma region includes BV, then the chroma intra prediction mode IntraPredModeC[xCb][yCb] uses DBV. Then, based on the decoding method including the operations 101 to 103 above, the second colour component may be predicted. Here, if the first colour component block is the center block of the collocated luma region, the BV of the corresponding luma block may be directly obtained as the first block vector parameter. Further, if the candidate block vector parameter(s) (candidate chroma BV(s)) determined based on the first block vector parameter is/are unavailable, the corresponding luma prediction mode may be obtained for the prediction of the second colour component.

That is to say, when using the INTRA_DBV mode for prediction, for the CU at the center position of the collocated luma region that is obtained, if the obtained CU at the center position of the collocated luma region is unavailable, the corresponding luma prediction mode may be obtained for chroma prediction.

Further, in an embodiment of the disclosure, in response to any block in the first colour component region being intra predicted based on the block vector, it is determined that the second colour component of the current block uses the DBV mode; the second block vector parameter(s) of the second colour component block is/are determined; and the prediction value of the second colour component is determined based on the second block vector parameter(s). That is, if it is determined that the second colour component of the current block uses the DBV mode, the second block vector parameter(s) of the second colour component block may be determined based on the above method, and the prediction value of the second colour component may be determined based on the second block vector parameter(s).

That is to say, the judgment condition for the DM mode may be that there is BV information at any position within the entire corresponding luma region. In some embodiments, in the DM mode, if the prediction information of the corresponding luma region includes BV information, the current chroma block is coded using the DBV mode. For example: if for x=xCb . . . xCb+cbWidth−1, and y=yCb . . . yCb+cbHeight−1, there is any pair (x, y) where CuPredMode[0][x][y] equals MODE_IBC, then Intra_DBV_flag is set to be 1, in which case the chroma intra prediction mode IntraPredModeC[xCb][yCb] uses DBV. If for x=xCb . . . xCb+cbWidth−1, y=yCb . . . yCb+cbHeight−1, there is any pair (x, y) where CuPredMode[0][x][y] equals MODE_INTRA and IntraTmpFlag[x][y] equals 1, then Intra_DBV_flag is set to be 1, in which case the chroma intra prediction mode IntraPredModeC[xCb][yCb] uses DBV. Herein IntraTmpFlag indicates whether to use the IntraTmp mode.

Further, in an embodiment of the disclosure, when performing transform and inverse transform on the corresponding residual of the chroma block predicted in the DBV mode, the following schemes may be included but are not limited to: a single transform may be performed (for example, only a discrete cosine transform (DCT) is performed without a low-frequency non-separable transform (LFNST)), or two transforms may be performed (a primary transform and a secondary transform, for example, the coding end first performs the DCT transform and then performs the LFNST transform). The forward transforms implemented at the decoding end are in reverse order to those at the coding end.

It should be noted that the encoding method and decoding method according to the embodiments of the disclosure, on the one hand, address the problem of monotonicity in chroma prediction, make full use of the information of the collocated luma region, and effectively enhance the accuracy of chroma prediction. On the other hand, the precision of the chroma BV is adjusted, the candidate list is constructed, and multiple possibilities may be adaptively provided according to different contents and sampling formats, making DBV prediction more effective and thereby further improving the coding efficiency.

In view of the above, the encoding method and decoding method proposed in the embodiments of the disclosure take full account of available information such as reconstructed luma and BV, and predict the chroma based on this information, which may address the problem of monotonicity in chroma prediction; and after obtaining the luma BV(s), the luma BV(s) or the chroma BV(s) is/are adjusted to construct multiple chroma BV candidates, which may adaptively provide multiple choices according to different contents and sampling formats, making DBV prediction more effective, thereby further improving the coding efficiency.

That is to say, in the embodiments of the disclosure, the BV parameter(s) of the corresponding luma block(s) may be obtained, and the BV parameter(s) may be adjusted and applied to chroma. This addresses the problem of monotonicity in chroma prediction, makes full use of information of the collocated luma region, thereby improving the accuracy of chroma prediction and effectively improving the encoding and decoding efficiency.

The embodiments of the disclosure provide an encoding method and a decoding method. The encoder and the decoder determine at least one first colour component block of a current block; in response to the at least one first colour component block being intra predicted based on a block vector, determine at least one second block vector parameter of a second colour component block based on at least one first block vector parameter of the at least one first colour component block; and determine a prediction value of a second colour component based on the at least one second block vector parameter. Therefore, in the embodiments of the disclosure, if luma block(s) corresponding to the current block is/are intra predicted based on the block vector, the at least one second block vector parameter of a chroma component may be determined based on the block vector parameter(s) of the luma block(s), and the at least one second block vector parameter is used to predict the chroma component. That is to say, the encoding method and decoding method proposed in the embodiments of the disclosure address the problem of monotonicity in chroma prediction, make full use of related information of the collocated luma block. This improves the accuracy of chroma prediction, reduces the bitrate, improves the encoding and decoding efficiency, and thereby enhances the encoding and decoding performance.

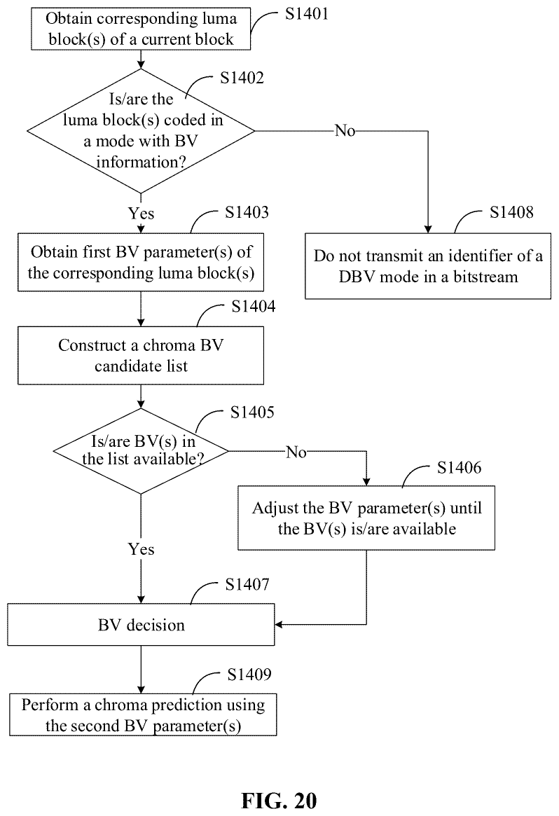

Based on the above embodiments, an encoding method and a decoding method according to the embodiments of the disclosure may include a new prediction mode, or an improved modification of the DM mode. For the new chroma prediction mode INTRA_DBV, FIG. 20 is a detailed schematic flowchart of an encoding method according to an embodiment of the disclosure. As shown in FIG. 20, the detailed flow may include the following operations S1401 to S1409.

At S1401, corresponding luma block(s) of a current block is/are obtained.

At S1402, whether the corresponding luma block(s) is/are coded in a mode with BV information is determined.

At S1403, first BV parameter(s) of the corresponding luma block(s) is/are obtained.

At S1404, a BV candidate list applied to chroma is constructed based on the first BV parameter(s).

At S1405, whether BV(s) in the BV candidate list is/are available is determined.

At S1406, the BV(s) is/are adjusted until the BV(s) is/are available.

At S1407, a decision is made on the available BV(s), and second BV parameter(s) is/are determined.

At S1408, an identifier of a DBV mode is not transmitted in a bitstream.

At S1409, a chroma prediction is performed using the second BV parameter(s).

It should be noted that in the embodiment of the disclosure, the corresponding luma block(s) indicates/indicate the collocated luma CU(s) of a chroma component of the current block. For S1402, if the judgment result is yes, S1403 to S1407 may be executed; and if the judgment result is no, S1408 may be executed. For S1405, if the judgment result is yes, S1407 may be executed; and if the judgment result is no, S1406 may be executed first, and then S1407 may be executed.

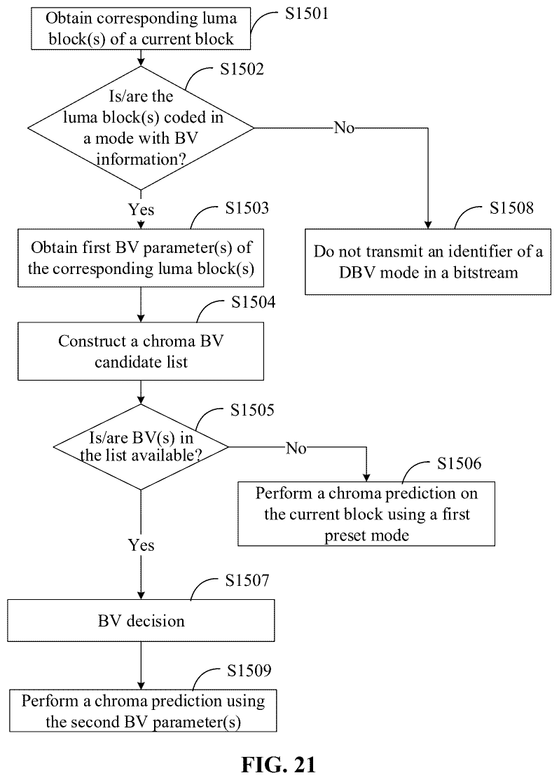

In another specific embodiment, FIG. 21 is a detailed schematic flowchart of another encoding method according to an embodiment of the disclosure. As shown in FIG. 21, the detailed flow may include the following operations S1501 to S1509.

At S1501, corresponding luma block(s) of a current block is/are obtained.

At S1502, whether the corresponding luma block(s) is/are coded in a mode with BV information is determined.

At S1503, first BV parameter(s) of the corresponding luma block(s) is/are obtained.

At S1504, a BV candidate list applied to chroma is constructed based on the first BV parameter(s).

At S1505, whether BV(s) in the BV candidate list is/are available is determined.

At S1506, a chroma prediction is performed on the current block using a first preset mode.

At S1507, a decision is performed on the available BV(s), and second BV parameter(s) is/are determined.

At S1508, an identifier of a DBV mode is not transmitted in a bitstream.

At S1509, a chroma prediction is performed using the second BV parameter(s).

It should be noted that in the embodiment of the disclosure, the corresponding luma block(s) indicates/indicate the collocated luma CU(s) of a chroma component of the current block. For S1502, if the judgment result is yes, S1503 to S1507 may be executed; and if the judgment result is no, S1508 may be executed. For S1505, if the judgment result is yes, S1507 may be executed; and if the judgment result is no, S1506 may be executed.

It should be further noted that in the embodiment of the disclosure, the first preset mode may be the PLANAR mode, or any other chroma prediction mode alternative, or skipping this mode, which is not specifically limited thereto.

That is to say, the prediction process for the chroma block is as follows.

Corresponding luma block(s) is/are obtained. Whether the corresponding luma block(s) is/are coded in a mode with BV information is determined. Then the following processing operations may be taken. If the corresponding luma block(s) is/are not coded in the mode with BV information, an identifier of this mode is not transmitted in a bitstream. If the corresponding luma block(s) is/are coded in the mode with BV information, BV(s) of the corresponding luma block(s) is/are obtained, the luma BV(s) (BVL(s)) is/are adjusted and applied to chroma, and a candidate list of chroma BV(s) (BVC(s)) is constructed. Then, whether BVC candidate item(s) in the chroma BVC candidate list is/are available is determined. If the BVC candidate item(s) in the chroma BVC candidate list is/are available, the decision-making process is proceeded to. If the BVC candidate item(s) in the chroma BVC candidate list is/are unavailable, the BVC(s) is/are adjusted to be available and then the decision-making process is proceeded to. If all of the BVC candidate item(s) in the chroma BVC candidate list are unavailable, a prediction is performed using the PLANAR mode or other chroma prediction modes.

Further, in an embodiment of the disclosure, the coding is within MODE_INTRA, added before intra_chroma_pred_mode. Here, Table 12 only lists one bitstream parsing position for illustration purposes.

TABLE 12

| | |
|---|---|
| if( !cu_act_enabled_flag ) { | |
| if( cbWidth / SubWidthC <= MaxTsSize && cbHeight / | |
| SubHeightC <= MaxTsSize && sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| else | |
| if(DbvEnabled ) | |
| dbv_flag | ae(v) |
| if( !dbv_flag) | |
| intra_chroma_pred_mode | ae(v) |
| } | |
| } | |

If sps_ibc_enabled_flag is equal to 0 and sps_intratmp_enabled_flag is equal to 0, DbvEnabled is set to 0.

Otherwise, a variable ModeIncludeBv is set. If the corresponding luma block(s) is/are not coded in the mode with BV information, ModeIncludeBv is set to 0; otherwise, ModeIncludeBv is set to 1.

If the following multiple conditions are all true (including but not limited to the following conditions), DbvEnabled is equal to 1:
ModeIncludeBv is equal to 1;
sh_slice_type is equal to I;
CtbLog2SizeC is less than or equal to MaxChromalbcSize; and
MaxChromalbcSize can be determined based on the chroma CTU size or a preset value.

Otherwise, DbvEnabled is equal to 0.

If DbvEnabled is equal to 0, dbv_flag is inferred as FALSE.

If dbv_flag is TRUE, it indicates that the current chroma prediction mode is DBV, including but not limited to binarization manners in the following tables, which may be coded using either context or bypass.

TABLE 13

| | | |
|---|---|---|
| dbv_flag | FL | cMax = 1 |

TABLE 14

| Value of intra_chroma_pred_mode | Bin string |
|---|---|
| 0 | 100 |
| 1 | 101 |
| 2 | 110 |
| 3 | 111 |
| 4 | 0 |

TABLE 15

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| dbv_flag | 0 | na | na | na | na | na |
| intra_chroma_pred_mode | 0 | bypass | bypass | na | na | na |

TABLE 16

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| dbv_flag | bypass | na | na | na | na | na |
| intra_chroma_pred_mode | 0 | bypass | bypass | na | na | na |

Further, in an embodiment of the disclosure, the coding is carried out in MODE_IBC, as shown in the following table.

TABLE 17

| | |
|---|---|
| if( sh_slice_type != I \| \| sps_ibc_enabled_flag ) { | |
| if( treeType != DUAL_TREE_CHROMA && | |
| ( ( !( cbWidth == 4 && cbHeight == 4 ) && | |
| modeType != MODE_TYPE_INTRA ) \| \| | |
| ( sps_ibc_enabled_flag && cbWidth <= 64 && cbHeight <= 64 ) ) ) | |
| cu_skip_flag[x0][y0] | ae(v) |
| if( cu_skip_flag[x0][y0] == 0 && sh_slice_type != I && | |
| !( cbWidth == 4 && cbHeight == 4 ) && modeType == | |
| MODE_TYPE_ALL ) | |
| pred_mode_flag | ae(v) |
| if( ( ( sh_slice_type == I && cu_skip_flag[x0][y0]==0 ) \| \| | |
| ( sh_slice_type != I && ( CuPredMode[chType][x0][y0] != MODE_INTRA \| \| | |
| ( ( ( cbWidth == 4 && cbHeight == 4 ) \| \| modeType ==MODE_TYPE_INTRA ) | |
| && cu_skip_flag[x0][y0] == 0 ) ) ) ) && cbWidth <= 64 && cbHeight <=64 | |
| && modeType != MODE_TYPE_INTER && sps_ibc_enabled_flag [symbol] | |
| [symbol] ) | |
| if(treeType != DUAL_TREE_CHROMA \|\| | |
| (treeType == DUAL_TREE_CHROMA && DbvEnabled) ){ | |
| pred_mode_ibc_flag | ae(v) |
| } | |
| } | |

If sps_ibc_enabled_flag is equal to 0 and sps_intratmp_enabled_flag is equal to 0, DbvEnabled is equal to 0. Otherwise, a variable ModeIncludeBv is set. If the corresponding luma block(s) is/are not coded in the mode with BV information, ModeIncludeBv is equal to 0; otherwise, ModeIncludeBv is equal to 1.

If the following multiple conditions are all true (including but not limited to the following conditions), DbvEnabled is equal to 1:
ModeIncludeBv is equal to 1;
sh_slice_type is equal to I;
CtbLog2SizeC is less than or equal to MaxChromalbcSize; and
MaxChromalbcSize can be determined based on the chroma CTU size or a preset value.

Otherwise, DbvEnabled is equal to 0.

Under the condition that treeType==DUAL_TREE_CHROMA, if DbvEnabled is equal to 0, pred_mode_ibc_flag is inferred as FALSE.

Under the condition 1 that treeType==DUAL_TREE_CHROMA, if pred_mode_ibc_flag is TRUE, it indicates that the current chroma prediction mode is DBV.

TABLE 18

| | | |
|---|---|---|
| pred_mode_ibc_flag | FL | cMax = 1 |

TABLE 19

| Initialization | ctxIdx of pred_mode_ibc_flag | | | | | | | | |
|---|---|---|---|---|---|---|---|---|---|
| variable | 0 | 1 | 2 | 3 | 4 | 5 | 6 | 7 | 8 |
| initValue | 17 | 42 | 36 | 0 | 57 | 44 | 0 | 43 | 45 |
| shiftIdx | 1 | 5 | 8 | 1 | 5 | 8 | 1 | 5 | 8 |

TABLE 20

| | |
|---|---|
| if( !cu_act_enabled_flag ) { | |
| if( cbWidth / SubWidthC <= MaxTsSize && cbHeight / | |
| SubHeightC <= MaxTsSize && sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| else | |
| intra_chroma_pred_mode | ae(v) |
| } | |
| } | |

TABLE 21

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| intra_chroma_pred_mode | 0 | bypass | bypass | na | na | na |

TABLE 22

| Value of intra_chroma_pred_mode | Bin string |
|---|---|
| 0 | 100 |
| 1 | 101 |
| 2 | 110 |
| 3 | 111 |
| 4 | 0 |

For the 0th bin of intra_chroma_pred_mode, it represents the DM mode, and the coding method is the same as VVC.

The derivation process of DbvEnabled is as follows.

If sps_ibc_enabled_flag is equal to 0 and sps_intratmp_enabled_flag is equal to 0, DbvEnabled is equal to 0.

Otherwise, if the following multiple conditions are all true (including but not limited to the following conditions), DbvEnabled is equal to 1:
sh_slice_type is equal to I;
CtbLog2SizeC is less than or equal to MaxChromalbcSize;
MaxChromalbcSize can be determined based on the chroma CTU size or a preset value.

If DbvEnabled is equal to 1:

When intra_chroma_pred_mode is equal to 0, 1, 2, or 3, which are four chroma prediction modes, referring to Table 4. When intra_chroma_pred_mode is equal to 4, Scheme 2 is performed.

Otherwise, the chroma prediction process in the H.266 standard is referenced.

In view of the above, the encoding method and decoding method proposed in the embodiments of the disclosure take full account of available information such as reconstructed luma and BV, and predict the chroma based on this information, which may address the problem of monotonicity in chroma prediction; and after obtaining the luma BV(s), the luma BV(s) or the chroma BV(s) is/are adjusted to construct multiple chroma BV candidates, which may adaptively provide multiple choices according to different contents and sampling formats, making DBV prediction more effective, thereby further improving the coding efficiency.

That is to say, in the embodiments of the disclosure, the BV parameter(s) of the corresponding luma block(s) may be obtained, and the BV parameter(s) may be adjusted and applied to chroma. This addresses the problem of monotonicity in chroma prediction, makes full use of information of the collocated luma region, thereby improving the accuracy of chroma prediction and effectively improving the encoding and decoding efficiency.

The embodiments of the disclosure provide an encoding method and a decoding method. The encoder and the decoder determine at least one first colour component block of a current block; in response to the at least one first colour component block being intra predicted based on a block vector, determine at least one second block vector parameter of a second colour component block based on at least one first block vector parameter of the at least one first colour component block; and determine a prediction value of a second colour component based on the at least one second block vector parameter. Therefore, in the embodiments of the disclosure, if luma block(s) corresponding to the current block is/are intra predicted based on the block vector, the at least one second block vector parameter of a chroma component may be determined based on the block vector parameter(s) of the luma block(s), and the at least one second block vector parameter is used to predict the chroma component. That is to say, the encoding method and decoding method proposed in the embodiments of the disclosure address the problem of monotonicity in chroma prediction, make full use of related information of the collocated luma block. This improves the accuracy of chroma prediction, reduces the bitrate, improves the encoding and decoding efficiency, and thereby enhances the encoding and decoding performance.

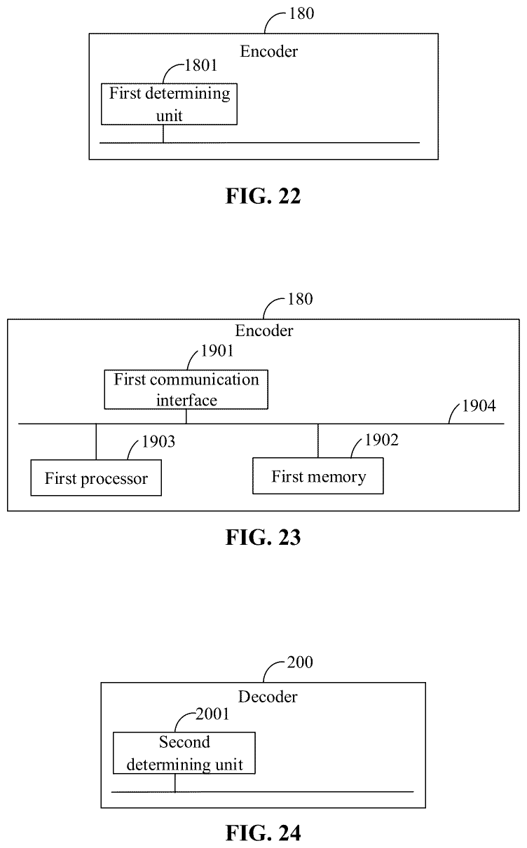

In yet another embodiment of the disclosure, referring to FIG. 22, it illustrates a schematic diagram of a composition structure of an encoder according to an embodiment of the disclosure. As shown in FIG. 22, an encoder 180 may include a first determining unit 1801.

The first determining unit 1801 is configured to: determine at least one first colour component block of a current block; in response to the at least one first colour component block being intra predicted based on a block vector, determine at least one second block vector parameter of the current block based on at least one first block vector parameter of the at least one first colour component block; and determine a prediction value of a second colour component based on the at least one second block vector parameter.

It may be understood that, in the embodiments of the disclosure, the “unit” may be part of an electrical circuit, part of a processor, part of a program or software, etc. Of course, the “unit” may also be modular or non-modular. Moreover, each component in the embodiments may be integrated in one processing unit, or, each unit may exist physically alone, or, two or more units may be integrated in one unit. The aforementioned integrated unit may be implemented either in the form of hardware or in the form of software functional module.

If the integrated unit is implemented in the form of software functional module and is not sold or used as an independent product, it may be stored in a computer-readable storage medium. Based on such understanding, the technical solutions of the disclosure, in essence or the part that contributes to the existing technology or the all or part of the technical solutions, may be embodied in the form of a software product. The computer software product is stored in a storage medium and includes several instructions to enable a computer device (which may be a personal computer, a server, or a network device, etc.) or a processor to perform all or part of the operations of the methods described in the embodiments of the disclosure. The aforementioned storage media include a universal serial bus (USB) flash disk, a removable hard disk, a read-only memory (ROM), a random access memory (RAM), a magnetic disk, or an optical disc, which may store program codes.

Therefore, an embodiment of the disclosure provides a computer-readable storage medium, applied to the encoder 180. The computer-readable storage medium has stored thereon a computer program, and the computer program, when executed by a first processor, implements the method in any one of the aforementioned embodiments.

Based on the composition of the encoder 180 and the computer-readable storage medium, FIG. 23 illustrates a schematic diagram of a specific hardware structure of the encoder 180 according to an embodiment of the disclosure. As shown in FIG. 23, the encoder 180 may include a first communication interface 1901, a first memory 1902 and a first processor 1903. The components are coupled together by a first bus system 1904. It may be understood that, the first bus system 1904 may be configured to implement connection communication between these components. The first bus system 1904 may include a power bus, a control bus and a status signal bus other than a data bus. However, for the sake of clarity, the various buses are denoted by the first bus system 1904 in FIG. 19.

The first communication interface 1901 is configured to receive and transmit signals during the process of transmitting and receiving information with other external network elements.

The first memory 1902 is configured to store a computer program capable of running on the first processor 1903.

The first processor 1903 is configured to perform, when running the computer program, the following operations.

At least one first colour component block of a current block is determined.

In response to the at least one first colour component block being intra predicted based on a block vector, at least one second block vector parameter of a second colour component block of the current block is determined based on at least one first block vector parameter of the at least one first colour component block.

A prediction value of a second colour component is determined based on the at least one second block vector parameter.

It may be understood that, the first memory 1902 in the embodiments of the disclosure may be a volatile memory or a non-volatile memory, or may include both a volatile memory and a non-volatile memory. The non-volatile memory may be a read-only memory (ROM), a programmable ROM (PROM), an erasable PROM (EPROM), an electrically EPROM (EEPROM) or a flash memory. The volatile memory may be a random access memory (RAM), and is used as an external cache. Through exemplary but not limitative description, many forms of RAMs may be used, for example, a static RAM (SRAM), a dynamic RAM (DRAM), a synchronous DRAM (SDRAM), a double data rate SDRAM (DDRSDRAM), an enhanced SDRAM (ESDRAM), a synchlink DRAM (SLDRAM) and a direct rambus RAM (DRRAM). The first memory 1902 of the systems and methods described herein is intended to include but not limited to these memories and any other suitable types of memories.

The first processor 1903 may be an integrated circuit chip, and has a signal processing capability. During implementation, the operations of the foregoing methods may be implemented by using a hardware integrated logic circuit in the first processor 1903 or implemented by using instructions in a software form. The first processor 1903 described above may be a general purpose processor, a digital signal processor (DSP), an application specific integrated circuit (ASIC), a field programmable gate array (FPGA), or another programmable logical device, discrete gate or transistor logical device, or discrete hardware component. The methods, operations and logical block diagrams disclosed in the embodiments of the disclosure may be implemented or performed. The general purpose processor may be a microprocessor or the processor may be any conventional processor and the like. The operations of the methods disclosed with reference to the embodiments of the disclosure may be directly executed and completed by means of a hardware decoding processor, or may be executed and completed by using a combination of hardware and software modules in the decoding processor. The software module may be located in a mature storage medium in the field, such as a random access memory, a flash memory, a read-only memory, a programmable read-only memory, an electrically-erasable programmable memory, or a register. The storage medium may be located in the first memory 1902, and the first processor 1903 may read the information in the first memory 1902 and complete the operations in the foregoing methods in combination with hardware of the processor.

It may be understood that, the embodiments described herein may be implemented in hardware, software, a firmware, a middleware, a micro bit or a combination thereof. For the hardware implementation, the processing unit may be implemented in one or more application specific integrated circuits (ASICs), digital signal processors (DSPs), digital signal processing devices (DSPDs), programmable logic devices (PLDs), field-programmable gate arrays (FPGAs), general purpose processors, controllers, microcontrollers, microprocessors, other electronic units for performing the functions described herein, or a combinations thereof. For the software implementation, the techniques described herein may be implemented by modules (e.g, procedures, functions, etc.) that perform the functions described herein. The software code may be stored in a memory and executed by a processor. The memory may be implemented in the processor or outside the processor.

Optionally, as another embodiment, the first processor 1903 is further configured to perform, when running the computer program, the method described in any one of the aforementioned embodiments.

In yet another embodiment of the disclosure, referring to FIG. 24, it illustrates a schematic diagram of a composition structure of a decoder according to an embodiment of the disclosure. As shown in FIG. 24, a decoder 200 may include a second determining unit 2001.

The second determining unit 2001 is configured to: determine at least one first colour component block of a current block; in response to the at least one first colour component block being intra predicted based on a block vector, determine at least one second block vector parameter of a second colour component block of the current block based on at least one first block vector parameter of the at least one first colour component block; and determine a prediction value of a second colour component based on the at least one second block vector parameter.

It may be understood that, in the embodiments, the “unit” may be part of an electrical circuit, part of a processor, part of a program or software, etc. Of course, the “unit” may also be modular or non-modular. Moreover, each component in the embodiments may be integrated in one processing unit, or, each unit may exist physically alone, or, two or more units may be integrated in one unit. The aforementioned integrated unit may be implemented either in the form of hardware or in the form of software functional module.

If the integrated unit is implemented in the form of software functional module and is not sold or used as an independent product, it may be stored in a computer-readable storage medium. Based on such understanding, the embodiment provides a computer-readable storage medium, which is applied to the decoder 200. The computer-readable storage medium has stored thereon a computer program, and the computer program, when executed by a second processor, implements the method in any one of the aforementioned embodiments.

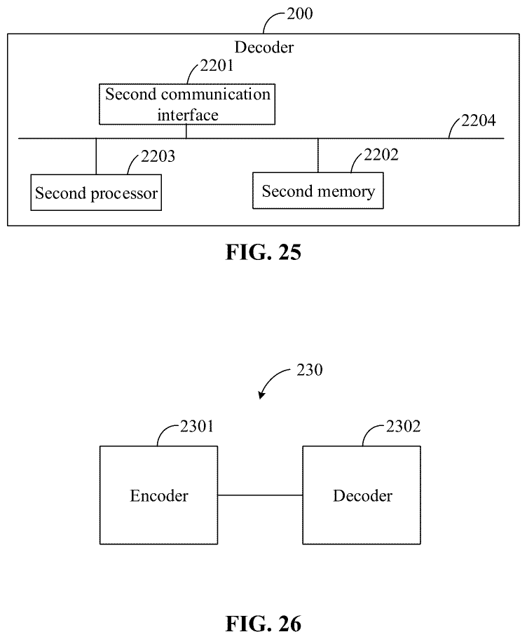

Based on the composition of the decoder 200 and the computer-readable storage medium, FIG. 25 illustrates a schematic diagram of a specific hardware structure of the decoder 200 according to an embodiment of the disclosure. As shown in FIG. 25, the decoder 200 may include a second communication interface 2201, a second memory 2202 and a second processor 2203. The components are coupled together by a second bus system 2204. It may be understood that, the second bus system 2204 may be configured to implement connection communication between these components. The second bus system 2204 may include a power bus, a control bus and a status signal bus other than a data bus. However, for the sake of clarity, the various buses are denoted by the second bus system 2204 in FIG. 22.

The second communication interface 2201 is configured to receive and transmit signals during the process of transmitting and receiving information with other external network elements.

The second memory 2202 is configured to store a computer program capable of running on the second processor 2203.

The second processor 2203 is configured to perform, when running the computer program, the following operations:

A first colour component block of a current block is determined. In response to the first colour component block being intra predicted based on a block vector, a second block vector parameter of a second colour component block of the current block is determined based on a first block vector parameter of the first colour component block. A prediction value of the second colour component is determined based on the second block vector parameter.

Optionally, as another embodiment, the second processor 2203 is further configured to perform, when running the computer program, the method described in any one of the aforementioned embodiments.

It may be understood that, the second memory 2202 may be similar in hardware function to the first memory 1902, and the second processor 2203 may be similar in hardware function to the first processor 1903, which will not be described in detail herein.

The embodiments provide an encoder and a decoder. The encoder and the decoder determine at least one first colour component block of a current block; in response to the at least one first colour component block being intra predicted based on a block vector, determine at least one second block vector parameter of a second colour component block based on at least one first block vector parameter of the at least one first colour component block; and determine a prediction value of a second colour component based on the at least one second block vector parameter. Therefore, in the embodiments of the disclosure, if luma block(s) corresponding to the current block is/are intra predicted based on the block vector, the at least one second block vector parameter of a chroma component may be determined based on the block vector parameter(s) of the luma block(s), and the at least one second block vector parameter is used to predict the chroma component. That is to say, the encoding method and decoding method proposed in the embodiments of the disclosure address the problem of monotonicity in chroma prediction, make full use of related information of the collocated luma block. This improves the accuracy of chroma prediction, reduces the bitrate, improves the encoding and decoding efficiency, and thereby enhances the encoding and decoding performance.

In yet another embodiment of the disclosure, referring to FIG. 26, it illustrates a schematic diagram of a composition structure of an encoding and decoding system according to an embodiment of the disclosure. As shown in FIG. 26, an encoding and decoding system 230 may include an encoder 2301 and a decoder 2302.

In the embodiment of the disclosure, the encoder 2301 may be the encoder described in any one of the aforementioned embodiments, and the decoder 2302 may be the decoder described in any one of the aforementioned embodiments.

Further, an embodiment of the disclosure provides a bitstream. The bitstream is generated by bit coding based on information to-be-coded, and the information to-be-coded includes at least one of: prediction mode identification information, or a colour sampling format of a current block.

Embodiments of the disclosure provide an encoding method, a decoding method, a bitstream, an encoder, a decoder, and a storage medium, which can reduce the bitrate, improve encoding and decoding efficiency, and thereby enhance encoding and decoding performance.

Technical solutions in the embodiments of the disclosure may be implemented as follows.

In a first aspect, an embodiment of the disclosure provides a decoding method, which is applied to a decoder, and includes the following operations.

At least one first colour component block of a current block is determined.

In response to the at least one first colour component block being intra predicted based on a block vector, at least one second block vector parameter of a second colour component block of the current block is determined based on at least one first block vector parameter of the at least one first colour component block.

A prediction value of a second colour component is determined based on the at least one second block vector parameter.

In a second aspect, an embodiment of the disclosure provides an encoding method, which is applied to an encoder, and includes the following operations.

At least one first colour component block of a current block is determined.

In response to the at least one first colour component block being intra predicted based on a block vector, at least one second block vector parameter of a second colour component block of the current block is determined based on at least one first block vector parameter of the at least one first colour component block.

A prediction value of a second colour component is determined based on the at least one second block vector parameter.

In a third aspect, an embodiment of the disclosure provides a bitstream, which is generated by bit coding based on information to-be-coded, and the information to-be-coded includes at least one of: prediction mode identification information, or a colour sampling format of a current block.

In a fourth aspect, an embodiment of the disclosure provides an encoder, which includes a first determining unit.

The first determining unit is configured to determine at least one first colour component block of a current block; in response to the at least one first colour component block being intra predicted based on a block vector, determine at least one second block vector parameter of the current block based on at least one first block vector parameter of the at least one first colour component block; and determine a prediction value of a second colour component based on the at least one second block vector parameter.

In a fifth aspect, an embodiment of the disclosure provides an encoder, which includes a first memory and a first processor.

The first memory is configured to store a computer program that is capable of running on the first processor.

The first processor is configured to execute, when running the computer program, the method described in the first aspect.

In a sixth aspect, an embodiment of the disclosure provides a decoder, which includes a second determining unit.

The second determining unit is configured to determine at least one first colour component block of a current block; in response to the at least one first colour component block being intra predicted based on a block vector, determine at least one second block vector parameter of a second colour component block of the current block based on at least one first block vector parameter of the at least one first colour component block; and determine a prediction value of a second colour component based on the at least one second block vector parameter.

In a seventh aspect, an embodiment of the disclosure provides a decoder, which includes a second memory and a second processor.

The second memory is configured to store a computer program that is capable of running on the second processor.

The second processor is configured to execute, when running the computer program, the method described in the second aspect.

In an eighth aspect, an embodiment of the disclosure provides a computer-readable storage medium, having stored thereon a computer program, and the computer program implements, when being executed, the method described in the first aspect or the method described in the second aspect.

It should be noted that, in the disclosure, the term “include”, “contain” or any other variants is intended to cover non-exclusive inclusion, such that a process, a method, an article or a device that includes a set of elements includes not only those elements but also other elements that are not explicitly listed, or also elements inherent to such process, method, article or device. In the absence of further limitations, an element defined by the phrase “includes a . . . ” does not preclude the existence of another identical element in the process, method, article or device in which it is included.

The above serial numbers of the embodiments of the disclosure are for description only and do not represent the superiority or inferiority of the embodiments.

The methods disclosed in the several method embodiments provided in the disclosure may be arbitrarily combined without conflict, to obtain new method embodiments.

The features disclosed in the several product embodiments provided in the disclosure may be arbitrarily combined without conflict, to obtain new product embodiments.

The features disclosed in the several method embodiments or device embodiments provided in the disclosure may be arbitrarily combined without conflict, to obtain new method embodiments or device embodiments.

The above is only the specific implementation of the disclosure, but the scope of protection of the disclosure is not limited thereto. Any technical person familiar with the technical field who may easily think of changes or substitutions within the technical scope disclosed in the disclosure, and all of these changes or substitutions should be covered within the scope of protection of the disclosure. Therefore, the scope of protection of the disclosure shall be subject to the scope of protection of the claims.

### INDUSTRIAL PRACTICABILITY

The embodiments of the disclosure provide an encoding method, a decoding method, an encoder, a decoder, and a storage medium. The encoder and the decoder determine at least one first colour component block of a current block; in response to the at least one first colour component block being intra predicted based on a block vector, determine at least one second block vector parameter of a second colour component block based on at least one first block vector parameter of the at least one first colour component block; and determine a prediction value of a second colour component based on the at least one second block vector parameter. Therefore, in the embodiments of the disclosure, if luma block(s) corresponding to the current block is/are intra predicted based on the block vector, the at least one second block vector parameter of a chroma component may be determined based on the block vector parameter(s) of the luma block(s), and the at least one second block vector parameter is used to predict the chroma component. That is to say, the encoding method and decoding method proposed in the embodiments of the disclosure address the problem of monotonicity in chroma prediction, make full use of related information of the collocated luma block. This improves the accuracy of chroma prediction, reduces the bitrate, improves the encoding and decoding efficiency, and thereby enhances the encoding and decoding performance.

1. A decoding method, applied to a decoder, and comprising:
determining at least one first colour component block of a current block;
in response to the at least one first colour component block being intra predicted based on a block vector, determining at least one second block vector parameter of a second colour component block of the current block based on at least one first block vector parameter of the at least one first colour component block; and
determining a prediction value of a second colour component based on the at least one second block vector parameter.

2. The method of claim 1, wherein determining the at least one first colour component block of the current block comprises:
determining a collocated first colour component region of the current block; and
determining the at least one first colour component block of the current block from a plurality of blocks partitioned from the first colour component region.

3. The method of claim 2, wherein determining the at least one first colour component block of the current block from the plurality of blocks partitioned from the first colour component region comprises:
selecting a target block from the plurality of blocks partitioned from the first colour component region, and taking the target block as the at least one first colour component block of the current block.

4. The method of claim 3, further comprising:
selecting a block at a center position in the first colour component region as the target block; or
selecting a block at a top-left position in the first colour component region as the target block; or
selecting a block at a bottom-right position in the first colour component region as the target block.

5. The method of claim 2, wherein determining the at least one first colour component block of the current block from the plurality of blocks partitioned from the first colour component region comprises:
determining at least one candidate block at a preset position from the plurality of blocks partitioned from the first colour component region; and
traversing the at least one candidate block according to a preset order, and determining a first candidate block among the at least one candidate block that is intra predicted based on the block vector as the at least one first colour component block of the current block.

6. The method of claim 2, wherein determining the at least one first colour component block of the current block from the plurality of blocks partitioned from the first colour component region comprises:
determining at least one candidate block at a preset position from the plurality of blocks partitioned from the first colour component region; and
determining the at least one candidate block as the at least one first colour component block of the current block.

7. The method of claim 1, wherein determining the at least one second block vector parameter of the second colour component block of the current block based on the at least one first block vector parameter of the at least one first colour component block comprises:
determining the at least one first block vector parameter of the at least one first colour component block as the at least one second block vector parameter of the second colour component block.

8. The method of claim 1, wherein determining the at least one second block vector parameter of the second colour component block of the current block based on the at least one first block vector parameter of the at least one first colour component block comprises:
determining a block vector parameter candidate list of the second colour component block of the current block based on the at least one first block vector parameter of the at least one first colour component block; and
determining the at least one second block vector parameter of the second colour component block based on the block vector parameter candidate list.

9. The method of claim 8, wherein determining the block vector parameter candidate list of the second colour component block of the current block based on the at least one first block vector parameter of the at least one first colour component block comprises:
adjusting the at least one first block vector parameter, and determining candidate block vector parameters of the second colour component block; and
determining the block vector parameter candidate list based on the candidate block vector parameters.

10. The method of claim 9, wherein adjusting the at least one first block vector parameter, and determining the candidate block vector parameters of the second colour component block comprises:
determining a colour sampling format of the current block; and
scaling the at least one first block vector parameter according to the colour sampling format, to determine the candidate block vector parameters.

11. The method of claim 9, wherein adjusting the at least one first block vector parameter, and determining the candidate block vector parameters of the second colour component block comprises:
determining a colour sampling format of the current block;
scaling the at least one first block vector parameter according to the colour sampling format, and determining at least one first initial block vector parameter; and
determining the candidate block vector parameters based on the at least one first initial block vector parameter and one or more values.

12. The method of claim 8, wherein determining the at least one second block vector parameter of the second colour component block based on the block vector parameter candidate list comprises:
determining whether one or more candidate block vector parameters meeting a first availability condition exist in the block vector parameter candidate list; and
in response to the one or more candidate block vector parameters meeting the first availability condition existing, determining the at least one second block vector parameter based on the one or more candidate block vector parameters.

13. The method of claim 12, wherein the operation of the one or more candidate block vector parameters meeting the first availability condition comprises at least one of:
an offset position indicated by the one or more candidate block vector parameters not exceeding picture boundaries;
the offset position indicated by the one or more candidate block vector parameters not overlapping the current block;
the offset position indicated by the one or more candidate block vector parameters not exceeding a preset available region; or
the offset position indicated by the one or more candidate block vector parameters having been reconstructed.

14. The method of claim 12, wherein determining the at least one second block vector parameter based on the one or more candidate block vector parameters comprises:
determining one candidate block vector parameter meeting the first availability condition as the at least one second block vector parameter.

15. The method of claim 12, wherein determining the at least one second block vector parameter based on the one or more candidate block vector parameters comprises:
for a plurality of candidate block vector parameters meeting the first availability condition, determining a first matching template based on the plurality of candidate block vector parameters;
calculating a matching error between a first template of the current block and the first matching template according to a preset error criterion, to determine a first cost value corresponding to the plurality of candidate block vector parameters; and
determining one or more second block vector parameters from the plurality of candidate block vector parameters based on the first cost value.

16. The method of claim 15, wherein the first template comprises one or more sample values in a neighbouring decoded region of the current block,
wherein determining the first matching template based on the plurality of candidate block vector parameters comprises:
with a position of a current point as a starting point, determining a region indicated by the plurality of candidate block vector parameters that has a same shape and comprises a same number of sample values as the first template as the first matching template.

17. The method of claim 12, further comprising:
determining at least one candidate block at a preset position from the plurality of blocks partitioned from the first colour component region; and
traversing the at least one candidate block according to a preset order, and determining a first candidate block among the at least one candidate block that meets a preset condition as the at least one first colour component block of the current block,
wherein the method further comprises:
in response to a candidate block being intra predicted based on the block vector and a block vector parameter of the second colour component block determined based on the candidate block meeting the first availability condition, determining that the candidate block meets the preset condition.

18. The method of claim 12, wherein determining the prediction value of the second colour component based on the at least one second block vector parameter comprises:
determining an offset position of the current block based on the at least one second block vector parameter and position information of the current block;
performing block copy processing based on the offset position of the current block, and obtaining a first prediction block; and
determining the prediction value of the second colour component based on the first prediction block,
wherein determining the prediction value of the second colour component based on the first prediction block comprises:
determining the first prediction block as the prediction value of the second colour component.

19. An encoding method, applied to an encoder, and comprising:
determining at least one first colour component block of a current block;
in response to the at least one first colour component block being intra predicted based on a block vector, determining at least one second block vector parameter of a second colour component block based on at least one first block vector parameter of the at least one first colour component block; and
determining a prediction value of a second colour component based on the at least one second block vector parameter.

20. A decoder, comprising:
a processor; and
a memory, configured to store a computer program executable by the processor,
wherein the processor is configured to:
determine at least one first colour component block of a current block;
in response to the at least one first colour component block being intra predicted based on a block vector, determine at least one second block vector parameter of a second colour component block of the current block based on at least one first block vector parameter of the at least one first colour component block; and
determine a prediction value of a second colour component based on the at least one second block vector parameter.
